(19) United States
(12) Patent Application Publication
(10) Pub. No.: US 2025/0193205 A1
(43) Pub. Date: Jun. 12, 2025

(54) USER INTERFACES FOR PREVENTING UNAUTHORIZED DEVICE ACCESS

(71) Applicant: Apple Inc., Cupertino, CA (US)

(72) Inventors: Ivan KRSTIC, San Francisco, CA (US); Felix Javier ACERO SALAZAR, Prague (CZ); Madeline T. ZUG, San Francisco, CA (US); Libor SYKORA, Prague (CZ); Ramakrishnan W. MOORIYATHU, San Jose, CA (US); Rex C. ROSS, San Jose, CA (US); Andrew J. KERNS, Cupertino, CA (US); Ryan D. SHELBY, Mountain View, CA (US); Russell E. SNEDIKER, Aptos, CA (US); Donald W. PITSCHEL, San Francisco, CA (US); Candice L. ROE, Palo Alto, CA (US)

(21) Appl. No.: 18/952,669

(22) Filed: Nov. 19, 2024

Related U.S. Application Data
(60) Provisional application No. 63/608,294, filed on Dec. 10, 2023.

(51) Int. Cl. H04L 9/40

(52) U.S. Cl. CPC H04L 63/107; H04L 63/0861

(57) ABSTRACT

The present disclosure generally relates to location-based user authentication. In some embodiments, methods and user interfaces for performing location-based user authentication based on a type of requested operation are described.

### CROSS-REFERENCE TO RELATED APPLICATIONS

This application claims priority to U.S. Provisional Application No. 63/608,294, filed on Dec. 10, 2023, entitled “USER INTERFACES FOR PREVENTING UNAUTHORIZED DEVICE ACCESS,” the contents of which is hereby incorporated by reference for all purposes, as if fully set forth herein.

### FIELD

The present disclosure relates generally to computer user interfaces, and more specifically to techniques for authentication for performing operations.

### BACKGROUND

Smart phones and other personal electronic devices can contain personal and sensitive information. Requiring authentication to perform certain operations on the device helps to prevent unauthorized individuals from improperly accessing this information.

### BRIEF SUMMARY

Some techniques for authenticating a user to perform operations, however, are generally cumbersome and inefficient. For example, some existing techniques use a complex and time-consuming user interface regardless of the location of the device. Some existing techniques require a user to either choose greater security, wasting user time and device energy when devices are not at risk, or choose greater accessibility, decreasing the security of personal information.

Accordingly, the present technique provides electronic devices with the ability to perform authentication based on a location of the electronic devices. Such methods and interfaces optionally complement or replace other methods of performing authentication to perform operations. Such methods and interfaces allow for more device security when in locations that are unfamiliar while allowing a user faster and simpler access to operations when in locations that are familiar. For battery-operated computing devices, such methods and interfaces conserve power and increase the time between battery charges while providing customizable levels of security.

In accordance with some embodiments, a method performed at a computer system that is in communication with a display generation component and one or more input devices is described. The method comprises: receiving, via the one or more input devices, a sequence of one or more inputs that includes a request to perform an operation of a respective type; and in response to receiving the sequence of one or more inputs: in accordance with a determination that the operation is a first type of operation that was requested while the computer system was in a first type of location, initiating a process to perform the operation; and in accordance with a determination that the operation is the first type of operation that was requested while the computer system was in a second type of location that is different from the first type of location, forgoing initiating the process to perform the operation.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: receiving, via the one or more input devices, a sequence of one or more inputs that includes a request to perform an operation of a respective type; and in response to receiving the sequence of one or more inputs: in accordance with a determination that the operation is a first type of operation that was requested while the computer system was in a first type of location, initiating a process to perform the operation; and in accordance with a determination that the operation is the first type of operation that was requested while the computer system was in a second type of location that is different from the first type of location, forgoing initiating the process to perform the operation.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: receiving, via the one or more input devices, a sequence of one or more inputs that includes a request to perform an operation of a respective type; and in response to receiving the sequence of one or more inputs: in accordance with a determination that the operation is a first type of operation that was requested while the computer system was in a first type of location, initiating a process to perform the operation; and in accordance with a determination that the operation is the first type of operation that was requested while the computer system was in a second type of location that is different from the first type of location, forgoing initiating the process to perform the operation.

In accordance with some embodiments, a computer system is described. The computer system comprises one or more processors, wherein the computer system is configured to communicate with a display generation component and one or more input devices; and memory storing one or more programs configured to be executed by the one or more processors, the one or more programs including instructions for: receiving, via the one or more input devices, a sequence of one or more inputs that includes a request to perform an operation of a respective type; and in response to receiving the sequence of one or more inputs: in accordance with a determination that the operation is a first type of operation that was requested while the computer system was in a first type of location, initiating a process to perform the operation; and in accordance with a determination that the operation is the first type of operation that was requested while the computer system was in a second type of location that is different from the first type of location, forgoing initiating the process to perform the operation.

In accordance with some embodiments, a computer system is described. The computer system is configured to communicate with a display generation component and one or more input devices. The computer system comprises: means for receiving, via the one or more input devices, a sequence of one or more inputs that includes a request to perform an operation of a respective type; and means, in response to receiving the sequence of one or more inputs, for: in accordance with a determination that the operation is a first type of operation that was requested while the computer system was in a first type of location, initiating a process to perform the operation; and in accordance with a determination that the operation is the first type of operation that was requested while the computer system was in a second type of location that is different from the first type of location, forgoing initiating the process to perform the operation.

In accordance with some embodiments, a computer program product is described. The computer program product comprises one or more programs configured to be executed by one or more processors of a computer system that is in communication with a display generation component and one or more input devices, the one or more programs including instructions for: receiving, via the one or more input devices, a sequence of one or more inputs that includes a request to perform an operation of a respective type; and in response to receiving the sequence of one or more inputs: in accordance with a determination that the operation is a first type of operation that was requested while the computer system was in a first type of location, initiating a process to perform the operation; and in accordance with a determination that the operation is the first type of operation that was requested while the computer system was in a second type of location that is different from the first type of location, forgoing initiating the process to perform the operation.

In accordance with some embodiments, a method performed at a computer system that is in communication with a display generation component and one or more input devices is described. The method comprises: detecting, via the one or more input devices, a first authentication attempt using a first type of biometric authentication; in response to detecting the first authentication attempt: in accordance with a determination that a first input of the first type of biometric authentication matches an enrolled biometric feature, performing a respective operation associated with the first authentication attempt; and in accordance with a determination that the first input of the first type of biometric authentication does not match an enrolled biometric feature, preventing further authentication attempts using the first type of biometric authentication without performing the respective operation associated with the first authentication attempt; while preventing further authentication attempts using the first type of biometric authentication and in accordance with a determination that a first set of criteria are met, providing a prompt for an alternative type of authentication that is different from the first type of biometric authentication; receiving, via the one or more input devices, a second authentication attempt using the alternative type of authentication; and in response to receiving the second authentication attempt: in accordance with a determination that the second authentication attempt includes received authentication information that matches an enrolled authentication information for the alternative type of authentication, enabling further authentication attempts using the first type of biometric authentication; and in accordance with a determination that the second authentication attempt does not include received authentication information that matches enrolled authentication information for the alternative type of authentication, continuing to prevent further authentication attempts using the first type of biometric authentication.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: detecting, via the one or more input devices, a first authentication attempt using a first type of biometric authentication; in response to detecting the first authentication attempt: in accordance with a determination that a first input of the first type of biometric authentication matches an enrolled biometric feature, performing a respective operation associated with the first authentication attempt; and in accordance with a determination that the first input of the first type of biometric authentication does not match an enrolled biometric feature, preventing further authentication attempts using the first type of biometric authentication without performing the respective operation associated with the first authentication attempt; while preventing further authentication attempts using the first type of biometric authentication and in accordance with a determination that a first set of criteria are met, providing a prompt for an alternative type of authentication that is different from the first type of biometric authentication; receiving, via the one or more input devices, a second authentication attempt using the alternative type of authentication; and in response to receiving the second authentication attempt: in accordance with a determination that the second authentication attempt includes received authentication information that matches an enrolled authentication information for the alternative type of authentication, enabling further authentication attempts using the first type of biometric authentication; and in accordance with a determination that the second authentication attempt does not include received authentication information that matches enrolled authentication information for the alternative type of authentication, continuing to prevent further authentication attempts using the first type of biometric authentication.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: detecting, via the one or more input devices, a first authentication attempt using a first type of biometric authentication; in response to detecting the first authentication attempt: in accordance with a determination that a first input of the first type of biometric authentication matches an enrolled biometric feature, performing a respective operation associated with the first authentication attempt; and in accordance with a determination that the first input of the first type of biometric authentication does not match an enrolled biometric feature, preventing further authentication attempts using the first type of biometric authentication without performing the respective operation associated with the first authentication attempt; while preventing further authentication attempts using the first type of biometric authentication and in accordance with a determination that a first set of criteria are met, providing a prompt for an alternative type of authentication that is different from the first type of biometric authentication; receiving, via the one or more input devices, a second authentication attempt using the alternative type of authentication; and in response to receiving the second authentication attempt: in accordance with a determination that the second authentication attempt includes received authentication information that matches an enrolled authentication information for the alternative type of authentication, enabling further authentication attempts using the first type of biometric authentication; and in accordance with a determination that the second authentication attempt does not include received authentication information that matches enrolled authentication information for the alternative type of authentication, continuing to prevent further authentication attempts using the first type of biometric authentication.

In accordance with some embodiments, a computer system is described. The computer system comprises one or more processors, wherein the computer system is configured to communicate with a display generation component and one or more input devices; and memory storing one or more programs configured to be executed by the one or more processors, the one or more programs including instructions for: detecting, via the one or more input devices, a first authentication attempt using a first type of biometric authentication; in response to detecting the first authentication attempt: in accordance with a determination that a first input of the first type of biometric authentication matches an enrolled biometric feature, performing a respective operation associated with the first authentication attempt; and in accordance with a determination that the first input of the first type of biometric authentication does not match an enrolled biometric feature, preventing further authentication attempts using the first type of biometric authentication without performing the respective operation associated with the first authentication attempt; while preventing further authentication attempts using the first type of biometric authentication and in accordance with a determination that a first set of criteria are met, providing a prompt for an alternative type of authentication that is different from the first type of biometric authentication; receiving, via the one or more input devices, a second authentication attempt using the alternative type of authentication; and in response to receiving the second authentication attempt: in accordance with a determination that the second authentication attempt includes received authentication information that matches an enrolled authentication information for the alternative type of authentication, enabling further authentication attempts using the first type of biometric authentication; and in accordance with a determination that the second authentication attempt does not include received authentication information that matches enrolled authentication information for the alternative type of authentication, continuing to prevent further authentication attempts using the first type of biometric authentication.

In accordance with some embodiments, a computer system is described. The computer system is configured to communicate with a display generation component and one or more input devices. The computer system comprises: means for detecting, via the one or more input devices, a first authentication attempt using a first type of biometric authentication; means, in response to detecting the first authentication attempt, for: in accordance with a determination that a first input of the first type of biometric authentication matches an enrolled biometric feature, performing a respective operation associated with the first authentication attempt; and in accordance with a determination that the first input of the first type of biometric authentication does not match an enrolled biometric feature, preventing further authentication attempts using the first type of biometric authentication without performing the respective operation associated with the first authentication attempt; means, while preventing further authentication attempts using the first type of biometric authentication and in accordance with a determination that a first set of criteria are met, for providing a prompt for an alternative type of authentication that is different from the first type of biometric authentication; means for receiving, via the one or more input devices, a second authentication attempt using the alternative type of authentication; and means, in response to receiving the second authentication attempt, for: in accordance with a determination that the second authentication attempt includes received authentication information that matches an enrolled authentication information for the alternative type of authentication, enabling further authentication attempts using the first type of biometric authentication; and in accordance with a determination that the second authentication attempt does not include received authentication information that matches enrolled authentication information for the alternative type of authentication, continuing to prevent further authentication attempts using the first type of biometric authentication.

In accordance with some embodiments, a computer program product is described. The computer program product comprises one or more programs configured to be executed by one or more processors of a computer system that is in communication with a display generation component and one or more input devices, the one or more programs including instructions for: detecting, via the one or more input devices, a first authentication attempt using a first type of biometric authentication; in response to detecting the first authentication attempt: in accordance with a determination that a first input of the first type of biometric authentication matches an enrolled biometric feature, performing a respective operation associated with the first authentication attempt; and in accordance with a determination that the first input of the first type of biometric authentication does not match an enrolled biometric feature, preventing further authentication attempts using the first type of biometric authentication without performing the respective operation associated with the first authentication attempt; while preventing further authentication attempts using the first type of biometric authentication and in accordance with a determination that a first set of criteria are met, providing a prompt for an alternative type of authentication that is different from the first type of biometric authentication; receiving, via the one or more input devices, a second authentication attempt using the alternative type of authentication; and in response to receiving the second authentication attempt: in accordance with a determination that the second authentication attempt includes received authentication information that matches an enrolled authentication information for the alternative type of authentication, enabling further authentication attempts using the first type of biometric authentication; and in accordance with a determination that the second authentication attempt does not include received authentication information that matches enrolled authentication information for the alternative type of authentication, continuing to prevent further authentication attempts using the first type of biometric authentication.

In accordance with some embodiments, a method performed at a computer system that is in communication with one or more output devices and one or more input devices is described. The method comprises: receiving, via the one or more input devices, first authentication information corresponding to a request to perform the operation; in response to receiving, via the one or more input devices, the first authentication information, in accordance with a determination that the first authentication information is valid, delaying allowing the operation to be performed for a threshold amount of time; after the expiration of the threshold amount of time, receiving, via the one or more input devices, second authentication information corresponding to the request to perform the operation; in response to receiving the second authentication information in accordance with a determination that the second authentication information is valid, allowing the operation to be performed, wherein the second authentication information is requited to be provided in conjunction with a contextual cue that cannot be conveyed verbally or in writing; while the operation is allowed to be performed, detecting, via the one or more input devices, input corresponding to a request to perform the operation; and in response to detecting the input corresponding to the request to perform the operation, performing the operation, wherein performing the operation includes generating, via the one or more output devices, an indication that the operation has been performed.

In accordance with some embodiments, a non-transitory computer-readable storage medium is described. The non-transitory computer-readable storage medium stores one or more programs configured to be executed by one or more processors of a computer system that is in communication with one or more output devices and one or more input devices, the one or more programs including instructions for: receiving, via the one or more input devices, first authentication information corresponding to a request to perform the operation; in response to receiving, via the one or more input devices, the first authentication information, in accordance with a determination that the first authentication information is valid, delaying allowing the operation to be performed for a threshold amount of time; after the expiration of the threshold amount of time, receiving, via the one or more input devices, second authentication information corresponding to the request to perform the operation; in response to receiving the second authentication information in accordance with a determination that the second authentication information is valid, allowing the operation to be performed, wherein the second authentication information is requited to be provided in conjunction with a contextual cue that cannot be conveyed verbally or in writing; while the operation is allowed to be performed, detecting, via the one or more input devices, input corresponding to a request to perform the operation; and in response to detecting the input corresponding to the request to perform the operation, performing the operation, wherein performing the operation includes generating, via the one or more output devices, an indication that the operation has been performed.

In accordance with some embodiments, a transitory computer-readable storage medium is described. The transitory computer-readable storage medium stores one or more programs configured to be executed by one or more processors of a computer system that is in communication with one or more output devices and one or more input devices, the one or more programs including instructions for: receiving, via the one or more input devices, first authentication information corresponding to a request to perform the operation; in response to receiving, via the one or more input devices, the first authentication information, in accordance with a determination that the first authentication information is valid, delaying allowing the operation to be performed for a threshold amount of time; after the expiration of the threshold amount of time, receiving, via the one or more input devices, second authentication information corresponding to the request to perform the operation; in response to receiving the second authentication information in accordance with a determination that the second authentication information is valid, allowing the operation to be performed, wherein the second authentication information is requited to be provided in conjunction with a contextual cue that cannot be conveyed verbally or in writing; while the operation is allowed to be performed, detecting, via the one or more input devices, input corresponding to a request to perform the operation; and in response to detecting the input corresponding to the request to perform the operation, performing the operation, wherein performing the operation includes generating, via the one or more output devices, an indication that the operation has been performed.

In accordance with some embodiments, a computer system is described. The computer system comprises one or more processors, wherein the computer system is configured to communicate with one or more output devices and one or more input devices; and memory storing one or more programs configured to be executed by the one or more processors, the one or more programs including instructions for: receiving, via the one or more input devices, first authentication information corresponding to a request to perform the operation; in response to receiving, via the one or more input devices, the first authentication information, in accordance with a determination that the first authentication information is valid, delaying allowing the operation to be performed for a threshold amount of time; after the expiration of the threshold amount of time, receiving, via the one or more input devices, second authentication information corresponding to the request to perform the operation; in response to receiving the second authentication information in accordance with a determination that the second authentication information is valid, allowing the operation to be performed, wherein the second authentication information is requited to be provided in conjunction with a contextual cue that cannot be conveyed verbally or in writing; while the operation is allowed to be performed, detecting, via the one or more input devices, input corresponding to a request to perform the operation; and in response to detecting the input corresponding to the request to perform the operation, performing the operation, wherein performing the operation includes generating, via the one or more output devices, an indication that the operation has been performed.

In accordance with some embodiments, a computer system is described. The computer system is configured to communicate with one or more output devices and one or more input devices. The computer system comprises: means for receiving, via the one or more input devices, first authentication information corresponding to a request to perform the operation; means, in response to receiving, via the one or more input devices, the first authentication information, in accordance with a determination that the first authentication information is valid, for delaying allowing the operation to be performed for a threshold amount of time; means, after the expiration of the threshold amount of time, for receiving, via the one or more input devices, second authentication information corresponding to the request to perform the operation; means, in response to receiving the second authentication information in accordance with a determination that the second authentication information is valid, for allowing the operation to be performed, wherein the second authentication information is requited to be provided in conjunction with a contextual cue that cannot be conveyed verbally or in writing; means, while the operation is allowed to be performed, for detecting, via the one or more input devices, input corresponding to a request to perform the operation; and means, in response to detecting the input corresponding to the request to perform the operation, for performing the operation, wherein performing the operation includes generating, via the one or more output devices, an indication that the operation has been performed.

In accordance with some embodiments, a computer program product is described. The computer program product comprises one or more programs configured to be executed by one or more processors of a computer system that is in communication with one or more output devices and one or more input devices, the one or more programs including instructions for: receiving, via the one or more input devices, first authentication information corresponding to a request to perform the operation; in response to receiving, via the one or more input devices, the first authentication information, in accordance with a determination that the first authentication information is valid, delaying allowing the operation to be performed for a threshold amount of time; after the expiration of the threshold amount of time, receiving, via the one or more input devices, second authentication information corresponding to the request to perform the operation; in response to receiving the second authentication information in accordance with a determination that the second authentication information is valid, allowing the operation to be performed, wherein the second authentication information is requited to be provided in conjunction with a contextual cue that cannot be conveyed verbally or in writing; while the operation is allowed to be performed, detecting, via the one or more input devices, input corresponding to a request to perform the operation; and in response to detecting the input corresponding to the request to perform the operation, performing the operation, wherein performing the operation includes generating, via the one or more output devices, an indication that the operation has been performed.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing user authentication, thereby increasing the effectiveness, efficiency, and user satisfaction with such devices. Such methods and interfaces may complement or replace other methods for managing user authentication.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AK illustrate example user interfaces for authentication based on location, in accordance with some embodiments.

FIG. 7 is a flow diagram illustrating a method for displaying user interfaces for authentication based on location, in accordance with some embodiments.

FIG. 8 is a block diagram illustrating a system for authentication based on location, in accordance with some embodiments.

FIGS. 9A and 9B are a flow diagram illustrating a method for authentication based on location, in accordance with some embodiments.

FIGS. 10A-10Q illustrate example user interfaces for authentication using multiple types of authentication, in accordance with some embodiments.

FIGS. 11A-11B are a flow diagram illustrating a method for displaying user interfaces for authentication using multiple types of authentication, in accordance with some embodiments.

FIG. 12 is a flow diagram illustrating a method for performing authentication to perform an operation in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for user authentication. For example, there is a need for devices that enable customizable levels of security based on a location of the device. Such techniques allow for more device security when in locations that are unfamiliar while allowing a user faster and simpler access to operations when in locations that are familiar, thereby enhancing productivity. Further, such techniques can reduce processor and battery power while offering customizable levels of security.

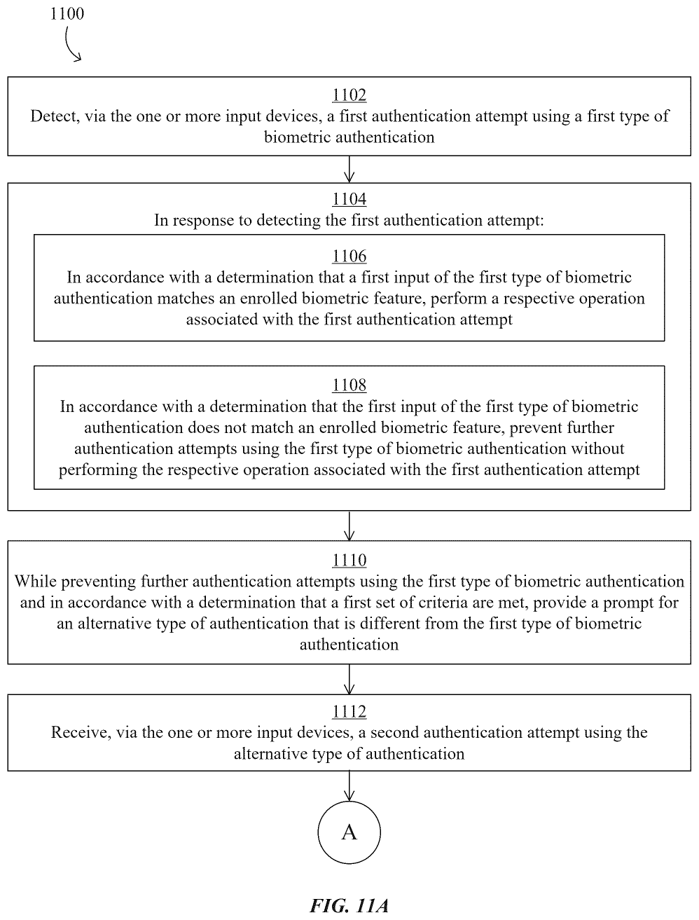

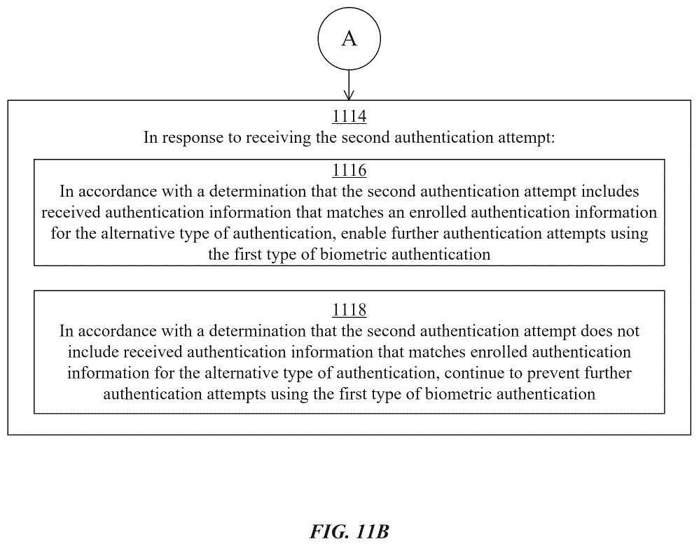

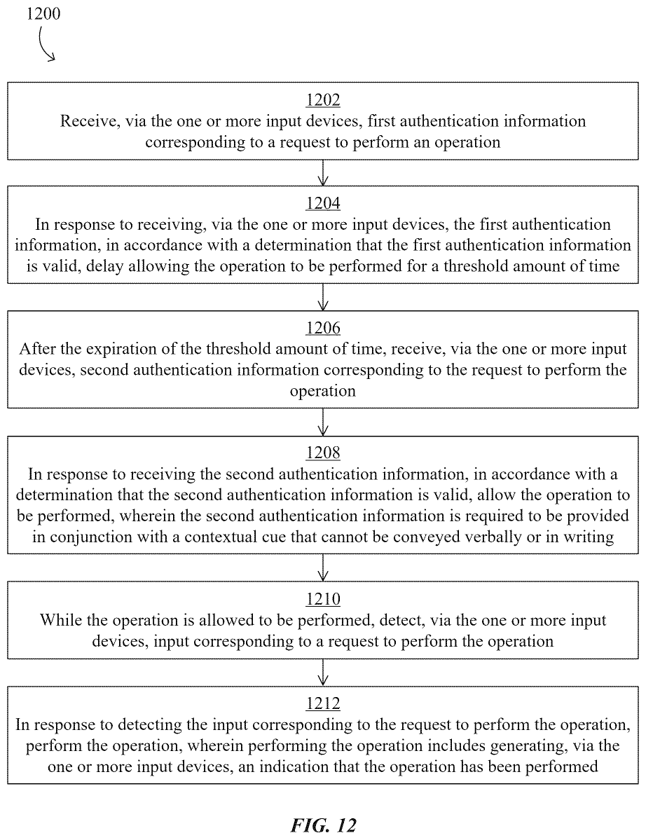

For example, an unauthorized person attempting to access a computer system may possess the passcode to the computer system through camera recording or observing the owner of the computer system when using the computer system. When the computer system requires biometric authentication to perform critical operations and the owner is not present, unauthorized persons attempting to access the computer system are unable to use just a passcode for certain important functions. Moreover, even if the owner is confronted and forced to input a biometric into the computer system, requiring multiple biometric authentications separated by a timer (as described below with reference to FIG. 7 and FIG. 12) allows the computer system to prevent access to critical operations when the owner is not present to provide a second biometric authentication after the timer has expired. In some embodiments, the computer system allows the use of a passcode instead of biometric authentication when the computer system is in a familiar location, allowing an owner of the computer system to overcome accidental lockouts and access the computer system efficiently when the computer system has not been taken from the owner (as described below with reference to FIG. 7 and FIG. 11).

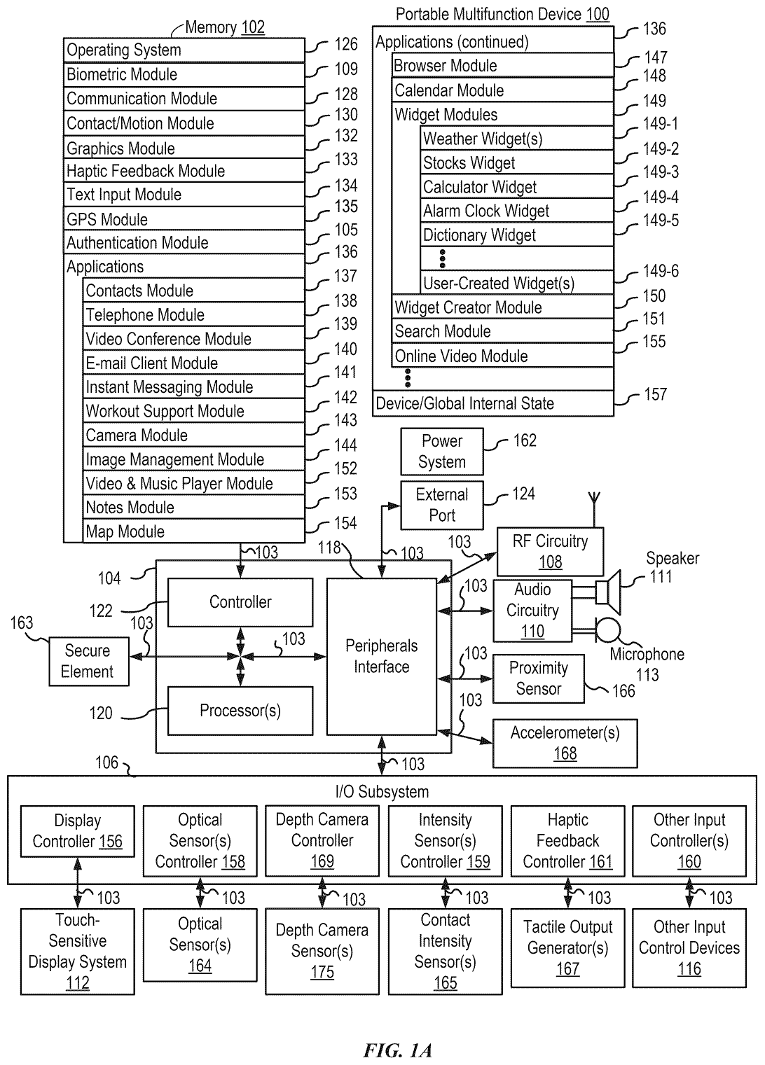

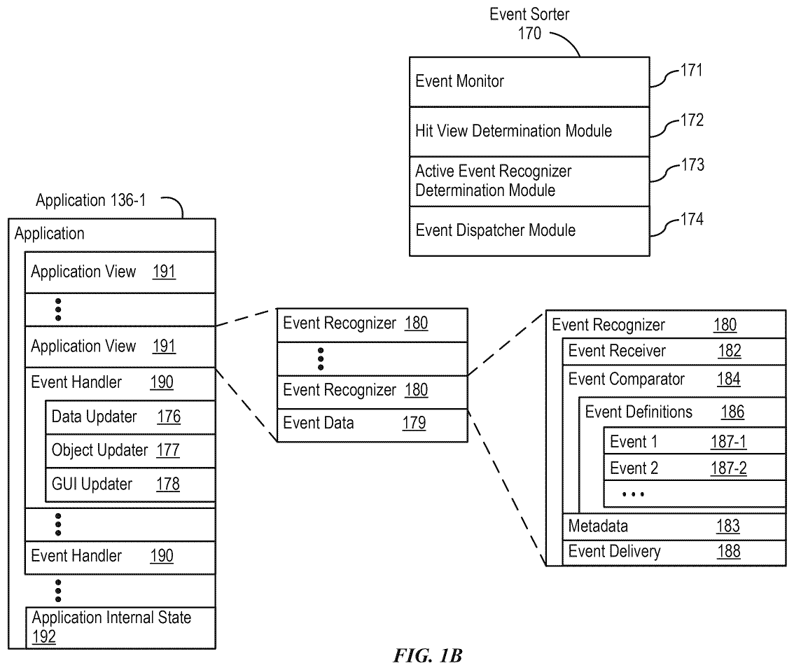

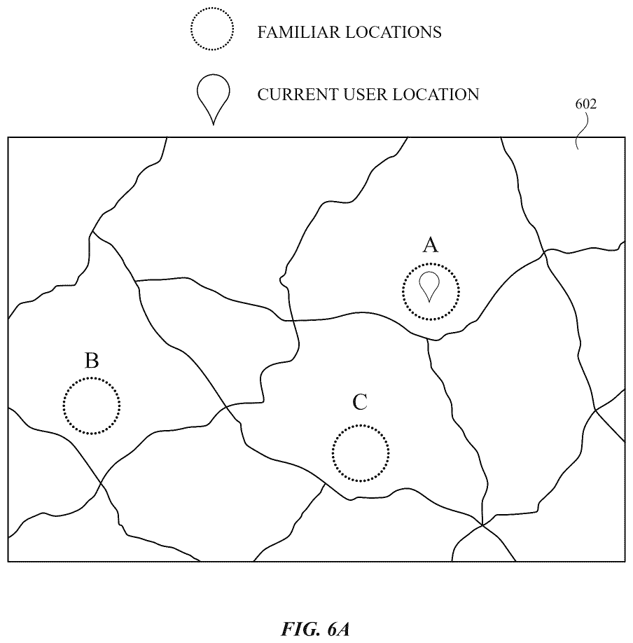

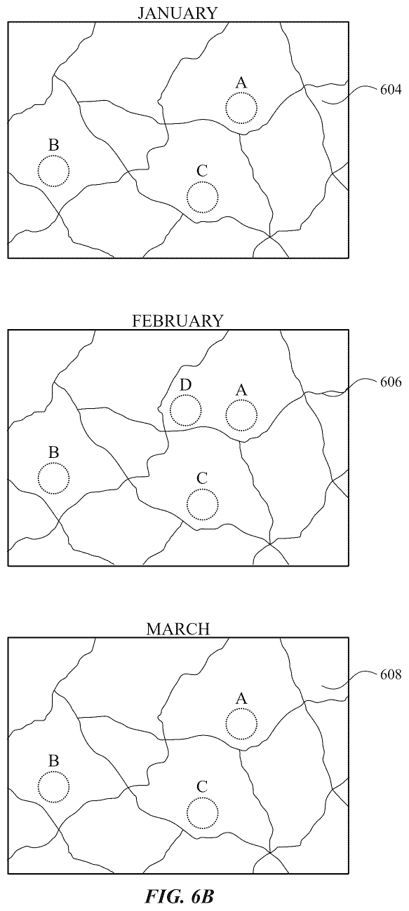

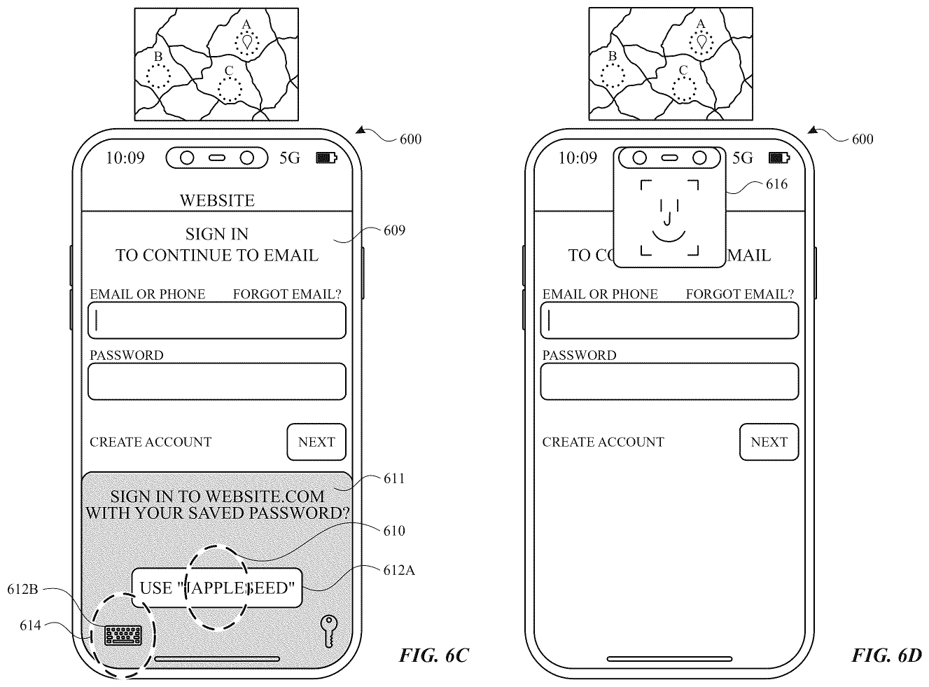

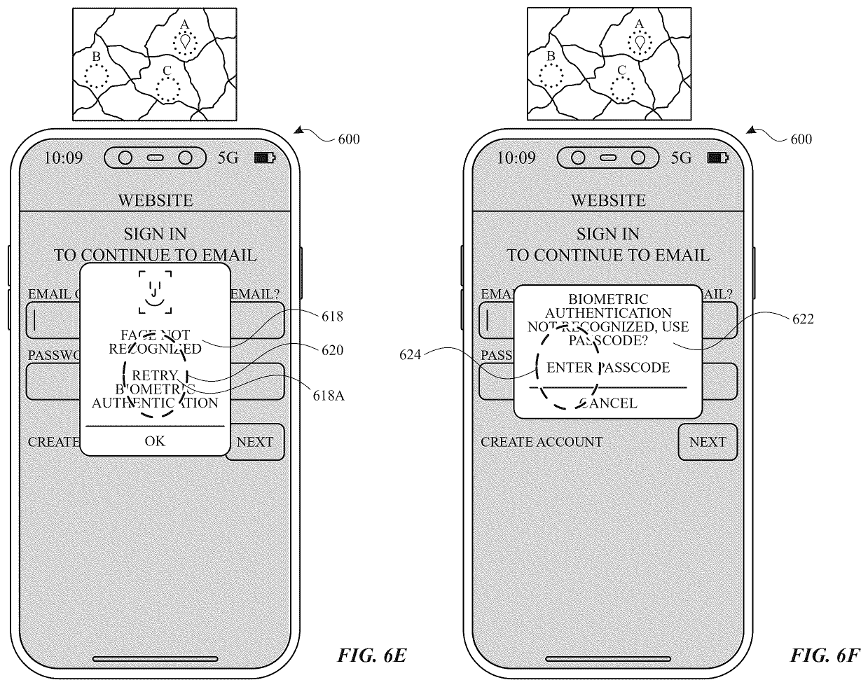

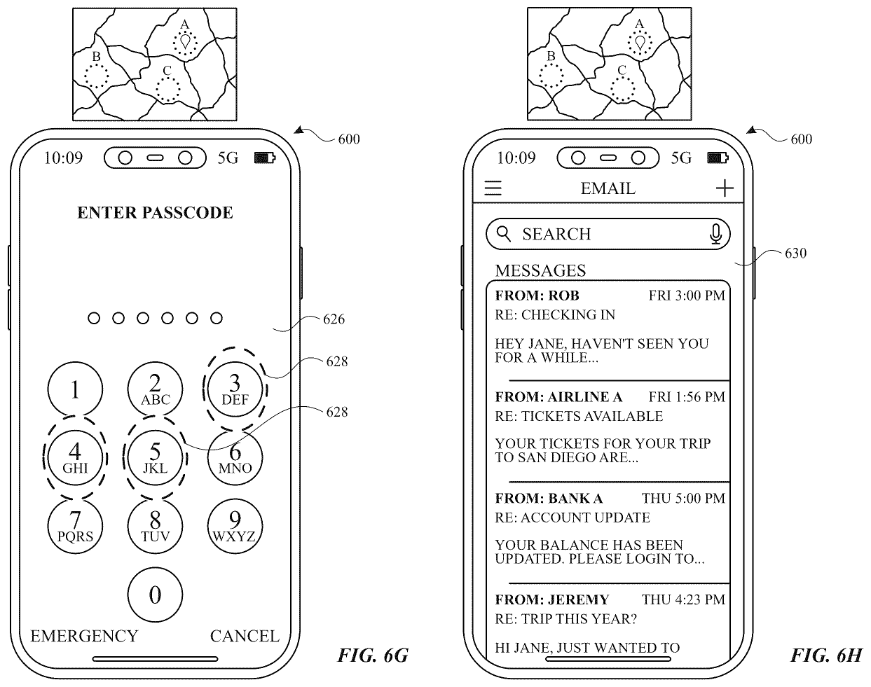

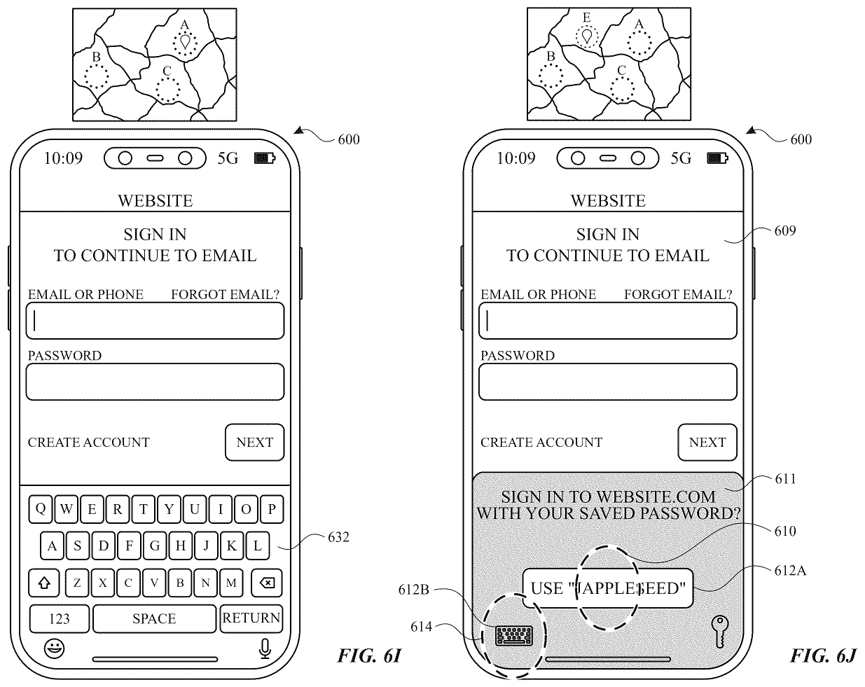

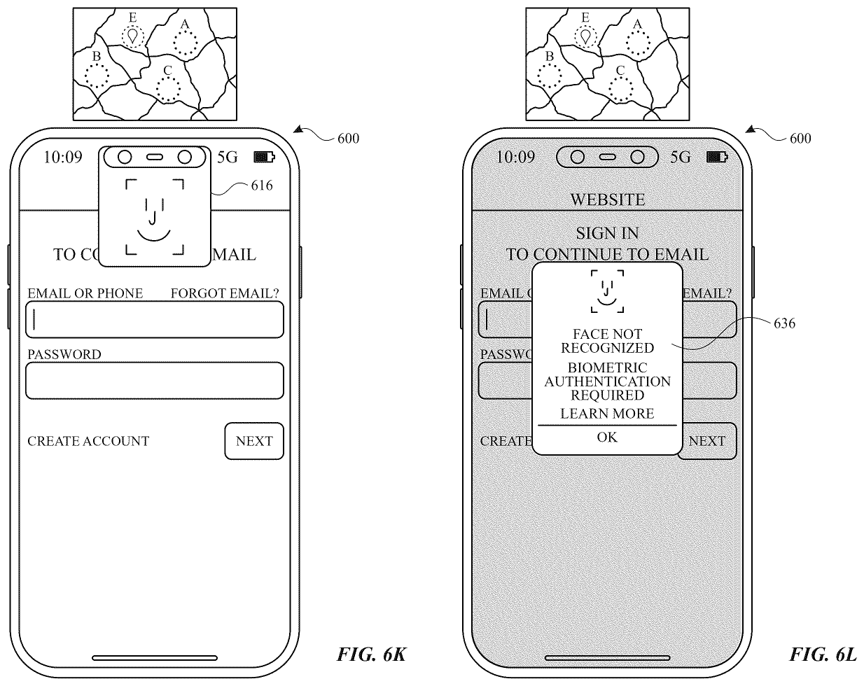

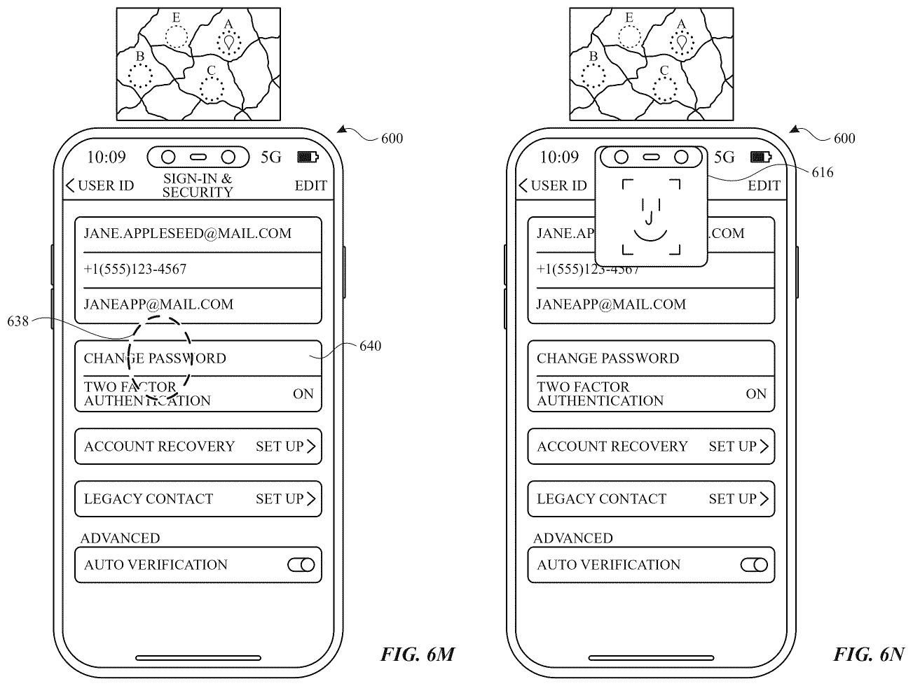

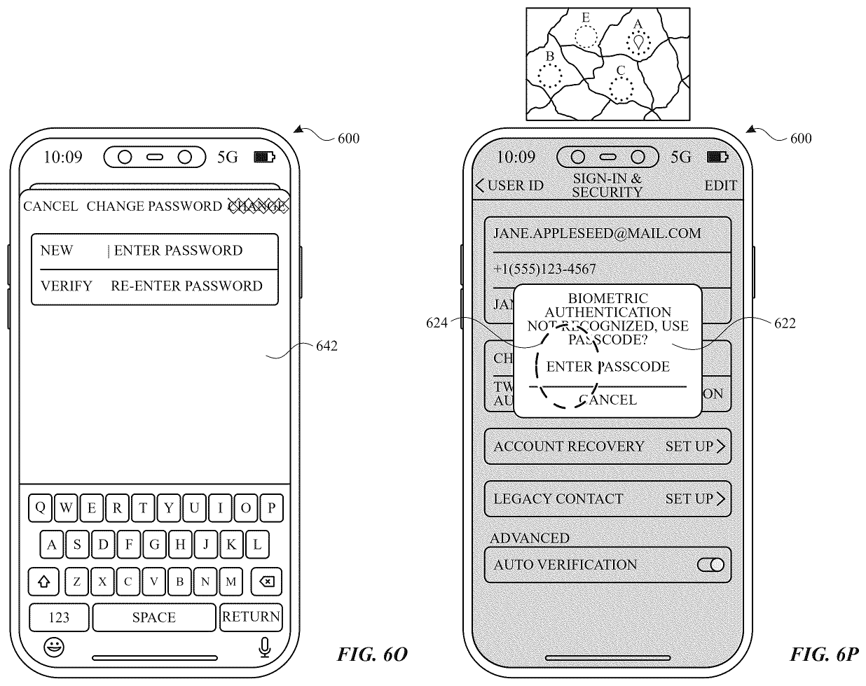

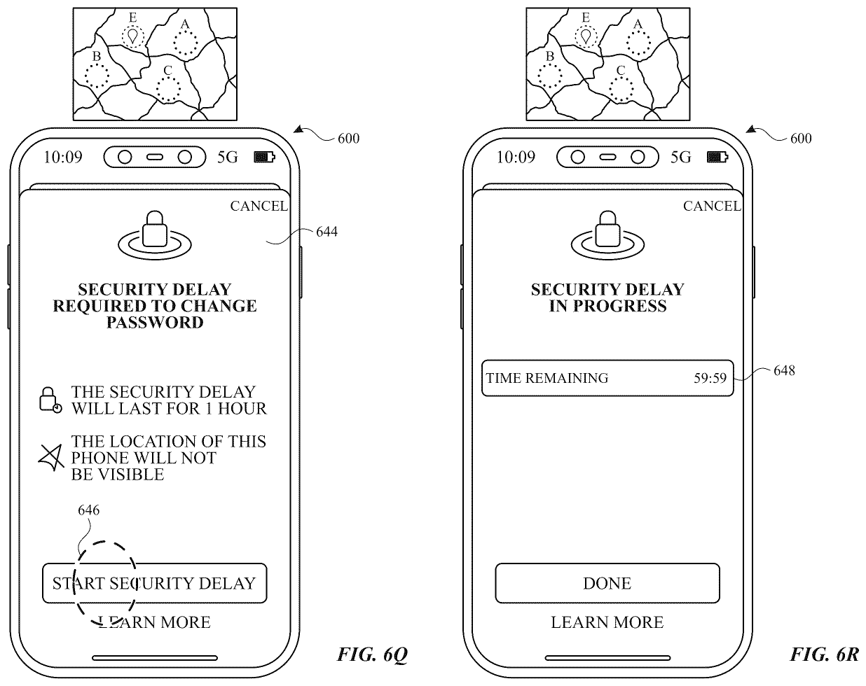

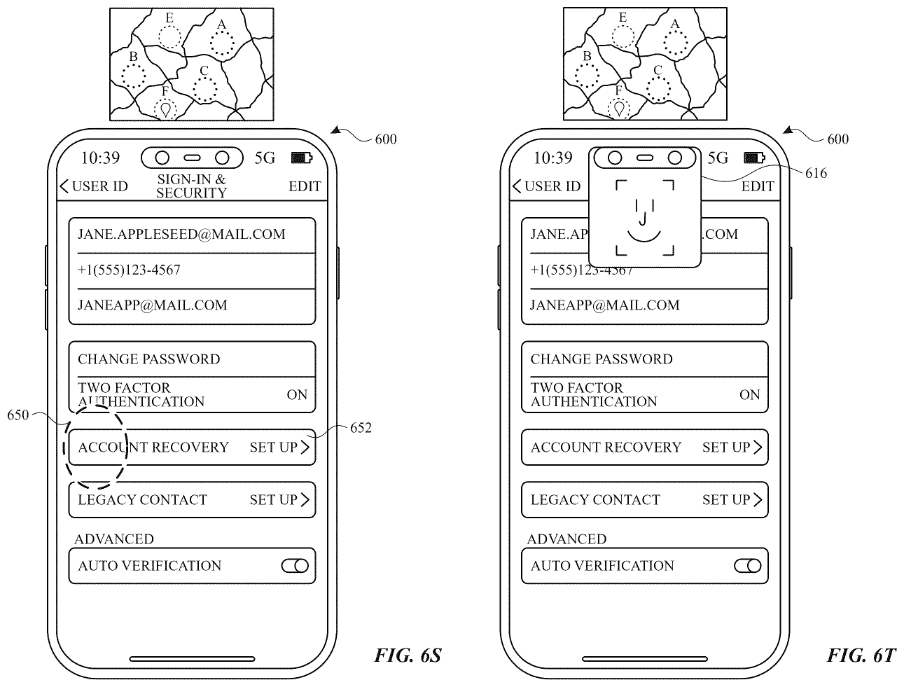

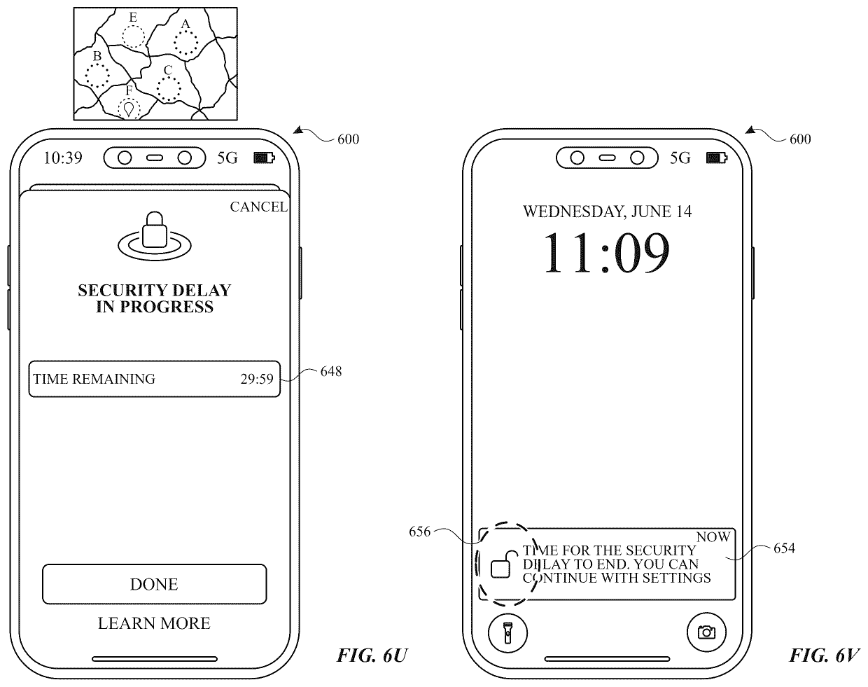

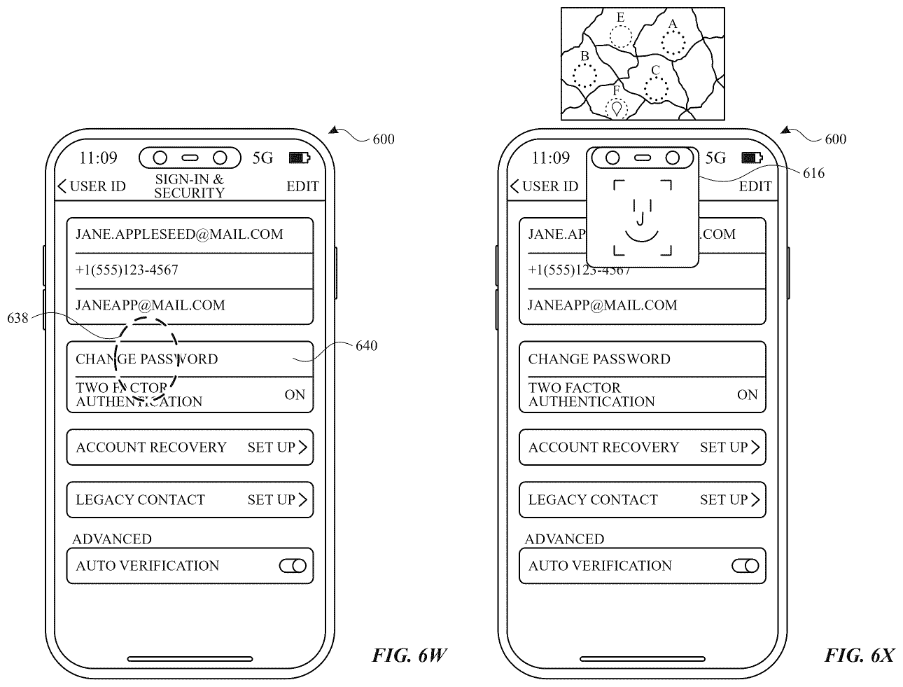

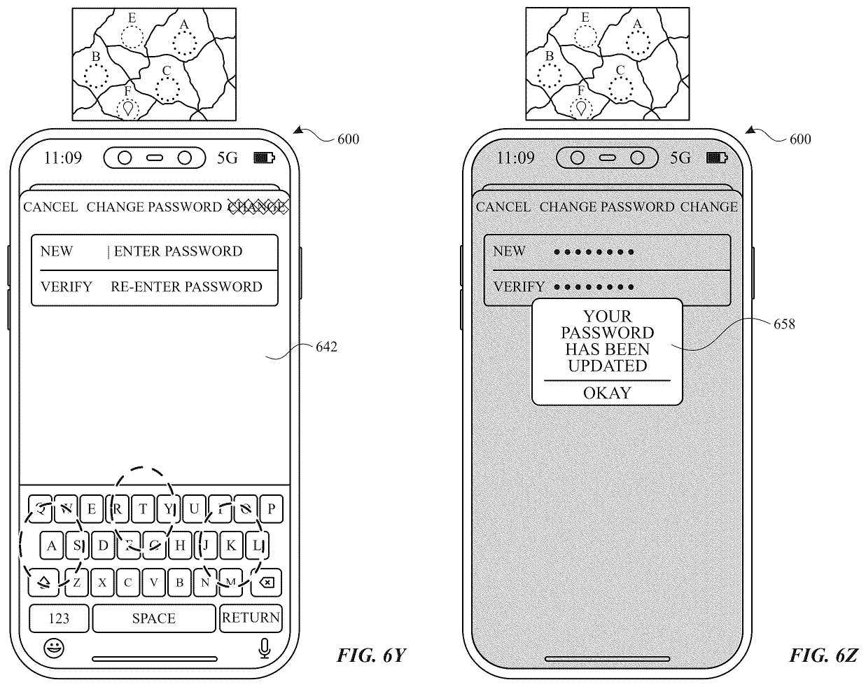

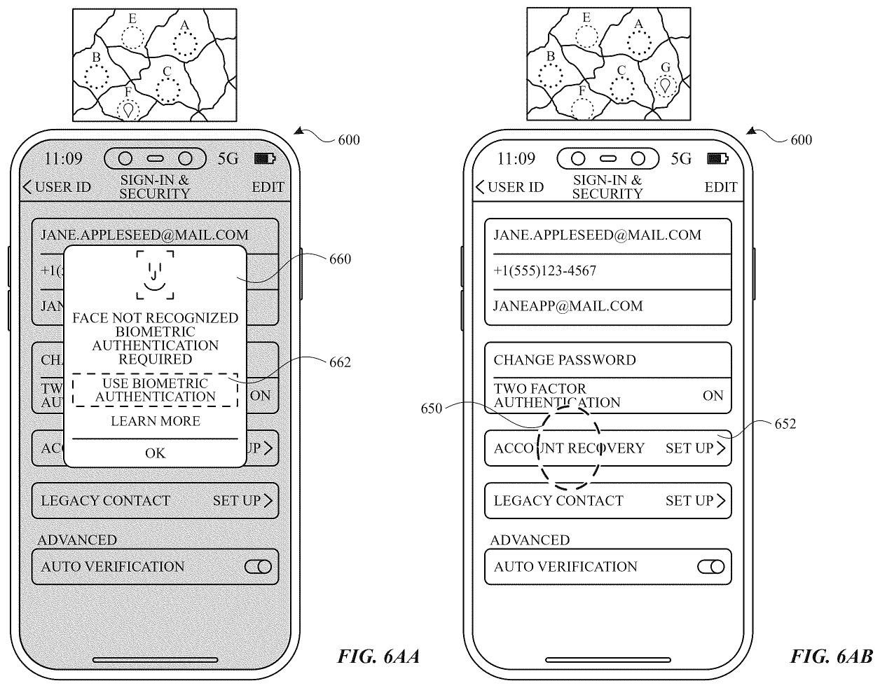

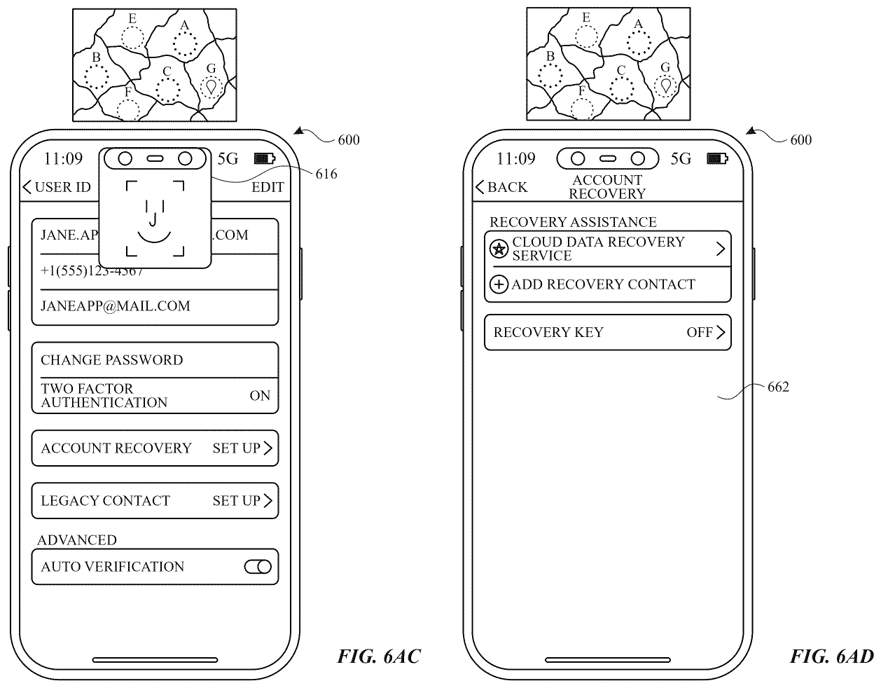

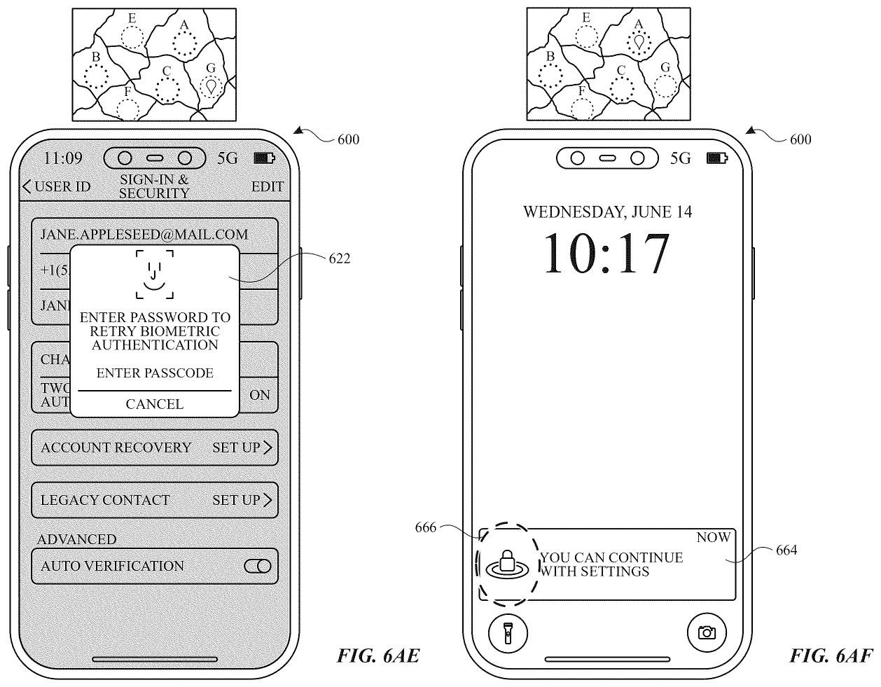

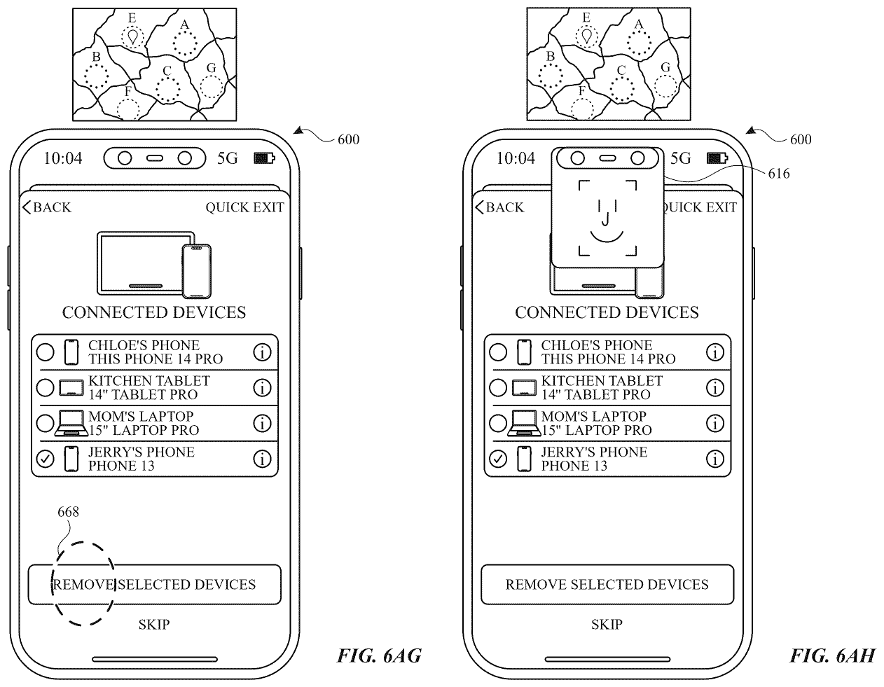

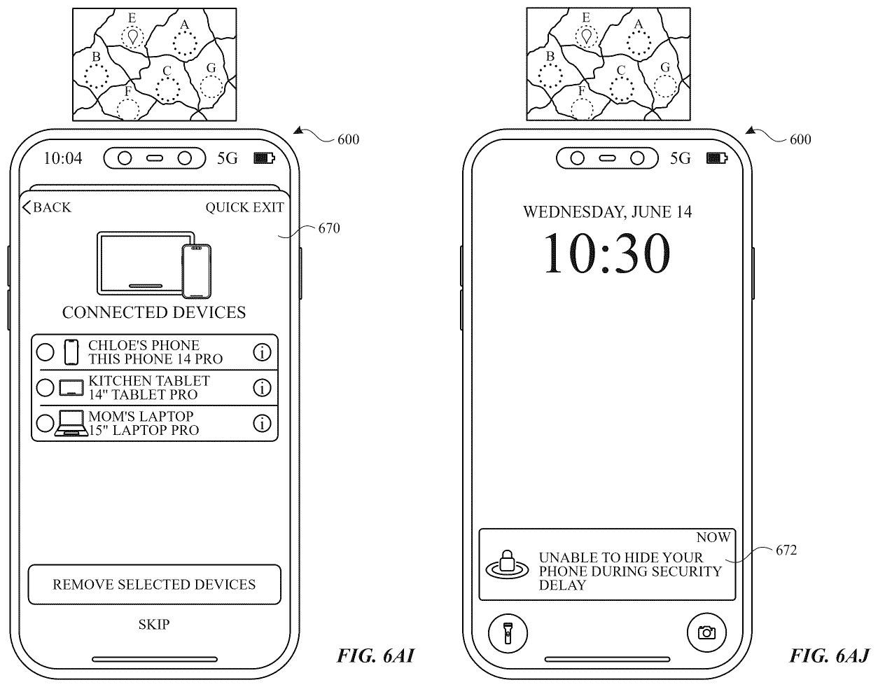

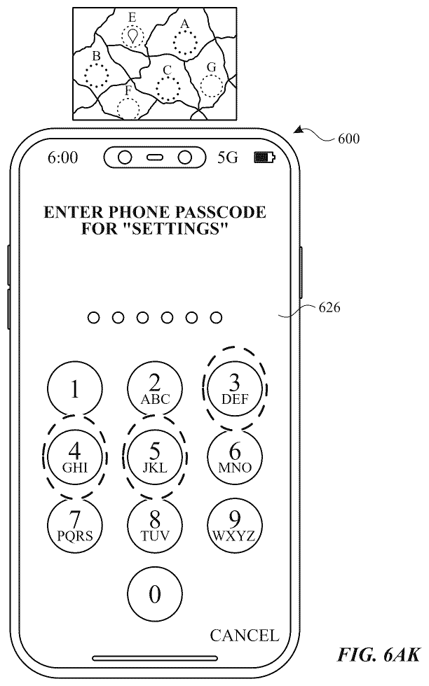

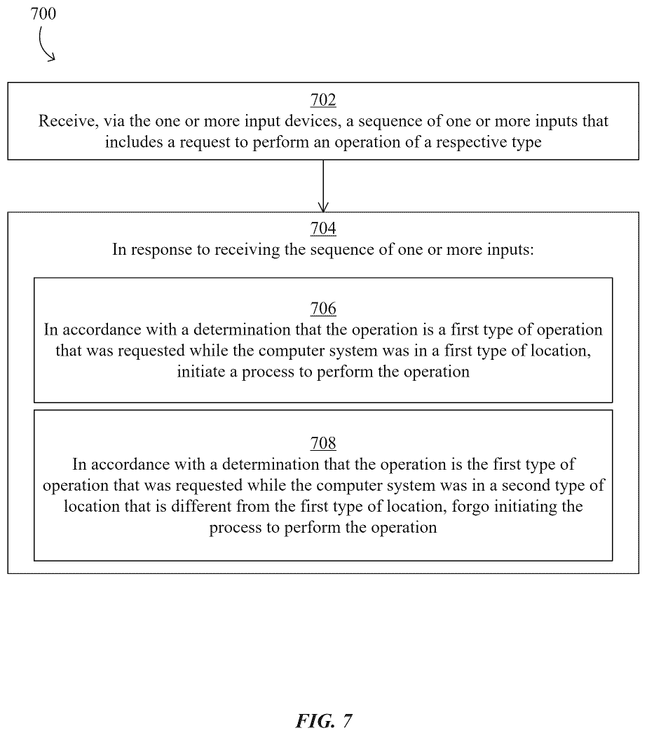

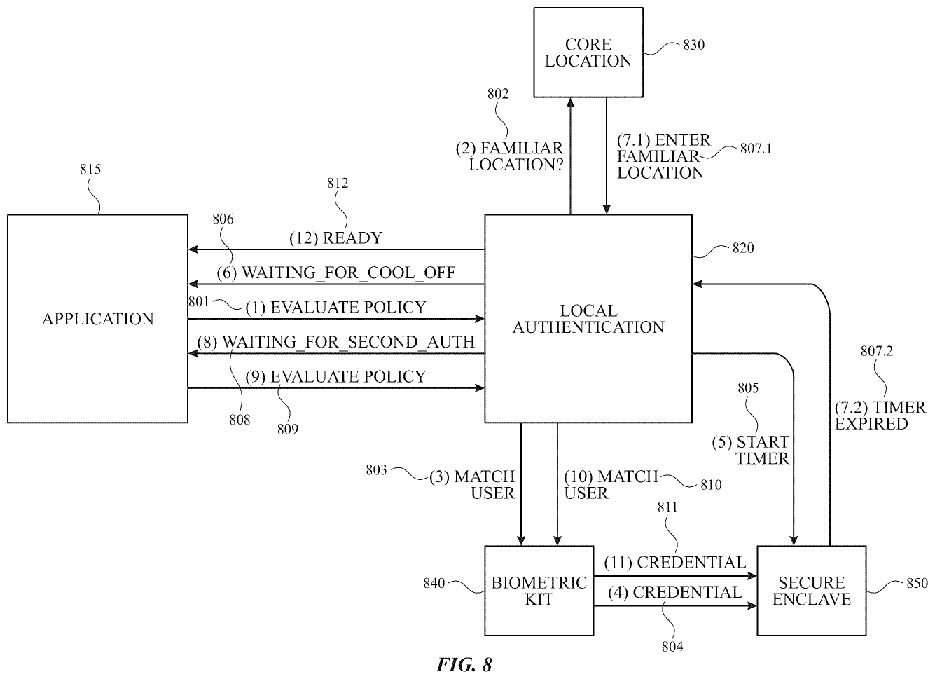

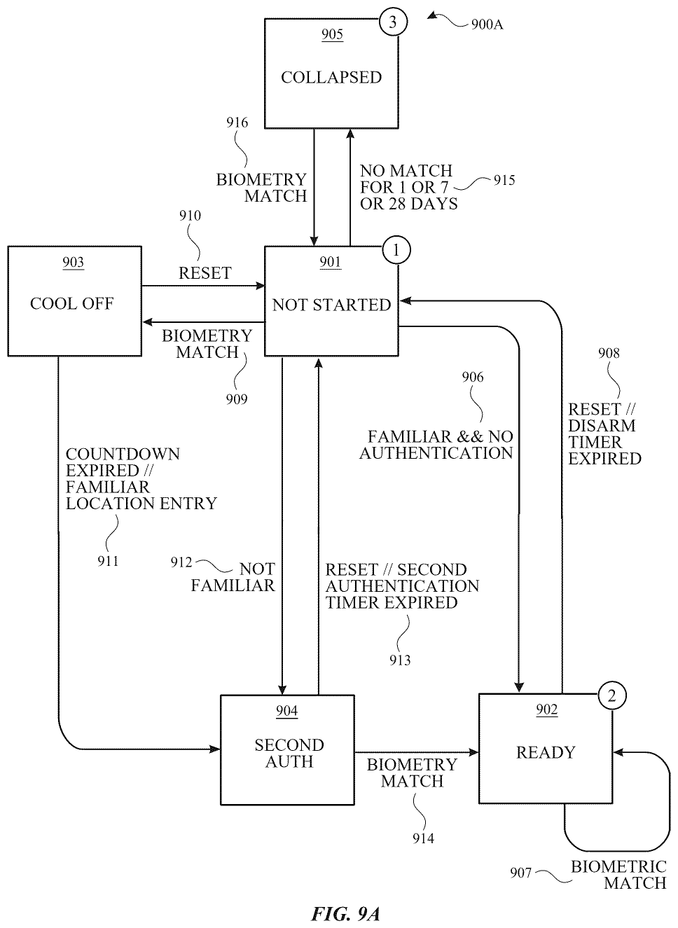

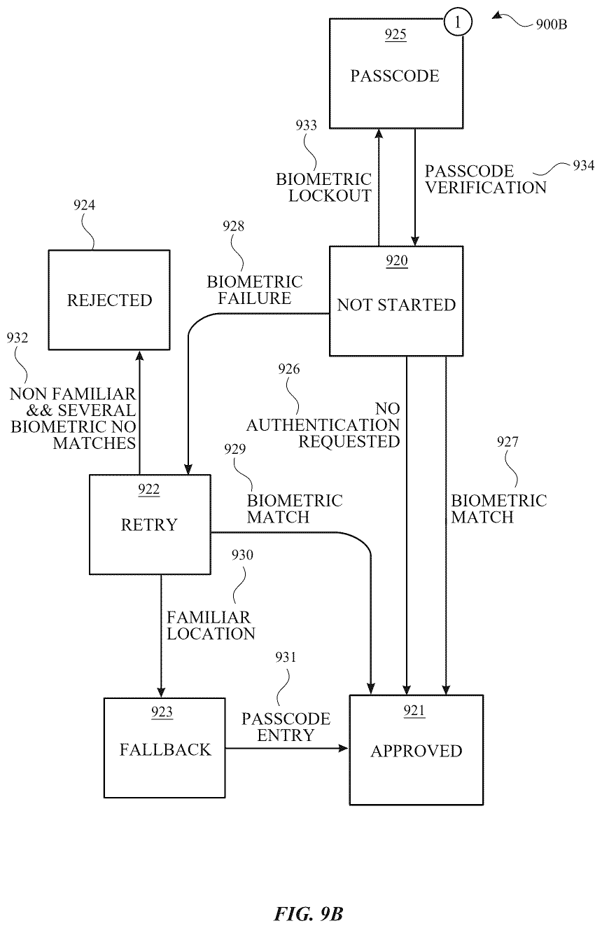

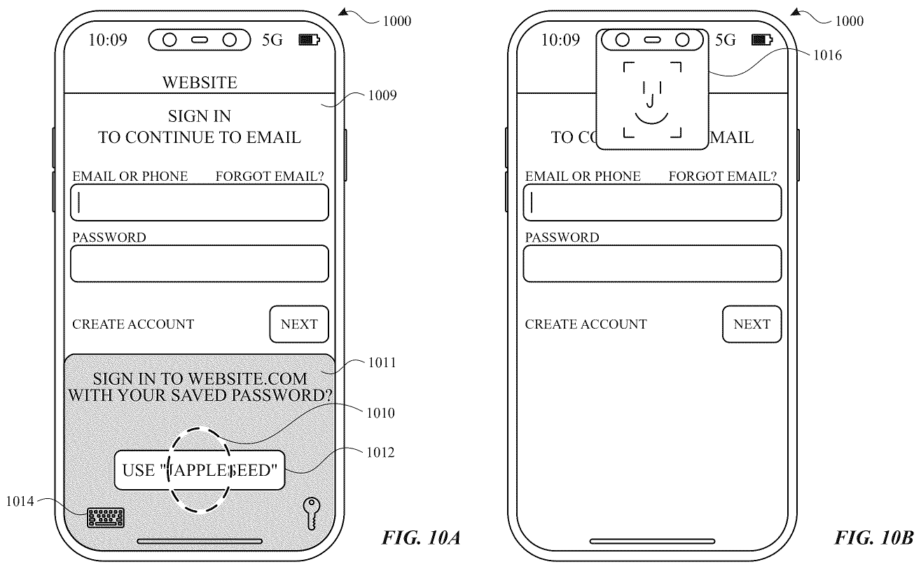

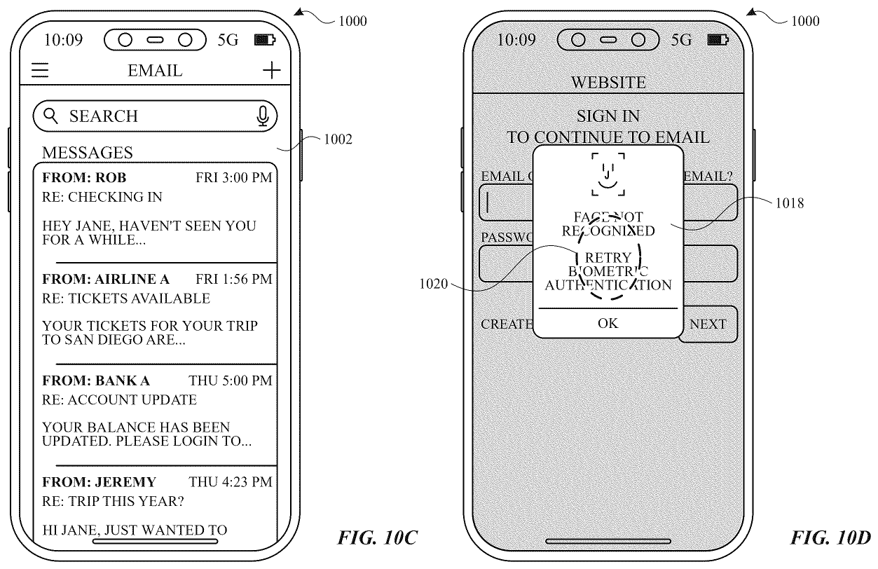

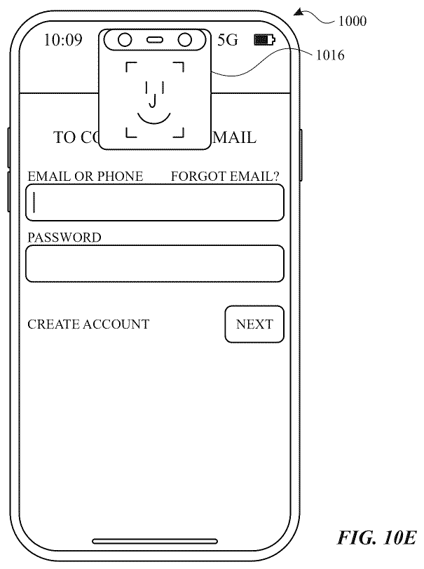

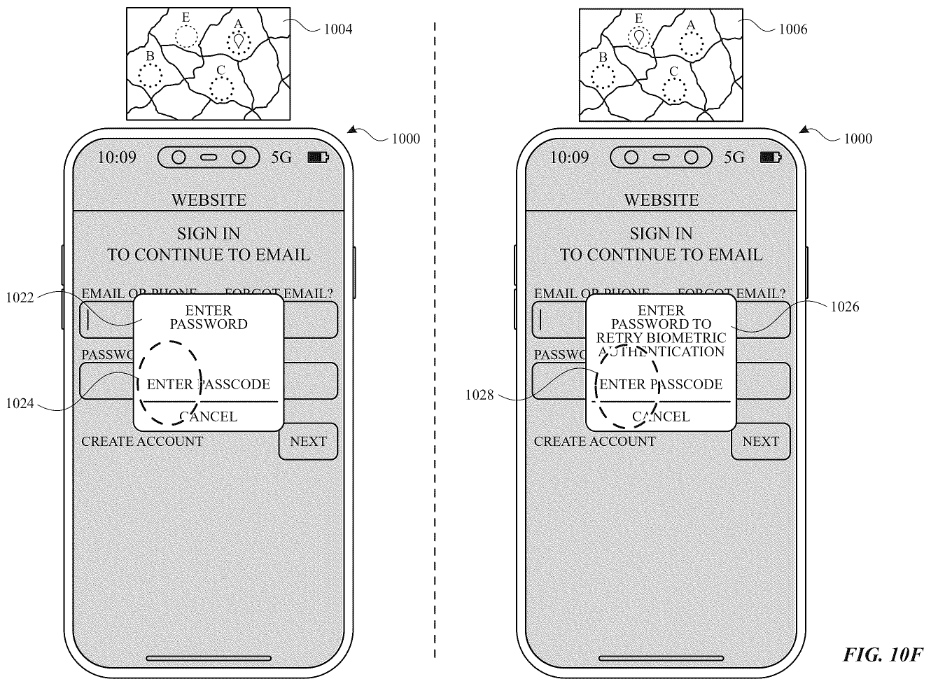

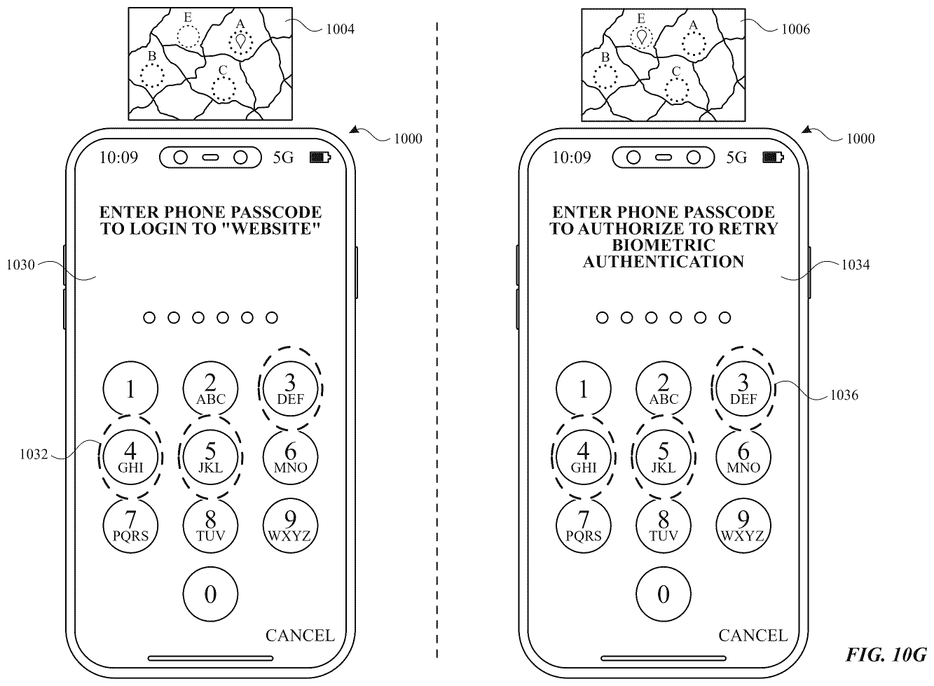

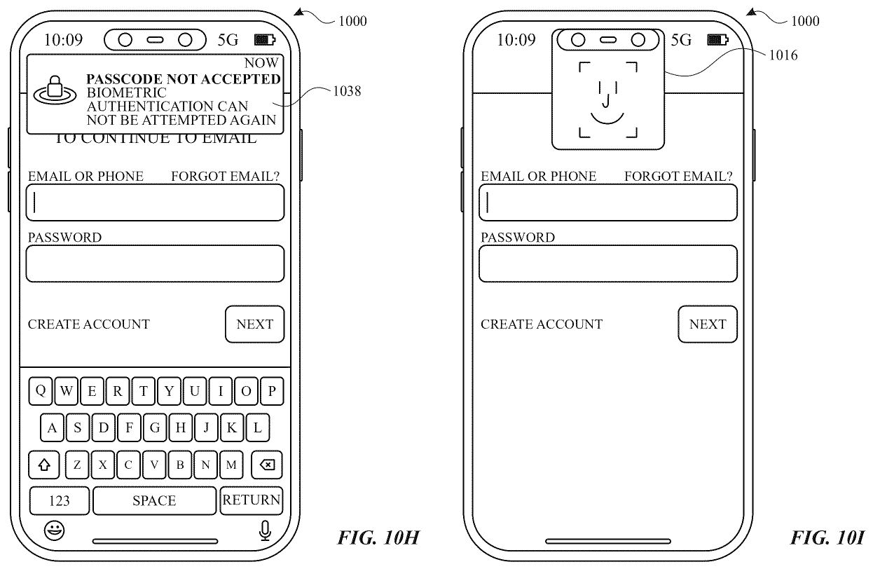

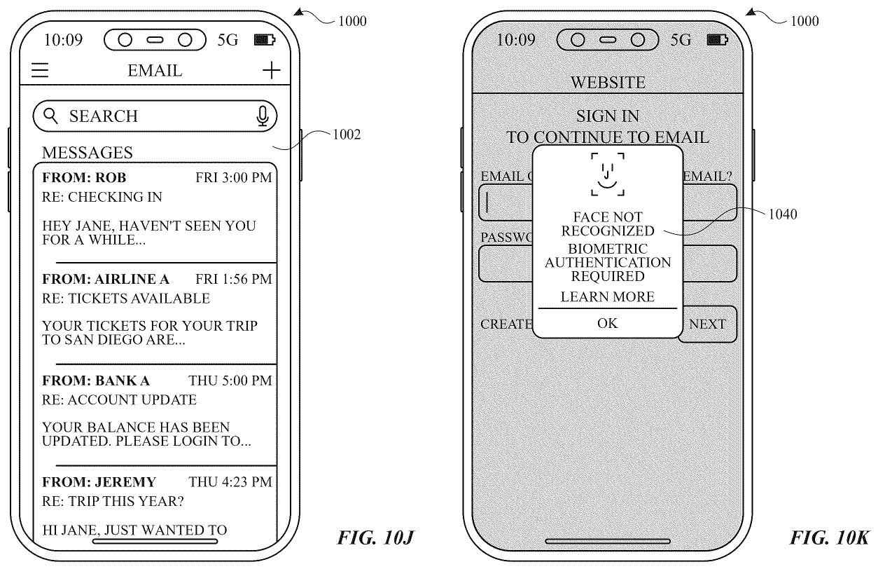

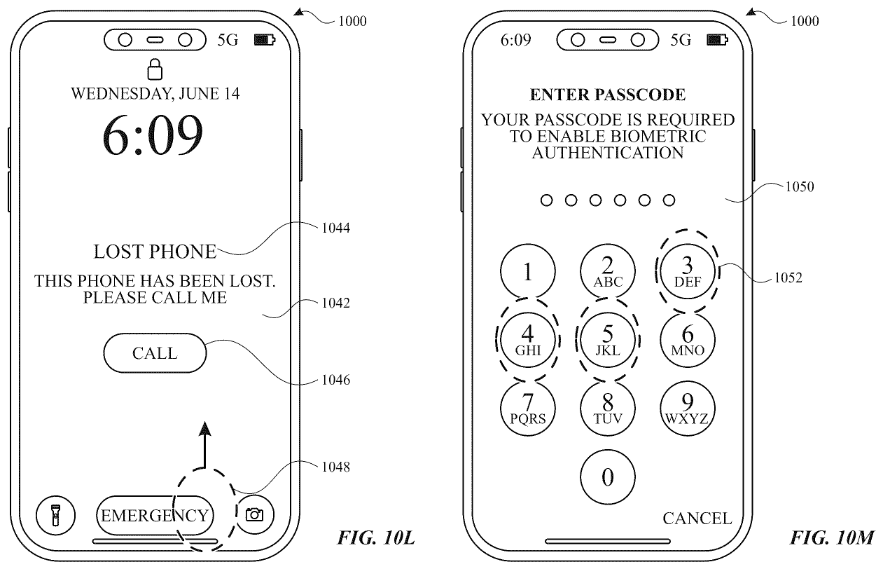

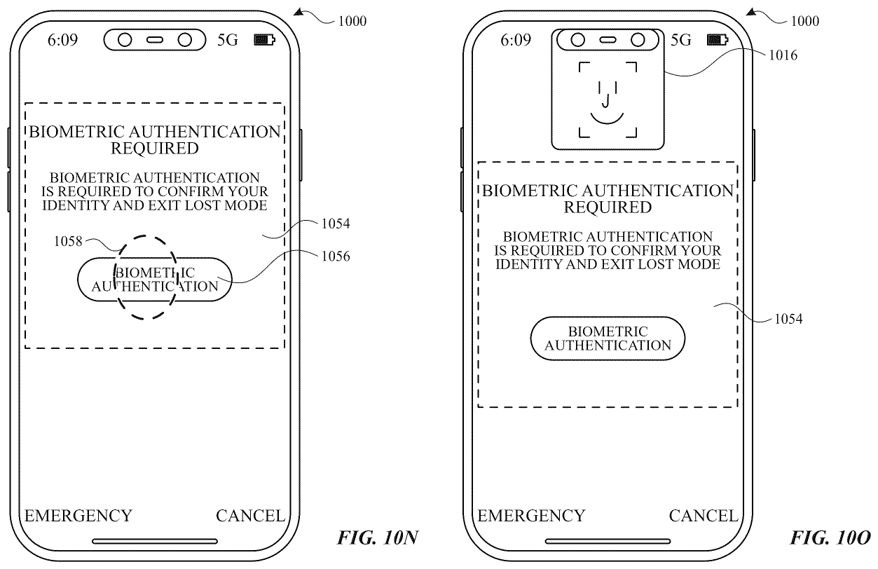

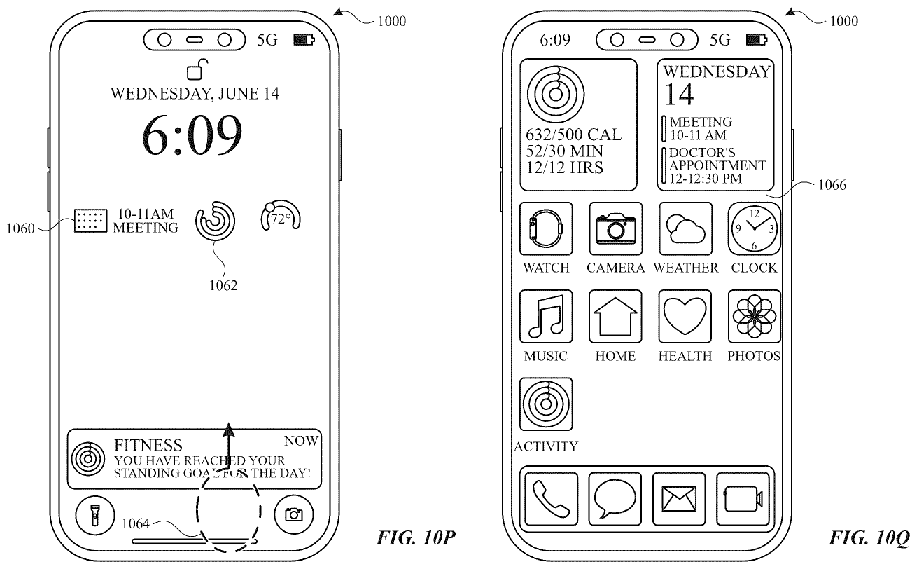

Below, FIGS. 1A-1B, 2, 3, 4A-4B, and 5A-5B provide a description of exemplary devices for performing the techniques for managing user authentication. FIGS. 6A-6AK illustrate example user interfaces for authentication based on location. FIG. 7 is a flow diagram illustrating a method for displaying user interfaces for authentication based on location in accordance with some embodiments. The user interfaces in FIGS. 6A-6AK are used to illustrate the processes described below, including the processes in FIG. 7. FIG. 8 is a block diagram illustrating a system for authentication based on location. FIGS. 9A and 9B are a flow diagram illustrating a method for authentication based on location. FIGS. 10A-10Q illustrate example user interfaces for authentication using multiple types of authentication. FIG. 11 is a flow diagram illustrating a method for displaying user interfaces for authentication using multiple types of authentication in accordance with some embodiments. The user interfaces in FIGS. 10A-10Q are used to illustrate the processes described below, including the processes in FIG. 11. FIG. 12 is a flow diagram illustrating a method for performing authentication to perform an operation in accordance with some embodiments. The user interfaces in FIGS. 6A-6AK and 10A-10Q are used to illustrate the processes described below, including the process in FIG. 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, providing additional security options, limiting the ability of an unauthorized user to perform operations, making it easier and/or faster for an authorized user to authenticate and to perform a requested operation, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

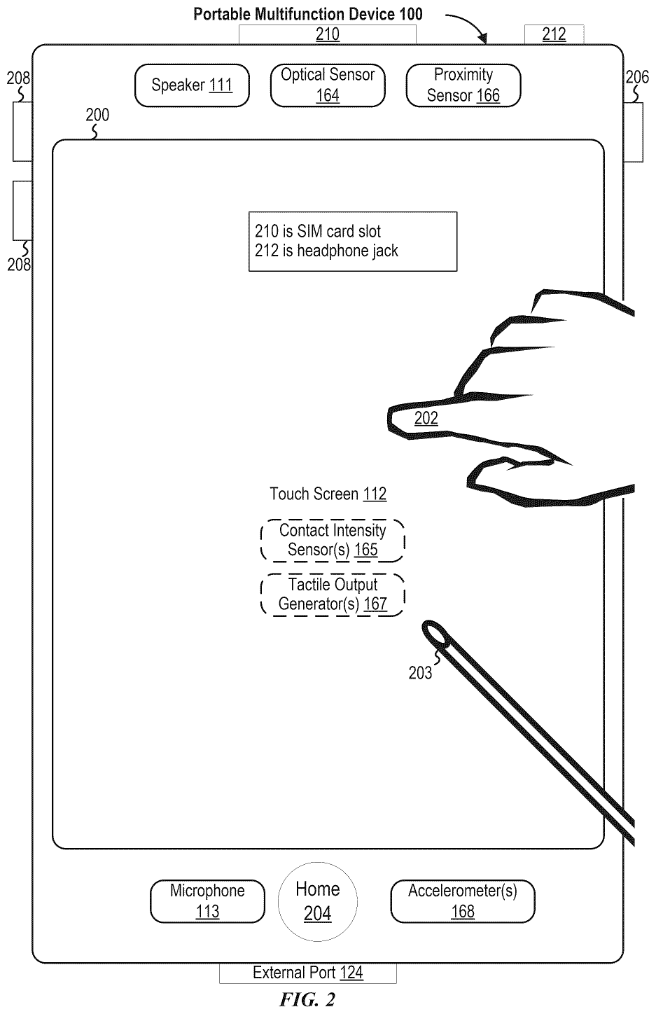

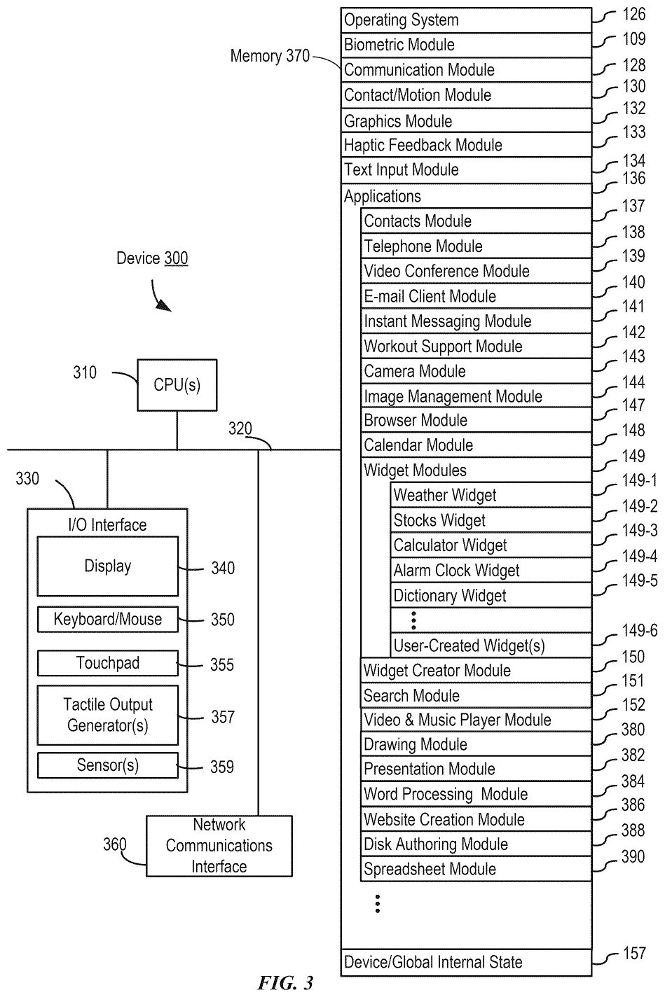

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, the secure element provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, the secure element provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, the secure element provides (e.g., releases) the secure information. In accordance with a determination that the fingerprint is not consistent with the enrolled fingerprint, the secure element forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

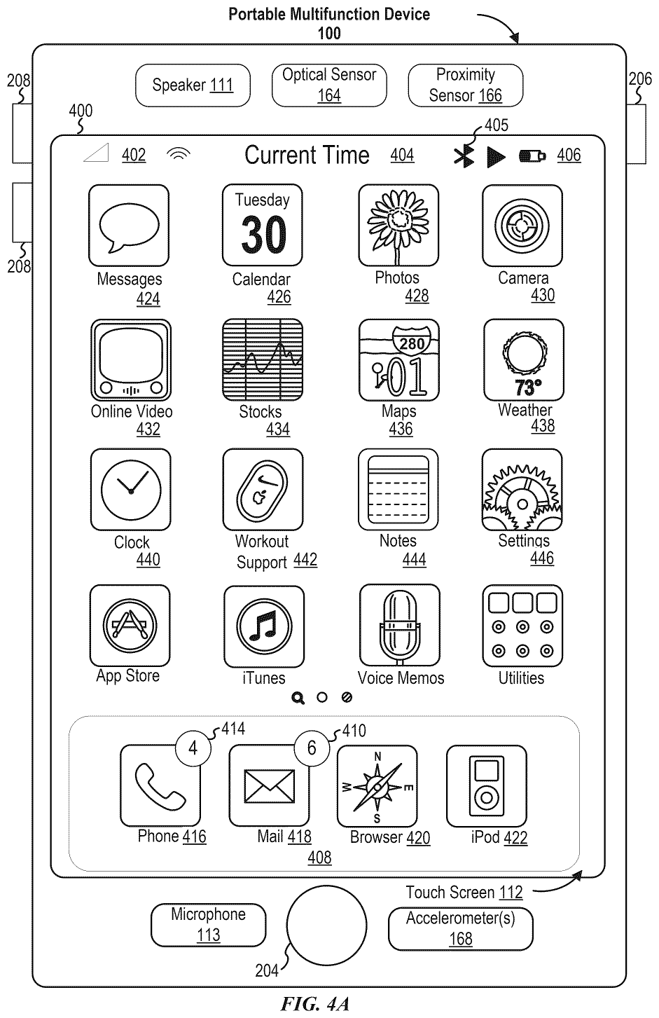

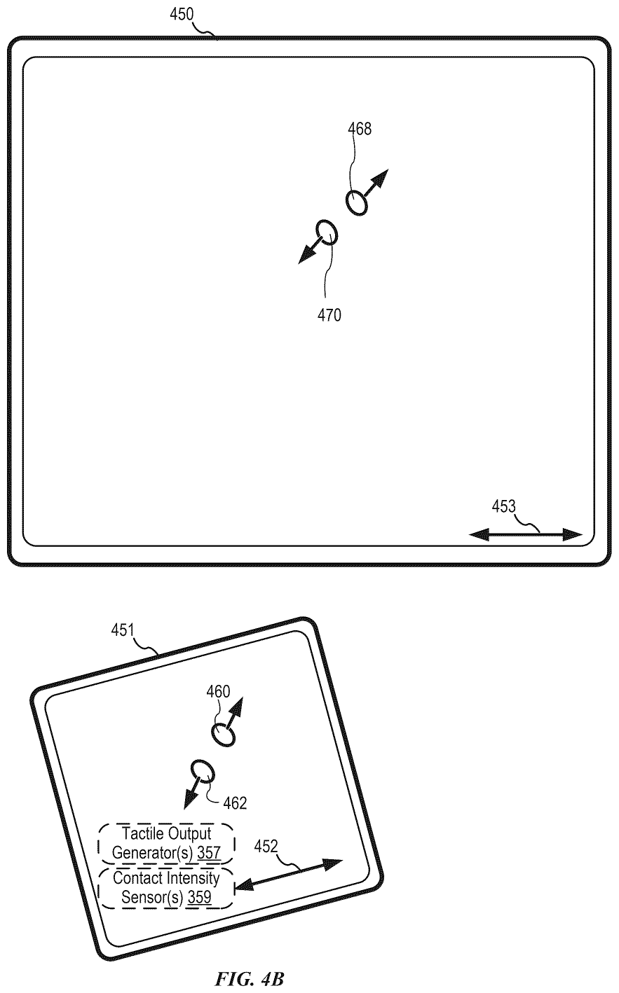

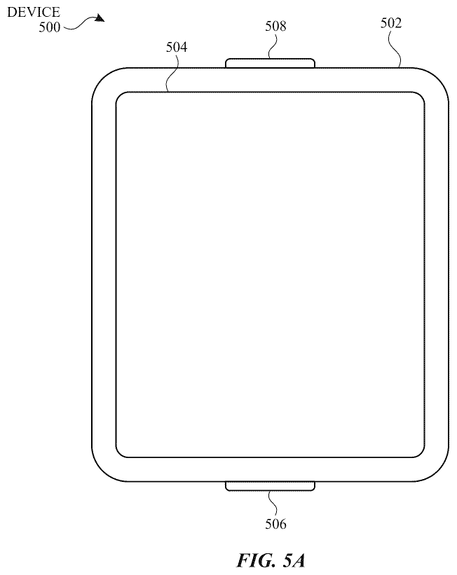

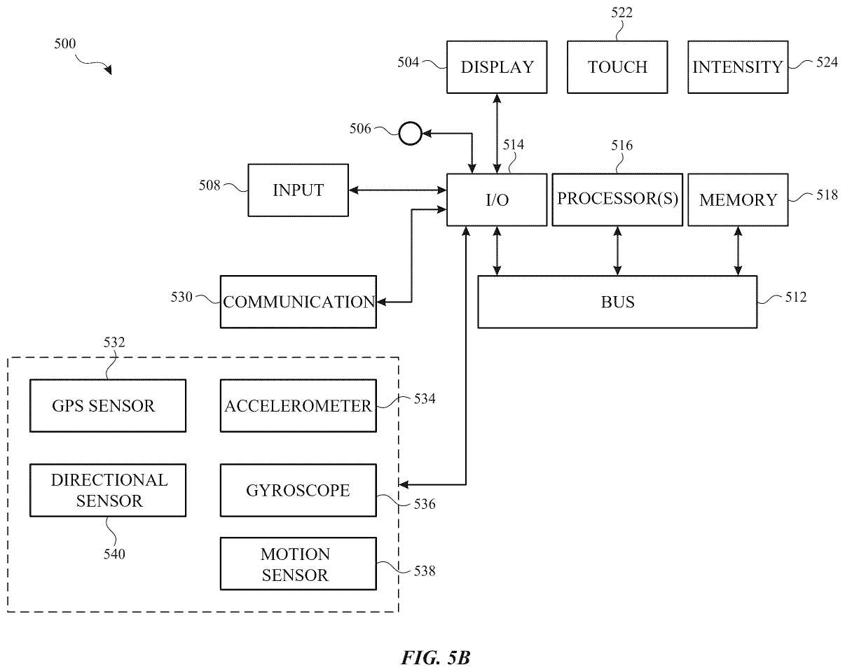

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 1100 (FIGS. 7 and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6AKC illustrate example user interfaces for authentication based on location, in accordance with some embodiments. The user interfaces in these figures are used to illustrate the processes described below, including the processes in FIG. 7.

The computer systems described below adapt security procedures based on the location of the computer system and, in particular, based on whether the computer system is in a familiar location or an unfamiliar location. In a familiar location, lower security is needed for the computer system to perform operations that are requested by a user. Accordingly, the computer system relies on fewer successful authentication attempts (e.g., as compared to an unfamiliar location) from the user or may allow different types of successful authentication attempts perform the operation. In contrast, in an unfamiliar location, higher security is used because of the possible threat of someone other than the user attempting to perform an operation and/or access private information of the user. Thus, the computer system uses multiple successful authentication attempts that are, optionally, separated by a time delay, to ensure that the user is the person requesting the performance of operations.

FIG. 6A illustrates map 602 of a local area including several locations that are familiar locations to a user device such as computer system 600, discussed further below. Map 602 is provided for the understanding of the reader and is not a user interface of computer system 600. In particular, map 602 identifies the familiar locations of a user's home (e.g., location A), the user's workplace (e.g., location B), and the user's parents' home (e.g., location C). Further, map 602 shows that computer system 600 is current located at the familiar location of the user's home (e.g., location A). In some embodiments, the familiar locations associated with the user and/or computer system 600 are based on factors including the frequency at which computer system 600 is present at a location, whether computer system 600 or another device associated with computer system 600 is initially setup at the location, and/or whether computer system 600 is charged overnight at the location. Areas other than the locations identified as familiar locations (e.g., the user's home, the user's workplace, and the user's parents' home) are unfamiliar locations for computer system 600.

Accordingly, as shown in FIG. 6B, when the user travels to a hotel and computer system 600 is located at the hotel for an amount of time or is charged overnight at the hotel, the hotel becomes a familiar location. Thus, the hotel can be an unfamiliar location in January, as shown in map 604, and then when the user takes a trip and stays at the hotel overnight with computer system 600 in February the hotel can become a familiar location, denoted as location D, as shown in map 606. The hotel can then remain a familiar location while the user resides at the hotel (e.g., for a work trip) and when the user then travels home with computer system 600 the hotel is removed as a familiar location (thus, optionally, returning to being an unfamiliar location), as shown in map 608 for the month of March. In some embodiments, whether locations are familiar or unfamiliar is optionally updated on an as-need, hourly, daily, weekly, or monthly basis. Locations can be removed from a list of familiar locations based on criteria including that the user has not visited the location recently with computer system 600, another location is to be added to the list of familiar locations, and/or a user requests that the location be removed as a familiar location.

At FIG. 6C, computer system 600 is displaying webpage 609 and has received a request (e.g., via a tap input on a credential field of the website) to fill in webpage credentials (e.g., username and/or password). In response to the request to fill in the webpage credentials, computer system 600 displays sheet 611, which includes autofill option 612A and keyboard option 612B. At FIG. 6C, computer system 600 detects an input (e.g., tap input 610) directed to autofill option 612A. In response to detecting the input (e.g., tap input 610) directed to autofill option 612A, computer system 600 determines the type of operation that is requested—a request to autofill the sign-in fields for the displayed website 609. Accordingly, computer system 600 determines that the requested operation is an operation which requires authentication from the user and displays request 616 for biometric authentication, as shown in FIG. 6D.

Exemplary biometric authentications include authentications using face scans, fingerprint scans, and/or eye scans, which are received using various sensors of computer system 600, such as a camera, a fingerprint scanner, and/or other sensors configured to capture biometric information for use in the biometric authentication. Accordingly, computer system 600 optionally uses different types of biometric authentication when authenticating a user and, as discussed more below, optionally additionally uses alternative types of authentications, such as authentication with a passcode and/or password.

Exemplary operations that require authentication optionally include autofilling of a password or a sign in credential, changing a password associated with a user account, changing a user ID associated with a user account, adding or removing a trusted device, adding or removing a trusted contact information, adding or removing a security key, adding or removing a recovery contact, unlocking a lost mode, turning off a setting for finding computer system 600, applying for a credit card, transferring funds between accounts, reviewing banking information, provisioning virtual accounts and/or payment cards, connecting financial accounts, adding new associated devices, and/or approving sign-ins on related devices. Additionally, as discussed further below, some of the operations that require authentication are critical account changes, which require a higher level of security in unfamiliar locations. In particular, changing a password associated with a user account, changing a user ID associated with a user account, adding or removing a trusted contact information, adding or removing a security key, adding or removing a recovery contact, and/or turning off a setting for finding computer system 600 are examples of critical account changes, which require a higher level of security.

At FIG. 6D, computer system 600 receives (e.g., via a camera or other appropriate sensor (e.g., biometric sensor) of computer system 600) biometric information from the user (e.g., before, after, and/or during display of request 616). When the received biometric information does not match an enrolled biometric, computer system 600 displays prompt 618, at FIG. 6E, indicating that the biometric authentication information does not match the enrolled biometric and that biometric authentication can be tried again. At FIG. 6E, in response to detecting an input (e.g., tap input 620) directed to retry option 618A, computer system 600 displays request 616 (e.g., again), as shown in FIG. 6D and receives another biometric information from the user (e.g., to be checked for a match with an enrolled biometric). In some embodiments, the biometric authentication may be attempted a predetermined number of times (e.g., 2, 5, or 10) prior to computer system 600 providing an option to use alternative authentication (e.g., a password and/or passcode). Thus, when at a familiar location, computer system 600 optionally receives several failed biometric authentications before allowing (or, optionally, provided an option to use) an alternative type of authentication or locking out a user, as discussed further below.

After the predetermined number (e.g., 2, 5, or 10) of failed biometric authentications, computer system 600 determines whether alternative authentication can be used to authenticate the user's identity and approve the operation request. In particular, computer system 600 determines that the requested operation requires authentication and that the computer system 600 is at the user's home (e.g., a familiar location) and/or the request (e.g., tap input 610) was received while computer system 600 was at the user's home (e.g., a familiar location). Thus, because computer system 600 is at a familiar location (and/or was at a familiar location when the request was received), computer system 600 determines that alternative authentication (e.g., non-biometric authentication, such as a password and/or passcode) can be used and displays prompt 622 requesting a passcode, as shown in FIG. 6F. Computer system 600 detects an input (e.g., tap input 624) directed to prompt 622 and in response to detecting the input (e.g., tap input 624) directed to prompt 622, computer system 600 displays passcode user interface 626, as shown in FIG. 6G.

While displaying passcode user interface 626, computer system 600 detects series of user inputs 628 that provide the passcode. In response to detecting series of user inputs 628, computer system 600 compares the received passcode to a passcode stored in association with the user account. When the received passcode matches the passcode stored in association with the user account, the authentication attempt succeeds and computer system 600 completes the autofill for the sign in attempt (e.g., submits the webpage credentials to the website) to show email interface 630, as shown in FIG. 6H. Thus, when in a familiar location, computer system 600 enables the user to perform operations that require authentication by successfully authenticating with biometric authentication or with the alternative authentication (e.g., password or passcode). When the received passcode does not match the passcode stored in association with the user account, computer system 600 does not autofill for the sign in attempt and, therefore, does not display user interface 630 and instead notifies the user that the passcode was incorrect.

In some embodiments, the alternative authentication requested by computer system 600 is an alternative type of biometric authentication such as authentication using face scans, fingerprint scans, and/or eye scans that is received using various sensors of computer system 600 such as a camera, a fingerprint scanner, and/or other sensors configured to capture the biometric authentication. Accordingly, if a biometric authentication attempt using a face scan does not succeed, computer system 600 optionally requests a fingerprint scan and/or an eye scan rather than a passcode and/or password as discussed above.

Returning to FIG. 6C, while displaying sheet 611, which includes autofill option 612A and keyboard option 612B, computer system 600 detects an input (e.g., user input 614) directed to keyboard option 612B to display a virtual keyboard. In response to detecting the input directed to keyboard option 612B, computer system 600 determines that the type of operation requested is not an operation that requires authentication and accordingly performs the requested operation (e.g., displaying keyboard 632) without any intervening authentication attempts. Thus, computer system 600 displays keyboard 632, as shown in FIG. 6I. The location of computer system 600 when the input (e.g., user input 614) directed to keyboard option 612B is detected is not relevant to the performance of the requested operation because authentication is not required for the requested operation (e.g., displaying keyboard 632). Thus, the operation associated with keyboard option 612A will be performed by computer system 600 when the user input (e.g., user input 614) directed to keyboard option 612B is detected regardless of the location of computer system 600 (e.g., regardless of whether computer system 600 is at a familiar or unfamiliar location). Accordingly, when user input 614 is detected in an unfamiliar location (e.g., location E), as shown in FIG. 6J, computer system 600 performs the requested operation and displays keyboard 632, as shown in FIG. 6I.

At FIG. 6J, while displaying sheet 611, which includes autofill option 612A and keyboard option 612B, computer system 600 detects an input (e.g., tap input 610) directed to autofill option 612A while computer system 600 is located at an unfamiliar location. Computer system 600 determines that the operation is an operation which requires authentication from the user, as discussed above, and provides request 616 for biometric authentication, as shown in FIG. 6K. However, because computer system 600 is located at an unfamiliar location, when the received biometric information does not match an enrolled biometric, computer system 600 does not allow the user to provide a passcode to authenticate and instead provides notification 636, as shown in FIG. 6L. Thus, computer system 600 requires that the user successfully authenticate with biometric authentication in unfamiliar locations to perform operations that require authentication and the user cannot perform the operation by authenticating via the alternative authentication. This increases the security of computer system 600 by preventing another person who has access to computer system 600 from entering the user's passcode to gain access to sensitive information and/or perform restricted operations.

Turning to FIG. 6M, while computer system 600 displays a settings user interface that includes change password option 640, computer system 600 detects an input (e.g., tap input 638) directed to change password option 640 associated with the operation of changing the password for the user's account (e.g., an account that computer system 600 uses to sign into a remote service). Computer system 600 determines that the operation of changing the user's password is a critical account change and thus requires user authentication before the operation can be performed. Accordingly, computer system 600 displays request 616 for biometric authentication, as shown in FIG. 6N.

Computer system 600 determines that computer system 600 is at a familiar location (e.g., the user's home) and/or computer system 600 determines that the input (e.g., tap input 638) directed to change password option 640 was detected while at the familiar location of the user's home and thus, computer system 600 determines that the requested operation can be performed when a received biometric information matches an enrolled biometric. Thus, when computer system 600 is at a familiar location, a single successful biometric authentication is sufficient to authorize computer system 600 to perform an operation that is categorized as a critical account change. Accordingly, when the received authentication matches the enrolled biometric, computer system 600 determines that the user has been successfully authenticated and displays password change user interface 642, as shown in FIG. 6O.

However, when computer system 600 detects the input (e.g., tap input 638) directed to change password option 640 in a familiar location, such as the user's home, and the received biometric information does not match the enrolled biometric, computer system 600 allows the user to provide a passcode (e.g., a device passcode) as a fallback and displays prompt 622 requesting the passcode, as shown in FIG. 6P. Computer system 600 receives passcode (e.g., based on touch input entry by the user) and if the provided passcode matches a passcode associated with the user, computer system 600 displays password change user interface 642, as shown in FIG. 6O. Thus, when computer system 600 is at a familiar location, and biometric authentication is not successful, a password/passcode is sufficient to authorize computer system 600 to perform an operation that is categorized as a critical account change.

Returning to FIG. 6M, when computer system 600 detects an input (e.g., tap input 638) directed to change password option 640 while computer system 600 is at unfamiliar location E (e.g., while the computer system is not located at one of the familiar locations), such as a library, a coffee shop, or any other unfamiliar location and the received biometric information matches an enrolled biometric, computer system 600 determines that a first biometric authentication has been successful and that another biometric authentication is required after a security time delay has finished (e.g., elapsed). Accordingly, computer system 600 displays notification 644 that a security delay will be started, as shown in FIG. 6Q. In response to detecting an input (e.g., tap input 646) to start the security delay, as shown in FIG. 6Q, computer system 600 starts the security delay and displays current status 648 of the security delay, as shown in FIG. 6R. In some embodiments, computer system 600 starts the security delay and/or displays the current status of the security delay, as shown in FIG. 6R, in response to the determination that the first biometric authentication for a critical account change has been successfully passed, without displaying notification 644 and/or without requiring the input (e.g., tap input 646) to start the security delay.

During the security delay, computer system 600 is hidden from being located remotely for the user's safety. For example, computer system 600 does not report the location of mobile phone 600 to a service that optionally provides the location information to other devices (e.g., the user's other devices and/or devices of members of the user's family). Accordingly, people who may be able to gain access to the user's account remotely are not able to determine the user's location and impact the user's ability to use computer system 600. Further, the user is notified that the location is hidden, as shown in notification 644 of FIG. 6Q. In some embodiments, the location of computer system 600 is only hidden from non-trusted devices during the security delay. Accordingly, trusted devices can access the location of computer system 600 remotely during the security delay. This allows people who the user trusts to locate and contact the user while ensuring that people that the user does not trust are unable to locate the user, increasing the user's safety and security. When the location of computer system 600 is unable to be hidden from being located remotely (e.g., because computer system 600 is unable to contact a server and/or a remote device that tracks the location of computer system 600), computer system 600 displays (e.g., on a lock screen) notification 672 that the location of computer system 600 is still being shared, as shown in FIG. 6AJ.

At FIG. 6S, while computer system 600 is at location F (e.g., an unfamiliar location) and while the security delay is ongoing (e.g., active and/or has not elapsed), computer system 600 detects an input (e.g., tap input 650) directed to recover option 652 associated with the operation of setting up account recovery for the user. Computer system 600 recognizes that the requested operation is another critical account change, which requires two biometric authentications separated by a security delay (e.g., one hour, two hours, or four hours). Accordingly, in response to detecting the input (e.g., tap input 650) directed to recover option 652, computer system 600 displays request 616 for biometric authentication, as shown in FIG. 6T, and then detects (e.g., receives) a biometric authentication. When the received biometric information matches an enrolled biometric, computer system 600 determines that the security delay to perform a critical account change is already ongoing and thus displays current status 648 of the security delay, as shown in FIG. 6U. Accordingly, because about half the duration of the security delay has passed since the security delay started, current status 648 of the security delay is about halfway through the required one hour security delay. While FIGS. 6S-6T show the location of computer system 600 as being in unfamiliar location F, the input (e.g., tap input 650) directed to recover option 652 could be detected while computer system 600 is at any unfamiliar location, including unfamiliar locations previously discussed like location E. When the input (e.g., tap input 650) directed to recover option 652 is detected in any unfamiliar location the same process is performed by computer system 600.

When computer system 600 determines that the security delay has elapsed (e.g., the full time of the security delay has passed), computer system 600 notifies the user that another biometric authentication can be performed by displaying notification 654, as shown in FIG. 6V. In response to detecting an input (e.g., tap input 656) directed to notification 654, computer system 600 displays the settings user interface including password option 640 associated with the operation of changing the user's password, as shown in FIG. 6W. Computer system 600 then detects an input (e.g., tap input 638) directed to change password option 640 (e.g., for a second time) requesting that the operation of changing the user's password be performed. In response to detecting the input (e.g., tap input 638) directed to change password option 640, computer system 600 provides request 616 for biometric authentication as shown in FIG. 6X and receives a biometric authentication from the user in response.

In some embodiments, computer system 600 detects a request to perform a different operation and proceeds to request biometric authentication. For example, computer system 600 optionally detects a tap input on the account recovery option, as shown in FIG. 6W, after the security delay has ended (e.g., when a previous input on the account recovery option was detected during the security delay). In this example, computer system 600 would also provide request 616 for biometric authentication as the account recovery operation is also a critical account change.

When the received biometric information matches an enrolled biometric, computer system 600 determines that a second authentication for a critical account change has been successful (and, optionally, within a threshold duration of time after the security delay has elapsed) and thus that the operation of changing the user's password can be performed. Accordingly, computer system 600 displays user interface 642 for changing the user's password, as shown in FIG. 6Y. After receiving the updated password from the user and updating the user's account, computer system 600 displays notification 658 indicating that the user's password was successfully updated, as shown in FIG. 6Z. After the security delay has elapsed and after the operation of changing the user's password has been performed, additional operations (e.g., the same as or different from the operation of changing the user's password) that require a security delay (e.g., are critical account changes) can be performed for a secondary authentication time threshold (e.g., 20 minutes, 1 hour, 1.5 hours, 3 hours, 5 hours, 6 hours, 13 hours, 24 hours, or 2 days). These additional operations performed during the secondary authentication time threshold optionally require an additional authentication of the authentication type (e.g., a biometric, passcode, password, pattern, or other type of authentication) that would be required if the additional operation were to be requested while the computer system is at a familiar location. In some embodiments, some operations performed during the secondary authentication time threshold that don't require additional authentication when the computer system is in a familiar location optionally do not require additional authentication during the secondary authentication time threshold (e.g., after the security delay and second biometric authentication have occurred).

When the received biometric information does not match the enrolled biometric after the security delay has elapsed (and, optionally, within a threshold duration of time after the security delay has elapsed), computer system 600 determines that the second biometric authentication for a critical account change has not been successful and thus, computer system 600 does not proceed with the operation of changing the user's password. Accordingly, computer system 600 displays notification 660 that biometric authentication is required, as shown in FIG. 6AA. Optionally, notification 660 includes prompt 662 for the user to try biometric authentication again. As discussed further below with regard to FIGS. 10A-10Q, in some embodiments, computer system 600 optionally also displays a prompt requesting an alternative type of authentication, such as a passcode, to re-enable the ability for computer system 600 to attempt biometric authentication. In this way, the user is not permanently locked out when the biometric authentication fails and may use a passcode to attempt further biometric authentications.

At FIG. 6AB, while computer system 600 continues to be in an unfamiliar location and once the second biometric authentication is successful after the security delay has elapsed, computer system 600 detects (optionally, within a threshold duration of time after the security delay has elapsed and/or after the second biometric authentication is successful) the input (e.g., tap input 650) directed to recovery option 652 associated with the operation of setting up account recovery for the user. As shown in FIG. 6AB, computer system 600 is now in location G, a different unfamiliar location than the other unfamiliar locations discussed when previous inputs requesting operations were received. Accordingly, computer system 600 proceeds with the processes that are performed in an unfamiliar location and computer system 600 will perform the same processes when in any unfamiliar location, including those that were visited earlier, such as location E and location 5. In other words, in some embodiments all unfamiliar locations are treated the same. In response to detecting the input (e.g., tap input 650) directed to recover option 652, computer system 600 provides request 616 for biometric authentication, as shown in FIG. 6AC.

At FIG. 6AC, when the received biometric information matches an enrolled biometric, computer system 600 displays user interface 662 for setting up account recovery (e.g., a critical account change), as shown in FIG. 6AD. Because the security delay has elapsed and the second biometric authentication successfully performed, computer system 600 does not start another security delay before allowing additional critical account changes. Rather, when another biometric authentication can be successfully completed after requesting the operation, the operation is performed. In some embodiments, computer system 600 performs additionally requested critical account changes for a limited time after the security delay has elapsed and the second biometric authentication is successful, such as 30 minutes, 60 minutes, 2 hours, and/or 24 hours. This provides the user with a window in which another security delay does not need to be completed so that the user may more freely make multiple critical account changes when in unfamiliar locations.

When the received biometric authentication, at FIG. 6AC, does not match an enrolled biometric after the security delay has elapsed and the successful second biometric authentication, computer system 600 determines that the user may provide an alternative type of authentication to authorize another biometric authentication attempt. Accordingly, in response to a failed biometric authentication attempt at FIG. 6AC, computer system 600 displays prompt 622 for a passcode, as shown in FIG. 6AE. Computer system 600 then receives the passcode and when the passcode matches a passcode stored in association with the user's account, computer system 600 provides request 616 for biometric authentication, as shown in FIG. 6AC.

In some embodiments, the location of computer system 600 changes during the security delay. When the change in location of computer system 600 is between unfamiliar locations the security delay is unaffected and continues to advance until the security delay ends. When computer system 600 moves to a familiar location during the security delay, the security delay optionally ends and computer system 600 can perform the requested critical account change immediately. Accordingly, when computer system 600 detects (e.g., during the security delay) that mobile phone is at a familiar location, computer system 600 provides notification 664 that the security delay has ended and the critical account change can be completed, as shown in FIG. 6AF. Computer system 600 detects tap input 66 on notification 664. In response to detecting an input (e.g., tap input 666) directed to notification 664, computer system 600 displays the settings user interface, as shown in FIG. 6W.

In some embodiments, some critical account changes, such as removing trusted devices, can be completed by computer system 600 without requiring a security delay in order to increase the user's safety. At FIG. 6AG, computer system 600 detects an input (e.g., tap input 668) requesting removal of “Gary's phone” from the user's list of trusted devices while computer system 600 is at an unfamiliar location. The operation of removing trusted devices is a critical account change, which typically requires at least two successful biometric authentications separated by a security delay when requested at an unfamiliar location, as discussed above. However, because removing a trusted device is an operation that can increase the user's safety, computer system 600 only requires a single biometric authentication to complete the operation. Accordingly, computer system 600 displays request 616 for biometric authentication as shown in 6AH. When a biometric authentication received in response to the request matches an enrolled biometric, computer system 600 performs the operation of removing the trusted device and displays updated user interface 670 as shown in FIG. 6AI.

In some embodiments, computer system 600 does not detect a successful biometric authentication for a period of time, such as when a biometric sensor or other component of computer system 600 is inoperable and/or disabled. For example, a camera of computer system 600 may break, disabling computer system 600 from receiving face and/or eye scans. Accordingly, computer system 600 optionally enables passcode authentication or removes all authentication requirements after the period of time has elapsed. For example, if a successful biometric authentication has not been detected for 24 hours, computer system 600 may enable reception of passcode authentication and display passcode user interface 626 as shown in FIG. 6AK when a request to perform an operation (e.g., any operation, such as one that would otherwise require biometric authentication) that requires authentication is detected. In some embodiments, the length of time before passcode authentication can be provided is different for different types of operations. For example, an operation that requires authentication but is not a critical account change is optionally able to be authenticated with a passcode after 24 hours while a critical account change is optionally able to be authenticated with a passcode after 7 days. Additionally, in some embodiments, the length of time before passcode authentication can be provided in place of biometric authentication is based on a mode of computer system 600. For example, when computer system 600 is unable to connect to a server to determine whether computer system 600 is in a lost mode or when computer system 600 can confirm that computer system 600 is currently in a lost mode, the length of time before passcode authentication can be provided in place of biometric authentication is optionally increased to 28 days to provide a greater level of security to the user.

FIG. 7 is a flow diagram illustrating a method for displaying user interfaces for authentication based on location using a computer system in accordance with some embodiments. Method 700 is performed at a computer system (e.g., 100, 300, 500, and/or 600) (e.g., a smartphone, a desktop computer, a laptop, a tablet, and/or a wearable electronic device) that is in communication with a display generation component (e.g., a display controller and/or a touch-sensitive display system) and one or more input devices (e.g., a button, a motion detector (e.g., an accelerometer and/or gyroscope), a location sensor (e.g., GPS, Wi-Fi, and/or a radio that indicates a location of the computer system), a camera, a fingerprint scanner, and/or a touch-sensitive surface) that is in communication with a display generation component and one or more input devices. Some operations in method 700 are, optionally, combined, the orders of some operations are, optionally, changed, and some operations are, optionally, omitted.

As described below, method 700 provides an intuitive way for managing authentication based on location. The method allows for more device security when in locations that are unfamiliar while allowing a user faster and simpler access to operations when in locations that are familiar, thereby enhancing productivity. Further, such techniques can reduce processor and battery power while offering customizable levels of security. The method also reduces the cognitive burden on a user for accessing a secure computer system, thereby creating a more efficient human-machine interface. For battery-operated computing devices, enabling a user to access a secure computer system faster and more efficiently conserves power and increases the time between battery charges.

The computer system (e.g., 600) receives (702) via the one or more input devices, a sequence of one or more inputs (e.g., a sequence including 610, 614, 620, 624, 628, and/or 638) that includes a request (e.g., 610, 614, 638, and/or 650) (e.g., an input, a tap gesture (e.g., on a touch-sensitive surface), a voice command, and/or a button press) to perform an operation of a respective type (e.g., an operation associated with 612A, 612B, 640, and/or 652) (e.g., a first type of operation, a second type of operation that is different from the first type of operation, and/or a third type of operation that is different from the first type of operation and the second type of operation). In some embodiments, the request is received while displaying, via the display generation component, a user interface for an application (e.g., a web application, a payment application, and/or a device pairing application). In some embodiments, the request is received while displaying, via the display generation component, a user interface for settings associated with the computer system and/or a user account associated with the computer system. In some embodiments, the operation is a payment. In some embodiments, the operation is a confirmation to submit an application (e.g., for a credit card and/or a new user account). In some embodiments, the operation is a change to an account associated with the computer system. In some embodiments, the operation is a change to an account associated with a user of the computer system. In some embodiments, the one or more inputs includes a failed biometric input.

In response to receiving the sequence of one or more inputs (704): in accordance with a determination that the operation is a first type of operation (e.g., an operation associated with 612A) (e.g., a non-critical operation, an operation requiring a biometric authentication, accessing passwords associated with a user, applying for a credit account, authorizing a payment, and/or pairing a new device) that was requested while the computer system (e.g., 600) was in a first type of location (e.g., locations A, B, and/or C as shown in FIG. 6A) (e.g., a familiar location such as: a trusted location, a location at which the computer system has previously been charged at overnight, and/or a location that a user of the computer system has previously designated as a home of the user), the computer system initiates (706) a process (e.g., providing 616, 618, 622, and/or 626, and/or displaying 630) to perform (or, optionally, performing) the operation (e.g., processing a payment, submitting an application (e.g., for a credit card and/or a new user account), and/or executing the change to the account associated with the computer system and/or a user of the computer system). In some embodiments, the first type of location includes a predetermined location. In some embodiments, a location of the first type of location is based on a frequency of the computer system being at the location. In some embodiments, the first type of location includes a list of locations (e.g., one familiar location, three familiar locations, and/or at least four familiar locations). In some embodiments, a location of the first type of location is based on an activity of the computer system at the location (e.g., the computer system is charged at the location included in the first type of location and/or the computer system was initially configured at the location). In some embodiments, a new location is identified as a location of the first type (e.g., to encourage users to turn on the additional security feature because they system can recognize new familiar locations). In some embodiments, the process to perform the operation includes completing a successful authentication. In some embodiments, a successful authentication is completed when a received biometric authentication matches an enrolled biometric feature. In some embodiments, a successful authentication is completed when a received authentication matches enrolled authentication information for an alternative type of authentication (e.g., a password and/or passcode). In some embodiments, a successful authentication has been completed when a received biometric authentication matches an enrolled biometric feature and a received authentication matches enrolled authentication information for an alternative type of authentication (e.g., a password and/or passcode).

In response to receiving the sequence of one or more inputs (704): in accordance with a determination that the operation is the first type of operation (e.g., an operation associated with 612A) that was requested while the computer system was in a second type of location (e.g., locations E, F, and/or G as shown in 6J, 6S, and 6AB and/or any location other than A, B, C, and D) (e.g., not a familiar location, not a familiar location, not a location at which the computer system has previously been charged at overnight, and/or not a location that a user of the computer system has previously designated as a home of the user) that is different from the first type of location, the computers system forgoes (708) initiating the process to perform the operation (e.g., forgoing immediately performing the operation). In some embodiments, in accordance with the determination that the operation is the first type of operation that was requested while the computer system was in the second type of location that is different from the first type of location, initiating a second process to perform the operation. In some embodiments initiating the second process to perform the operation includes completing a successful authentication. In some embodiments, a successful authentication is completed when a received biometric authentication matches an enrolled biometric feature. In some embodiments, a successful authentication is completed when a received authentication matches enrolled authentication information for an alternative type of authentication (e.g., a password and/or passcode). In some embodiments, a successful authentication has been completed when a received biometric authentication matches an enrolled biometric feature and a received authentication matches enrolled authentication information for an alternative type of authentication (e.g., a password and/or passcode). In some embodiments, the second type of location includes locations that are not a part of the first type of location. In some embodiments, in accordance with the determination that the operation is the first type of operation that was requested while the computer system was in the second type of location that is different from the first type of location, the computer system provides an error message (e.g., displaying, via the display generation component, an error message and/or providing an audio output including an error message), prevents another attempt to perform the operation, requests authentication from a user of the computer system, continues to display, via the display generation component, the user interface being displayed when the request was received, displays, via the display generation component, a home user interface, displays, via the display generation component, a user interface associated with an application, and/or ceases to display, via the display generation component, a user interface for settings associated with the computer system and/or an account associated with the computer system. In some embodiments, when a respective type of operation is requested, if the computer system is in a familiar location, the computer system performs the operation and if the computer system is not in a familiar location, the computer system does not perform the operation. Performing a respective type of operation when the computer system is in a familiar location and not performing the respective type of operation when the computer system is not in a familiar location enables the computer system to provide greater device security by imposing higher authentication requirements when the computer system may not be in the possession of the user and to determine whether operations can be performed based on a location of the computer system, thereby performing an operation when a set of conditions has been met.

In some embodiments, in response to receiving the sequence of one or more inputs (e.g., a sequence including 610, 614, 620, 624, 628, and/or 638): in accordance with a determination that the operation is a second type of operation (e.g., an operation associated with 612B) (e.g., an operation that does not require authentication, a standard operation, and/or an operation that does not require a level of security) that is different from the first type of operation, the computer system performs the operation (e.g., opening an application, playing media, starting navigation, performing a search, and/or navigating between user interfaces) without regard to whether the operation was requested while the computer system (e.g., 600) was in the first type of location (e.g., 600 as shown in FIG. 6C) or the second type of location (e.g., 600 as shown in FIG. 6J and/or 600 in any location other than A, B, C, and D). In some embodiments, when an operation that is different from the first type of operation is requested, the computer system performs the operation without regard to a location of the computer system. Performing a different type of operation without regard to a location of the computer system enables the computer system to provide access to some operations of the computer system at all times, thereby not limiting a user's ability to perform those operations and providing additional control options.

In some embodiments, locations of the first type of location (e.g., locations A, B, and/or C as shown in 6A) are determined based on a location history of the computer system (e.g., 600). In some embodiments, familiar locations (e.g., home, work, and/or a hotel) are determined based on a location history of the computers system (e.g., locations where the computer system has been recently). Determining familiar locations based on a location history of the computer system enables the computer system to provide update the familiar locations based on movement patterns of the user in addition to user preferences, thereby providing additional control options.

In some embodiments, while a first location is categorized as a first type of location (e.g., locations A, B, and/or C as shown in 6A), the computer system (e.g., 600) determines that a first set of one or more categorization conditions has been met for the first location (e.g., the computer system has been at the first location for less than a threshold frequency, the computer system has been at the first location for less than a threshold amount of time during a past time period, and/or the computer system has not been at the first location for a time period); in response to determining that the first set of one or more categorization conditions has been met for the first location, the computer system (e.g., 600) changes the categorization of the first location from the first type of location (e.g., locations A, B, and/or C as shown in 6A) to the second type of location (e.g., locations E, F, and/or G as shown in 6J, 6S, and 6AB and/or any location other than A, B, C, and D); and while a second location is categorized as the second type of location (e.g., locations E, F, and/or G as shown in 6J, 6S, and 6AB and/or any location other than A, B, C, and D), the computer system determines that a second set of one or more categorization conditions has been met for the second location (e.g., the computer system has been at the second location for more than a threshold frequency, the computer system has been at the second location for more than a threshold amount of time during a past time period, and/or the computer system has been at the second location for a time period (e.g., overnight and/or during work hours)); and in response to determining that the second set of one or more categorization conditions has been met for the second location, the computer system changes the categorization of the second location from the second type of location (e.g., locations E, F, and/or G as shown in 6J, 6S, and 6AB and/or any location other than A, B, C, and D) to the first type of location (e.g., locations A, B, and/or C as shown in 6A).

In some embodiments, the locations of the first type and the locations of the second type changes over time. In some embodiments, a location can change from the first type of location to the second type of location (e.g., based on contextual information). In some embodiments, the location can change from the second type of location to the first type of location (e.g., based on contextual information). In some embodiments, a person lives (e.g., sleeps) at a first location and the computer system determines that the first location is a first type of location (e.g., familiar location). Once the person has no longer lived (e.g., slept) at the first location for a period of time (e.g., 4 weeks, 5 weeks, 2 months, or 6 months), the computer system categorizes the first location as being the second type of location (and, optionally, not the first type of location). Changing the type of various locations over time enables the computer system to automatically update the familiar and/or familiar locations based on user activity, thereby performing an operation when a set of conditions has been met without requiring further user input.

In some embodiments, in response to receiving the sequence of one or more inputs (e.g., a sequence including 610, 614, 620, 624, 628, and/or 638) and in accordance with the determination that the operation is the first type of operation (e.g., an operation associated with 612A) that was requested while the computer system (e.g., 600) was in the first type of location (e.g., 600 as shown in FIG. 6C) (e.g., not a familiar location, not a familiar location, not a location at which the computer system has previously been charged at overnight, and/or not a location that a user of the computer system has previously designated as a home of the user): the computer system provides a prompt (e.g., 622) for an alternative type of authentication (e.g., passcode and/or password) other than biometric authentication; the computer system receives via the one or more input devices, an authentication attempt using the alternative type of authentication (e.g., 628); and in response to receiving the authentication attempt and in accordance with a determination that the authentication attempt includes received authentication information (e.g., an entered passcode and/or password) that matches enrolled authentication information for the alternative type of authentication (e.g., a passcode and/or password that is stored in association with a user profile), the computer system performs the operation (e.g., display 630 as shown in 6H); and in response to receiving the sequence of one or more inputs (e.g., a sequence including 610, 614, 620, 624, 628, and/or 638) and in accordance with the determination that the operation is the first type of operation (e.g., an operation associated with 612A) that was requested while the computer system was in the second type of location (e.g., 600 as shown in FIG. 6J and/or any location other than A, B, C, and D) (e.g., not a familiar location, not a location at which the computer system has previously been charged at overnight, and/or not a location that a user of the computer system has previously designated as a home of the user) that is different from the first type of location, the computer system initiates a second process to perform the operation, wherein the second process to perform the operation is different from the first process to perform the operation and wherein the second process includes (e.g., prompts for and/or requires) a first prompt for biometric authentication (e.g., 616) (e.g., a face scan, a fingerprint scan, and/or an eye scan). In some embodiments, the process to perform the operation includes: providing a request for an alternative type of authentication other than biometric authentication; receiving, via the one or more input devices, an authentication attempt using the alternative type of authentication; and in response to receiving the authentication attempt: in accordance with a determination that the authentication attempt includes received authentication information (e.g., an entered passcode and/or password) that matches enrolled authentication information for the alternative type of authentication (e.g., a passcode and/or password that is stored in association with a user profile), perform the operation; and in response to receiving the sequence of one or more inputs and in accordance with the determination that the operation is the first type of operation that was requested while the computer system was in the second type of location (e.g., not a familiar location, not a location at which the computer system has previously been charged at overnight, and/or not a location that a user of the computer system has previously designated as a home of the user) that is different from the first type of location, initiating a second process to perform the operation, wherein the second process to perform the operation is different from the first process to perform the operation and wherein the second process includes (e.g., prompts for and/or requires) a first prompt for biometric authentication. In some embodiments, the operation is an operation to use a stored password (e.g., insert the password into a password field or display the password), to use a stored payment method, to apply for a credit card, to unlock the computer system while in lost mode, to turn off remote finding of a current location of the computer system, and/or to set up a new paired device with the computer system. In some embodiments, the computer system requires biometric authentication (e.g., face, eye, fingerprint, and/or other biometric authentication) when the computer system is at an unfamiliar location and biometric authentication is not required at a familiar location (e.g., to use a stored password, a stored payment method, apply for a credit card, unlock while in lost mode, turn off device finding, set up a new paired device). Requiring biometric authentication when the computer system is at an unfamiliar location and not requiring biometric authentication when the computer system is at a familiar location enables the computer system to provide greater security to the user when in unfamiliar locations and there is a greater risk of the computer system not being with the owner of the computer system, thereby providing greater control and security options.

In some embodiments, in response to receiving the sequence of one or more inputs (e.g., a sequence including 610, 614, 620, 624, 628, and/or 638) and in accordance with a determination that the operation is a second type of operation (e.g., an operation associated with 640 and/or 652) that was requested while the computer system (e.g., 600) was in a second type of location (e.g., 600 as shown in FIG. 6Q) (e.g., not a familiar location, not a familiar location, not a location at which the computer system has previously been charged at overnight, and/or not a location that a user of the computer system has previously designated as a home of the user) that is different from the first type of location, the computer system initiates a third process to perform the operation, wherein the third process to perform the operation includes: providing a first prompt (e.g., 616) for (e.g., requesting and/or requiring) a biometric authentication (e.g., a face scan, fingerprint scan, and/or eye scan); and receiving, via the one or more input devices, a first authentication attempt using the biometric authentication; in response to receiving the first authentication attempt: in accordance with a determination that the first authentication attempt includes received biometric authentication information (e.g., a face scan, fingerprint scan, and/or eye scan) that matches an enrolled biometric feature (e.g., a face scan, fingerprint scan, and/or eye scan associated with a user account), starting a delay timer (e.g., the timer shown in 648) (e.g., a timer until another biometric authentication can be performed, a timer that measures the time since a successful biometric authentication, and/or a timer before the process to perform the operation can be continued); and in accordance with a determination that the first authentication attempt does not include received biometric authentication information that matches an enrolled biometric feature, forgoing starting the delay timer and forgoing performing the operation; in accordance with a determination that the delay timer (e.g., the timer shown in 648) has reached a threshold time and another request (e.g., 638 and/or 650) to perform the operation has been received: providing a second prompt (e.g., 616) for the biometric authentication; and receiving, via the one or more input devices, a second authentication attempt using the biometric authentication; and in response to receiving the second authentication attempt: in accordance with a determination that the second authentication attempt includes received biometric information that matches an enrolled biometric feature, performing the operation (e.g., displaying 642); and in accordance with a determination that the second authentication attempt does not include received biometric information that matches an enrolled biometric feature, forgoing performing of the operation (e.g., not displaying 642). In some embodiments, in response to receiving the sequence of one or more inputs and in accordance with a determination that the operation is a third type of operation (e.g., a critical account change, a change to security settings, and/or a critical task) that was requested while the computer system was in the second type of location (e.g., not a familiar location, not a familiar location, not a location at which the computer system has previously been charged at overnight, and/or not a location that a user of the computer system has previously designated as a home of the user) initiating a third process to perform the operation. In some embodiments, when the operation is a critical account change the computer system requires multiple biometric authentications (e.g., face, eye, fingerprint, and/or other biometric authentication) at different times spaced apart by a security delay timer (e.g., spaced apart by 30 min, 1 hour, 2 hours, 5 hours, 12 hours, 24 hours) when the computer system is not at a familiar location. Requiring multiple biometric authentications at different times spaced apart by a security delay timer when the operation is a critical account change enables the computer system to provide greater security to the user when in unfamiliar locations for operations that are more important to the security of the computer system, the user, and/or accounts associated with the user, thereby providing greater control and security options.

In some embodiments, the second type of operation (e.g., an operation associated with 640 and/or 652) (e.g., a critical account change) includes changing and/or removing (e.g., turning off and/or disabling) a password (e.g., alphanumeric password and/or numeric passcode) associated with (e.g., used to unlock or otherwise access) the computer system (e.g., 600). In some embodiments, a critical account change includes changing or turning off a password and/or passcode associated with the computer system. In some embodiments, the third type of operation includes changing and/or removing an alternative type of authentication (e.g., a non-biometric authentication, a password, and/or passcode) that is not a biometric authentication. Categorizing changing or turning off a password and/or passcode associated with the computer system as a critical account change enables the computer system to provide greater security to the user when changing or turning off a password and/or passcode, thereby providing greater control and limiting the ability of an unauthorized user to change and/or turn off the password/passcode.

In some embodiments, the second type of operation (e.g., an operation associated with 640 and/or 652) (e.g., a critical account change) includes adding, changing, and/or removing an enrolled biometric. In some embodiments, a critical account change includes adding, changing, and/or removing an enrolled biometric (e.g., a face scan, fingerprint scan, and/or eye scan). Categorizing adding, changing, and/or removing an enrolled biometric as a critical account change enables the computer system to provide greater security to the user when adjusting biometric signatures associated with a user account, thereby providing greater control and limiting the ability of an unauthorized user to add, change, or remove an enrolled biometric feature.

In some embodiments, the second type of operation (e.g., an operation associated with 640 and/or 652) (e.g., a critical account change) includes approving a sign in attempted on a second computer system that is different from the computer system (e.g., 600). In some embodiments, a critical account change includes approving a sign-in on another computer system. Categorizing approving a sign-in that was attempted on another computer system as a critical account change enables the computer system to provide greater security to other computer systems associated with the user, thereby providing greater control and limiting the ability of an unauthorized user to approve a remote sign-in attempt.

In some embodiments, the second type of operation (e.g., an operation associated with 640 and/or 652) (e.g., a critical account change) includes changing a password associated with a user account (e.g., a user account maintained at a remote server, such as for a storage service and/or an email service). In some embodiments, a critical account change includes changing a password associated with a user account. In some embodiments, the third type of operation includes changing an alternative type of authentication (e.g., a non-biometric authentication, a password, and/or passcode) that is not a biometric authentication that is associated with a user account. Categorizing changing a password associated with a user account as a critical account change enables the computer system to provide greater security to the user when managing the user's account, thereby providing greater control and limiting the ability of an unauthorized user to change a password associate with a user account.

In some embodiments, the second type of operation (e.g., an operation associated with 640 and/or 652) (e.g., a critical account change) includes changing settings associated with the delay timer. In some embodiments, a critical account change includes changing settings for a security delay requirement, such as reducing the delay timer, overriding the delay timer, and/or disabling the delay timer. Categorizing changing settings for a security delay requirement enables the computer system to provide greater security to the user when adjusting security settings, thereby providing greater control and limiting the ability of an unauthorized user to modify the security settings.

In some embodiments, starting the delay timer (e.g., the timer shown in 648) includes: in accordance with a determination that the second authentication attempt includes received biometric authentication information (e.g., a face scan, fingerprint scan, and/or eye scan) that matches an enrolled biometric feature (e.g., a face scan, fingerprint scan, and/or eye scan associated with a user account) and the computer system (e.g., 600) is in a first mode (e.g., a lost mode and/or a mode indicating the user does not have the computer system), starting a delay timer (e.g., the timer shown in 648) of a first length; and in accordance with a determination that the second authentication attempt includes received biometric authentication information that matches an enrolled biometric feature and the computer system (e.g., 600) is in a second mode that is different from the first mode, starting a delay timer (e.g., the timer shown in 648) of a second length that is different from the first length. In some embodiments, the computer system changes the security delay between biometric authentications based on whether the computer system is in a lost mode (e.g., increases if the computer system is in a lost mode). The computer system changing the security delay between biometric authentications based on whether the computer system is in a lost mode enables the computer system to provide greater security to the user when the computer system is not available to the user, thereby providing greater control and security options.

In some embodiments, after starting the delay timer (e.g., the timer shown in 648), the computer system detects a location (e.g., home, work, and/or another location) of the computer system (e.g., 600); in accordance with (and, optionally, in response to detecting the location of the computer system) a determination that the location of the computer system (e.g., 600) is the first type of location (e.g., locations A, B, and/or C as shown in 6A) (e.g., a familiar location, a location at which the computer system has previously been charged at overnight, and/or a location that a user of the computer system has previously designated as a home of the user): the computer system allows the second authentication attempt (e.g., 616 as shown in 6X) using the biometric authentication without regard to whether an end of the delay timer (e.g., the timer shown in 648) has been reached; and in accordance with (and, optionally, in response to detecting the location of the computer system) a determination that the location of the computer system (e.g., 600) is the second type of location (e.g., locations E, F, and/or G as shown in 6J, 6S, and 6AB and/or any location other than A, B, C, and D), the computer system prevents the second authentication attempt (e.g., 616 as shown in 6X) using the biometric authentication until an end of the delay timer (e.g., the timer shown in 648) has been reached. In some embodiments, there is no ability to perform the operation when the computer system is in a lost mode. In some embodiments, in accordance with a determination the computer system is in a first mode (e.g., a lost mode), continuing the delay timer. In some embodiments, the security delay between biometric authentications changes or ends if the computer system is moved to a familiar location. Changing or ending the security delay between biometric authentication attempts when the computer system moves to a familiar location enables the computer system to facilitate access to critical operations when the location of the computer system changes to the familiar/trust location, thereby making it easier and/or faster for an authorized user to authenticate and to perform a requested operation.

In some embodiments, the delay timer (e.g., the timer shown in 648) measures a delay until the second authentication attempt (e.g., 616 as shown in 6X) using the biometric authentication can be attempted and wherein the delay timer starts based on (e.g., in response to and/or after) the first authentication attempt (e.g., 616 as shown in 6N) using the biometric authentication being successful. In some embodiments, the delay timer starts based on (e.g., in response to and/or after) user input (e.g., selection of an option or object) after the first biometric authentication is successful. In some embodiments, the computer system starts the security delay timer until next biometric authentication can be attempted after the first biometric authentication (and optionally in response to a user input after the first biometric authentication). Starting the security delay timer after the first biometric authentication enables the computer system to accurately assess the amount of time since the first biometric authentication was successful, thereby providing additional control and slowing down an unauthorized user's attempt to perform an operation.

In some embodiments, the sequence of one or more inputs (e.g., a sequence including 610, 614, 620, 624, 628, and/or 638) that includes the request (e.g., 610, 614, 638, and/or 650) is a first sequence of one or more inputs that includes the request and while the delay timer (e.g., the timer shown in 648) is active: the computer system receives, via the one or more input devices, a second sequence of one or more inputs (e.g., a sequence including 646 and/or 650) that includes a request (e.g., 638 and/or 650) (e.g., an input, a tap gesture (e.g., on a touch-sensitive surface), a voice command, and/or a button press) to perform a second operation (e.g., same as the operation or different from the operation) of the second type (e.g., an operation associated with 640 and/or 652); and in response to receiving the second sequence of one or more inputs and in accordance with a determination that the second operation is the second type of operation (e.g., an operation associated with 640 and/or 652) that was requested while the computer system (e.g., 600) was in the second type of location (e.g., locations E, F, and/or G as shown in 6J, 6S, and 6AB and/or any location other than A, B, C, and D), the computer system displays, via the display generation component, a current time (e.g., how much time has elapsed and/or how much time is left) of the delay timer (e.g., 648 in FIG. 6U). Thus, in some embodiments, the delay timer is accessible when attempting the second type of operation. In some embodiments, in response to receiving the second sequence of one or more inputs and in accordance with a determination that the second operation is a type of operation that does not require a delay timer, the computer system forgoes displaying the current time of the delay timer. Displaying the current time of the delay timer when the computer system detects the user attempting a critical account change provides the user with feedback that the delay timer is currently running and indicates to the user how much time has elapsed and/or how much time remains, thereby providing improved feedback.

In some embodiments, while the delay timer (e.g., the timer shown in 648) is active: the computer system receives via the one or more input devices, the second sequence of one or more inputs (e.g., a sequence including 646 and/or 650) that includes the request (e.g., 638, 650) (e.g., an input, a tap gesture (e.g., on a touch-sensitive surface), a voice command, and/or a button press) to perform the second operation (e.g., same as the operation or different from the operation); and in response to receiving the second sequence of one or more inputs: in accordance with the determination that the second operation is the second type of operation (e.g., an operation associated with 640 and/or 652) (e.g., a critical account change) that was requested while the computer system (e.g., 600) was in the second type of location (e.g., locations E, F, and/or G as shown in 6J, 6S, and 6AB and/or any location other than A, B, C, and D) that is different from the first type of location, the computer system continues the delay timer without starting a new delay timer. In some embodiments, the computer system uses the same timer for multiple critical account changes (e.g., a new timer is not started in response to receiving another critical account change request). Using the same timer for multiple critical account changes enables the computer system to allow multiple changes once a security check has been successfully passed, thereby performing an operation when a set of conditions has been met without requiring further user input.

In some embodiments, the computer system detects that the delay timer (e.g., the timer shown in 648) has reached the threshold time; and in response to detecting that the delay timer has reached the threshold time, the computer system provides (e.g., displaying and or outputting audio of) a notification (e.g., 654) including the second prompt for the biometric authentication. In some embodiments, providing the notification includes displaying, via the display generation component, the notification including the second prompt for the biometric authentication. In some embodiments, providing the notification includes outputting audio of the notification. In some embodiments, the computer system provides a notification for the user to authenticate again once the security delay timer has elapsed. Providing a notification to attempt authentication again once the security delay timer has elapsed enables the computer system to notify a user as soon as the user can attempt another authentication without requiring additional inputs from the user, thereby providing improved feedback.

In some embodiments, the computer system detects via the one or more input devices, an input (e.g., 656) (e.g., a tap, swipe, and/or press) directed at (e.g., on and/or at) the notification (e.g., 654) including the second prompt for biometric authentication; and in response to detecting the input (e.g., 656) directed at the notification (e.g., 654) including the second prompt for biometric authentication, the computer system displays, via the display generation component, a user interface (e.g., the user interface shown in 6W) (e.g., a settings user interface and/or an application user interface) associated with the operation of the respective type. In some embodiments, the notification links to a user interface for performing the operation (e.g., in settings). Linking the notification to the user interface for performing the operation enables the computer system to display the correct user interface without requiring a user to manually navigate through a plurality of other user interfaces, thereby reducing the number of inputs needed to perform an operation.

In some embodiments, the request (e.g., 610, 614, 638, and/or 650) is a first request (e.g., 610, 614, 638, and/or 650) and wherein the operation (e.g., an operation associated with 640 and/or 652) is a first operation (e.g., an operation associated with 640 and/or 652), and subsequent to (e.g., in accordance with the determination that) receiving the second authentication attempt that includes received biometric information (e.g., a face scan, fingerprint scan, and/or eye scan) that matches an enrolled biometric feature (e.g., a face scan, fingerprint scan, and/or eye scan associated with a user account): the computer system receives, via the one or more input devices, a third sequence of one or more inputs (e.g., a sequence including 638, 646, and/or 650) that includes a second request (e.g., 638 and/or 650) (e.g., an input, a tap gesture (e.g., on a touch-sensitive surface), a voice command, and/or a button press) to perform a third operation (e.g., an operation associated with 640 and/or 652); and in response to receiving the third sequence of one or more inputs (e.g., a sequence including 638, 646, and/or 650) and in accordance with a determination that the third operation is the second type of operation (e.g., an operation associated with 640 and/or 652) that was requested while the computer system (e.g., 600) was in the second type of location (e.g., locations E, F, and/or G as shown in 6J, 6S, and 6AB and/or any location other than A, B, C, and D) (and, optionally, that the second request was received within a threshold duration of the third authentication attempt), the computer system initiates a process to perform the third operation of the respective type without starting a delay timer. In some embodiments, once multiple biometric authentications with the security delay have occurred, the computer system can make multiple critical account changes within a threshold amount of time (e.g., from the third authentication attempt and/or from the delay timer elapsing). Allowing the computer system to make multiple critical account changes once multiple biometric authentications with the security delay have occurred enables the computer system to provide a more efficient interaction once the security requirements have been met, thereby providing additional control and security options.

In some embodiments, the request (e.g., 610, 614, 638, and/or 650) is a first request (e.g., 610, 614, 638, and/or 650) and wherein the operation (e.g., an operation associated with 640 and/or 652) is a first operation (e.g., an operation associated with 640 and/or 652), and subsequent to (e.g., in accordance with the determination that) the second authentication attempt including received biometric information (e.g., a face scan, fingerprint scan, and/or eye scan) that matches an enrolled biometric feature (e.g., a face scan, fingerprint scan, and/or eye scan associated with a user account): the computer system receives, via the one or more input devices, a fourth sequence of one or more inputs (e.g., a sequence including 638, 646, and/or 650) that includes a request (e.g., 638 and/or 650) (e.g., an input, a tap gesture (e.g., on a touch-sensitive surface), a voice command, and/or a button press) to perform a fourth operation of the respective type; and in response to receiving the fourth sequence of one or more inputs (e.g., a sequence including 638, 646, and/or 650) and in accordance with a determination that the fourth operation is the second type of operation (e.g., an operation associated with 640 and/or 652) that was requested while the computer system was in the second type of location (e.g., locations E, F, and/or G as shown in 6J, 6S, and 6AB and/or any location other than A, B, C, and D) and that the fourth sequence of one or more inputs is received within a time period from when the second authentication attempt occurred (e.g., a time period that starts after the delay timer has elapsed or a time period that starts when the second authentication attempt is detected) (e.g., 30 minutes, 1 hour, 3 hours, 6 hours, 12 hours, or 24 hours), the computer system initiates a process to perform the fourth operation of the respective type. In some embodiments, in response to receiving the fourth sequence of one or more inputs and in accordance with a determination that the fourth operation is the second type of operation that was requested while the computer system was in the second type of location and that the fourth sequence of one or more inputs is not received within the time period from when the second authentication attempt occurred (e.g., a time period that starts after the delay timer has elapsed or a time period that starts when the second authentication attempt is detected), forgoing initiating the process to perform the fourth operation of the respective type (e.g., require another delay timer to elapse and, optionally, additional biometric authentication, before the computer system performs the fourth operation). In some embodiments, once multiple biometric authentications with the security delay have occurred, the computer system authorizes critical account changes for a time period (e.g., 30 minutes, 1 hour, 3 hours, 10 hours, and/or 24 hours). Authorizing critical account changes for a period of time after multiple biometric authentications with the security delay have occurred enables the computer system to provide a user with a window to more easily make changes while increasing security of the computer system outside of the window, thereby providing additional control and security options.

In some embodiments, wherein the first type of operation (e.g., an operation associated with 612A and/or an operation as shown in 6AG) includes removing a trusted device. In some embodiments, in response to receiving the sequence of one or more inputs and in accordance with a determination that the operation is a fourth type of operation (e.g., an operation to remove a trusted device and/or a device associated with the user account (e.g., a user account that is in use by the computer system to log into or to access a remote service)) that was requested while the computer system was in the second type of location (e.g., not a familiar location, such as a location that is: not a trusted location, not a location at which the computer system has previously been charged at overnight, and/or not a location that a user of the computer system has previously designated as a home of the user) that is different from the first type of location the computer system: provides (e.g., displaying via the display generation component and/or outputting via an audio device) a fourth prompt for biometric authentication; receives, via the one or more input devices, a fourth authentication attempt using biometric authentication; and in response to receiving the fourth authentication attempt: in accordance with a determination that the fourth authentication attempt includes received biometric information (e.g., a face scan, fingerprint scan, and/or eye scan) that matches an enrolled biometric feature (e.g., a face scan, fingerprint scan, and/or eye scan associated with a user account), performing the operation; and in accordance with a determination that the fourth authentication attempt does not include received biometric information that matches an enrolled biometric feature, forgoing performing the operation. In some embodiments, trusted devices can be removed from a user account without requiring multiple biometric authentications. Allowing trusted devices to be removed from a user account without multiple biometric authentications enables the computer system to ensure that the user is able to remain safe while increasing security for other operations, thereby providing additional control and security options.

In some embodiments, while the delay timer (e.g., the timer shown in 648) is active, the computer system ceases to provide a location of the computer system (e.g., 600) to one or more other computer systems (e.g., to an external computer system and/or to a remote service). In some embodiments, when the delay timer is not active (e.g., before it became activated and/or after it expired), the computer system provides (e.g., automatically and/or periodically) a location of the computer system to the one or more other computer systems. In some embodiments, during the time period between biometric authentications (e.g., the security delay timer), the computer system temporarily hides the computer system from being located remotely. Temporarily hiding the computer system from being located remotely during the time period between biometric authentications enables the computer system to ensure that the user is able to remain safe during the time delay while simultaneously increasing the security of the computer system, thereby providing additional control and security options.

In some embodiments, while the delay timer (e.g., the timer shown in 648) is active: in accordance with a determination that another computer system is a first type of computer system (e.g., a trusted device and/or a device that is logged into a service using the same credentials as used by the computer system to log into the same service), the computer system provides a location of the computer system (e.g., 600); and in accordance with a determination that another computer system is a second type of computer system (e.g., a non-trusted device and/or a device that is not logged into a service using the same credentials as used by the computer system to log into the same service), the computer system forgoes providing the location of the computer system (e.g., 600). In some embodiments, when the delay timer is not active (e.g., before it became activated and/or after it expired), the computer system provides (e.g., automatically and/or periodically) a location of the computer system to the first type of computer system and to the second type of computer system. In some embodiments, during the time period between biometric authentications (e.g., the security delay timer), the computer system temporarily hides the computer system from being located remotely by a non-trusted device and/or allows the computer system to be located remotely by a trusted device. Temporarily hiding the computer system from being located remotely by a non-trusted device and/or allowing the computer system to be located remotely by a trusted device during the time period between biometric authentications enables the computer system to ensure that the user is able to remain safe during the time delay while simultaneously increasing the security of the computer system, thereby providing additional control and security options.

In some embodiments, while the delay timer is active: in accordance with a determination that the location of the computer system (e.g., 600) is available to other computer systems (e.g., to the second type of computer system), the computer system provides a notification (e.g., 672) (e.g., by displaying the notification and/or outputting audio of the notification) that the computer system can be located remotely. In some embodiments the computer system displays, via the display generation component, the notification that the computer system can be located remotely as a pop-up notification. In some embodiments the computer system displays, via the display generation component, the notification that the computer system can be located remotely on a wake screen and/or a lock screen. In some embodiments the notification that the computer system can be located remotely is a persistent notification that cannot be dismissed. In some embodiments the notification that the computer system can be located remotely is a persistent notification that is dismissed after detecting multiple inputs directed to dismissing the notification. In some embodiments, if the computer system is not successfully hidden, the computer system notifies the user that the computer system can still be found remotely (e.g., by other users that are associated with the user of the computer system). Notifying the user that the computer system can still be found remotely if the computer system is not successfully hidden enables the computer system to ensure that the user is able to remain safe during the time delay while simultaneously increasing the security of the computer system, thereby providing additional control and security options.

In some embodiments, the computer system (e.g., 600) receives, via the one or more input devices, a request (e.g., at a settings user interface of computer system 600) to require multiple requests for biometric authentication with a delay timer (e.g., the timer shown in 648) for the second type of operation (e.g., an operation associated with 640 and/or 652) regardless of a location of the computer system (e.g., 600); and in response to receiving the request to require multiple requests for biometric authentication with a delay timer for the second type of operation (e.g., an operation associated with 640 and/or 652) regardless of a location of the computer system (e.g., 600), the computer system enables an option to require multiple requests for biometric authentication with a delay timer for the second type of operation (e.g., an operation associated with 640 and/or 652) regardless of a location of the computer system. In some embodiments, a user has the option to always require multiple biometric authentications for critical account changes (e.g., without regard to the location of the device). Providing the option to always require multiple biometric authentications for critical account changes without regard to the location of the device enables the computer system to provide a greater level security at all locations if the user desires, thereby providing additional control and security options.

In some embodiments, the computer system (e.g., 600) receives, via the one or more input devices, a request (e.g., at a settings user interface of computer system 600) to disable requiring multiple requests for biometric authentication with a delay timer for the second type of operation (e.g., an operation associated with 640 and/or 652) regardless of a location of the computer system (e.g., 600); and in response to receiving the request to disable requiring multiple requests for biometric authentication with a delay timer for the second type of operation (e.g., an operation associated with 640 and/or 652) regardless of a location of the computer system (e.g., 600), the computer system disables requiring multiple requests for biometric authentication with a delay timer for the second type of operation (e.g., an operation associated with 640 and/or 652) regardless of a location of the computer system. In some embodiments, a user has the option to never require multiple biometric authentications for critical account changes (e.g., without regard to the location of the device). In some embodiments, enabling the option to never require multiple biometric authentications for critical account changes results in the computer system requiring a single biometric authentication for critical account changes. Providing the option to never require multiple biometric authentications for critical account changes without regard to the location of the device enables the computer system to provide a greater level of access to the computer system if the user desires, thereby providing additional control options.

In some embodiments, in response to the sequence of one or more inputs (e.g., a sequence including 610, 614, 620, 624, 628, and/or 638) that includes the request (e.g., 610, 614, 638, and/or 650) (e.g., an input, a tap gesture (e.g., on a touch-sensitive surface), a voice command, and/or a button press) to perform the operation (e.g., an operation associated with 612A, 612B, 640, and/or 652) of the respective type and in accordance with a determination that a successful biometric authentication has not occurred within a time period, the computer system initiates the process to perform the operation, including, in accordance with a determination that a successful biometric authentication has not occurred within the time period, providing (e.g., displaying via the display generation component and/or outputting via an audio device) a prompt (e.g., 622 and/or 626) for an alternative type of authentication (e.g., passcode and/or password) other than biometric authentication that is associated with the operation of the respective type. In some embodiments, wherein initiating the process to perform the operation includes: in accordance with a determination that the operation of the respective type does not require authentication when a successful biometric authentication has not occurred within the time period, performing the operation without providing a prompt for an alternative type of authentication (e.g., passcode and/or password) other than biometric authentication. In some embodiments, after a time period of no biometric success, based on a type of operation the computer system can request a passcode to authenticate the user and/or perform the operation without requesting a passcode to authenticate the user (e.g., allow passcode to be provided to perform operation without a successful biometric authentication). Allowing the computer system to require password authentication and/or performing the operation after a time period of no biometric success based on the type of operation enables the computer system to ensure that the user can access the computer system when biometric sensors may be disabled, thereby providing additional control and security options.

In some embodiments, in accordance with a determination that the operation is the first type of operation (e.g., an operation associated with 612A) (e.g., an operation that is attempted when the device is being first configured, such as an out of box experience and/or an operation that includes filling a password that is accessible by the computer system into a field or form), the time period is more than 10 hours (e.g., 12, 24, or 36 hours). Allowing the computer system to proceed with authentication after an amount of time has elapsed enables the computer system to provide access to non-critical operations faster when biometric sensors may be disabled, thereby providing additional control and security options.

In some embodiments, in accordance with a determination that the operation is a second type of operation (e.g., an operation associated with 640 and/or 652) (e.g., a critical account change) that is different from the first type of operation and in accordance with a determination that the computer system (e.g., 600) is not marked as lost on a remote device registration service (e.g., computer system can connect to a remote service/server and confirm that the computer system should not be in a lost mode), the time period is more than 2 days (e.g., 3, 5, 7, 14, or 21 days). Allowing the computer system to proceed (e.g., with authentication) after an amount of time has elapsed (e.g., after 7 days) of no biometric success for a second type of operation when the computer system should not be in a lost mode enables the computer system to ensure that critical operations are secure for a longer period of time even when a biometric sensor may be disabled, thereby providing additional control and security options.

In some embodiments, in accordance with a determination that the operation is a second type of operation (e.g., an operation associated with 640 and/or 652) (e.g., a critical account change) and the computer system (e.g., 600) has been marked as lost on a remote device registration service (and/or, optionally, the computer system cannot connect to the remote device registration service to confirm that it has not been marked as lost on the remote device registration service) (e.g., the computer system cannot connect to a server to check whether the computer system should not be in a lost mode and/or the computer system connects to the server and confirms that the computer system should be in the lost mode), the time period is more than 5 days (e.g., 10, 14, 21, 28, 30, or 60 days). Allowing the computer system to proceed (e.g., with authentication) after an amount of time has elapsed (e.g., after 28 days) of no biometric success for when the computer system cannot connect to a server to check whether the computer system should not be in a lost mode and/or the computer system connects to the server and confirms that the computer system should be in the lost mode enables the computer system to ensure that the computer system is secure for a longer period of time when the computer system may be lost, thereby providing additional control and security options.

Note that details of the processes described above with respect to method 700 (e.g., FIG. 7) are also applicable in an analogous manner to the methods described below. For example, methods 1100 and/or 1200 optionally includes one or more of the characteristics of the various methods described above with reference to method 700. For example, method 1100 can include the location-based user authentication described in method 700 in addition to utilizing authentications of different types. As another example, method 1200 can include the location-based user authentication described in method 700 in addition to utilizing multiple authentications separated by a delay. For brevity, these details are not repeated below.

FIG. 8 is a block diagram illustrating a system for authentication based on location, in accordance with some embodiments. In particular, FIG. 8 is a block diagram illustrating how components (e.g., implemented in hardware and/or in software) of an electronic device (e.g., 100, 300, 500, and/or 600) perform authentication when a critical account change is requested in a familiar or an unfamiliar location. Some operations in block diagram 800 are, optionally, combined, the orders of some operations are, optionally, changed, and some operations are, optionally, omitted.

At 801, an operation that requires biometric ratchet authentication (e.g., a second type of operation) (e.g., the critical account change associated with 640 and/or 652) and an associated first biometric authentication are provided from application 815 (e.g., an application of applications 136) associated with the operation that requires biometric ratchet authentication to local authentication 820 (e.g., authentication module 105).

Local authentication 820 (e.g., authentication module 105) then checks a device location monitoring process (e.g., core location 830, such as GPS module 135) for a location of the electronic device (e.g., 600 and/or a computer system). In particular, local authentication 820 (e.g., authentication module 105) queries core location 830 (e.g., GPS module 135) for whether the electronic device is located at a familiar location or an unfamiliar location at 802. Local authentication 820 (e.g., authentication module 105) then processes the requested critical account change (e.g., the critical account change associated with 640 and/or 652) based on whether the location of the electronic device is a familiar location or an unfamiliar location.

When the operation that requires biometric ratchet authentication (e.g., a second type of operation) (e.g., the critical account change associated with 640 and/or 652) is requested when the electronic device is in a familiar location (e.g., 600 as shown in FIG. 6M), local authentication 820 (e.g., authentication module 105) compares received biometric information (e.g., face information, fingerprint information, and/or eye information) (e.g., biometric information received in response to 616) received with the first biometric authentication to an enrolled biometric feature in biometric kit 840 (e.g., biometric module 109) at 803. When the received biometric information matches an enrolled biometric feature associated with the user, the electronic device performs the operation at 812. When the received biometric information does not match an enrolled biometric feature associated with the user, the electronic device requests (e.g., 616) another biometric authentication.

When a second received biometric information does not match an enrolled biometric feature associated with the user, the electronic device (e.g., 600) requests a passcode authentication (e.g., an alternative type of authentication other than biometric authentication) (e.g., 622) and compares a received passcode to a passcode associated with the user. When the received passcode matches the passcode associated with the user, the electronic device performs the operation at step 812. In some embodiments, a predetermined number of biometric authentications are requested before providing the request for passcode authentication. Thus, the electronic device may request 3, 4, 5, or 10 biometric authentications and determine that a received biometric information for each does not match an enrolled biometric feature associated with the user prior to requesting passcode authentication.

When the operation that requires biometric ratchet authentication (e.g., a second type of operation) (e.g., the critical account change associated with 640 and/or 652) is requested when the electronic device is in an unfamiliar location (e.g., 600 as shown in FIG. 6Q), local authentication 820 (e.g., authentication module 105) compares a received biometric information (e.g., biometric information received in response to 616) received with the first biometric authentication to an enrolled biometric feature in biometric kit 840 (e.g., biometric module 109) at 803. When the received biometric information matches an enrolled biometric feature associated with the user, the credential indicating the successful biometric authentication is provided to secure enclave 850 (e.g., secure element 163) at 804. Local authentication 820 (e.g., authentication module 105) then starts a cool off timer (e.g., security delay shown with 648) and provides application 815 (e.g., an application of applications 136) with the information that the electronic device must wait through a cool off period and perform another biometric authentication at 806, prior to being able to perform the operation.

At 807.1, core location 830 (e.g., GPS module 135) determines that the electronic device (e.g., 600) has moved from an unfamiliar location to a familiar location (e.g., 600 as shown in FIG. 6AF) and provides the information to local authentication 820 (e.g., authentication module 105). Local authentication then determines that there is no longer a need for the cool off period and allows the requested operation to be performed after a second successful biometric authentication (or optionally immediately) at step 812. In some embodiments, the requested operation is performed after detecting another request to perform the operation.

At 807.2, secure enclave 850 (e.g., secure element 163) provides the information that the cool off period has expired and local authentication 820 (e.g., authentication module 105) can request a second biometric authentication. Local authentication 820 (e.g., authentication module 105) then provides a request (e.g., 654) for a second biometric authentication at 808 and receives the second biometric authentication at 809. Local authentication 820 (e.g., authentication module 105) then compares a second received biometric information to an enrolled biometric feature associated with a user in biometric kit 840 (e.g., biometric module 109) at 810. When the second received biometric information matches the enrolled biometric feature associated with the user the credential is provided to secure enclave 850 (e.g., secure element 163) indicating that the user has been authenticated a second time at 811.

Because the user has been authenticated two times separated by a required cool off period (e.g., duration of the security delay), local authentication 820 (e.g., authentication module 105) then triggers performance of the operation at 812.

FIGS. 9A-9B are flow diagrams illustrating exemplary methods for authentication based on location, in accordance with some embodiments. FIG. 9A illustrates method 900a of a computer system (e.g., 100, 300, 500, and/or 600) performing authentication for an operation that requires biometric authentication twice separated by a cool off timer when requested in an unfamiliar location. Some operations in method 900a are, optionally, combined, the orders of some operations are, optionally, changed, and some operations are, optionally, omitted.

At not started state 901, the security process has not started and a request (e.g., 638, 650) to perform an operation (e.g., the critical account change associated with 640 and/or 652) is received.

When the operation does not require authentication and is received when the computer system (e.g., 600) is located at a familiar location (e.g., a first type of location), the security process proceeds to ready state 902 at 906. In some embodiments, when the operation does not require authentication or is received when the computer system (e.g., 600) is located at a familiar location (e.g., a first type of location), the security process proceeds to ready state 902 at 906. When in ready state 902, the security process allows performance of operations that do not require authentication, regardless of the location of the computer system.

When the operation requires authentication and the request for the operation is received while the computer system (e.g., 600) is in a familiar location (e.g., a first type of location) (e.g., 600 as shown in FIG. 6M), the security process requests (e.g., 616) biometric authentication, receives biometric information (e.g., detected by one or more biometric sensors) corresponding to the request for the second biometric authentication, and determines whether there is a biometric match (e.g., whether received biometric information matches an enrolled biometric feature). When there is a biometric match, the security process allows performance of the operations requiring authentication at 907.

When the operation requires authentication and the request for the operation is received while the computer system (e.g., 600) is in a non-familiar location (e.g., a second type of location) (e.g., 600 as shown in FIG. 6S), the security process does not progress to ready state 902. The security process requests biometric authentication (e.g., 616) and determines whether there is a biometric match. When there is a biometric match, the security process starts a cool off timer (e.g., a delay timer) (e.g., as represented by 648) and proceeds to cool off state 903 where the security process waits for the cool off timer to finish or for the computer system to enter a familiar location (e.g., a first type of location).

When security process is at cool off state 903, if the security process detects a reset, such as a reset of the security process (e.g., due to a failure of the device to detect a second authentication before a secondary authentication timer has expired) and/or a reset of the computer system (e.g., 600) then the security process returns to not started state 901 at 910.

After the cool off timer (e.g., the delay timer) finishes (e.g., 600 as shown in 6V) or the computer system enters a familiar location (e.g., 600 as shown in 6AF), at 911, the security process proceeds to second authentication state 904 where the security process waits for a second biometric authentication and/or requests (e.g., 616) a second biometric authentication. When in second authentication state 904, the security process starts a second authentication timer which runs for a time period (e.g., 3, 6, 9, or 12 hours) to allow a user to provide a second biometric authentication. When the timer period of the second authentication timer expires (e.g., finishes) without receiving a second biometric authentication the security process returns to not started state 901 at 913. Further, if the security process detects a reset, such as a reset of the security process and/or a reset of the computer system then the security process returns to not started state 901 at 913.

In some embodiments, when the cool off timer (e.g., a delay timer) has finished but before the second authentication has performed, the computer system receives another request (e.g., 638 and/or 650) for an operation that requires two biometric authentications separated by a cool off timer and the security process proceeds to second authentication state 904 in which the computer system is prepared to perform one or more operations in response to a successful secondary biometric authentication, at 912.

While in second authentication state 904, the security operation requests a second biometric authentication, receives biometric information (e.g., detected by one or more biometric sensors) corresponding to the request for the second biometric authentication, and determines whether there is a biometric match. When there is a biometric match, at 914, the security operation proceeds to ready state 902 for a period of time measured by a disarm timer. When in ready state 902 and after two successful biometric matches separated by the cool off period, the security process behaves as discussed above with regard to ready state 902. Thus, once the security process has entered ready state 902 after the two successful biometric matches separated by the cool off period, when the computer system (e.g., 600) detects another request (e.g., 638, 650) for an operation, the operation is performed after determining there is a biometric match. In some embodiments, while the computer system is in the ready state, subsequent operations can be performed using the standard authentication procedures (e.g., with biometric authentication, passcode authentication, password authentication, pattern authentication, no further authentication).

After the security process enters ready state 902 after the two successful biometric matches separated by the cool off period, the disarm timer runs for a period of time (e.g., 3, 6, 9, or 12 hours) during which, as discussed above, operations (e.g., operations associated with 640, 652) that require two successful biometric matches separated by the cool off period that are requested in non-familiar locations (e.g., a second type of location) are performed after a single biometric match. After the disarm timer expires (e.g., the period of time exceeds 3, 6, 9, or 12 hours) the security process returns to not started state 901 at 908. Alternatively, if the security process detects a reset, such as a reset of the security process and/or a reset of the computer system, regardless of how the security process entered ready state 902, then the security process returns to not started state 901 at 908.

When an operation is requested in a non-familiar location (e.g., a second type of location) and no successful biometric match has been detected for a period of time (e.g., 1, 7, 14, 28, 30, 60, or 120 days) the security proceeds to collapsed state 905 at 915 and the requested operation is authenticated without the security process. The security process collapse because a biometric sensor of the computer system has been unable to observe a successful match for the period of time measured by an expiration timer. The period of time varies for different types of operations and states of the computer system. When the requested operation is an operation (e.g., a first type of operation) when the computer system (e.g., 600) is being first configured, such as an out of box experience, or is an operation that includes filling a password that is accessible by the computer system into a field or form the period of time before the security process collapses is 1 or 3 days. For operations that require a higher level of security, when the computer system can connect to a server and verify that the computer system is not in a lost mode (e.g., the computer system is not marked as lost on a remote device registration service), then the period of time before the security policy collapses is 7 or 14 days. For operations that require a higher level of security, when the computer system cannot connect to a server and/or is in a lost mode (e.g., the computer system has been marked as lost on a remote device registration service), then the period of time before the security policy collapses the policy is 28 or 60 days.

Once the security policy is in collapsed state 905, when the computer system detects a successful biometric match then the security policy re-engages and returns to not started state 901 at 916.

FIG. 9B illustrates method 900b of a computer system (e.g., 100, 300, 500, and/or 600) performing authentication in familiar and unfamiliar locations. Some operations in method 900b are, optionally, combined, the orders of some operations are, optionally, changed, and some operations are, optionally, omitted.

At not-started state 920, the security process receives a request (e.g., 610 and/or 1010) for an operation. When the requested operation does not require authentication, the security process moves to approved state 921 at 926 and the operation is performed, regardless of the location of the computer system (e.g., 600, 1000) when the request was detected.

When the requested operation requires authentication, the security process receives biometric information (e.g., detects a first authentication attempt using a first type of biometric authentication) (e.g., 616 and/or 1016) and compares the received biometric information to enrolled biometric features to determine if there is a biometric match. When there is a biometric match, the security process moves to approved state 921 at 927 and the operation is performed, regardless of the location of the computer system (e.g., 600 and/or 1000) when the request (e.g., 610 and/or 1010) was detected.

When there is a biometric failure (e.g., not a biometric match and/or received biometric information does not match enrolled biometric features), at 928, the security process moves to retry state 922 where a second biometric authentication (e.g., 616 and/or 1016) is received. The biometric information received from the second biometric authentication is compared to enrolled biometric features to determine if there is a biometric match. When there is a biometric match for the second biometric authentication, at 929, the security process moves to the approved state 921 and the operation is performed, regardless of the location of the computer system (e.g., 600 and/or 1000) when the request (e.g., 610 and/or 1010) was detected.

When there is a second biometric failure (e.g., the second biometric authentication is not successful) then the security process moves to a state based on the location of the computer system (e.g., 600 and/or 1000) when the request (e.g., 610 and/or 1010) was detected. In some embodiments, a predetermined number of biometric failures, such as 3, 4, or 5, are detected before the security process moves to a state based on the location of the computer system when the request was detected. Thus, the user may attempt and fail up to the predetermined number of biometric authentications before the security process behaves as described below.

When the request for the operation is detected when the computer system (e.g., 600, 1000) is in a familiar location (e.g., a first type of location) and there is a second biometric failure, the security process moves, at 930, to fallback state 923. In fallback state 923 the security process requests and/or receives passcode authentication (e.g., an alternative form of authentication that is different from a type of biometric authentication). When a passcode received for the passcode authentication matches an enrolled passcode then the security process moves, at 931, to approved state 921 and the operation is performed.

When the request for the operation is detected when the computer system is in a non-familiar location (e.g., a second type of location) the security process moves, at 932, to rejected state 924. In rejected state 924, a user cannot provide a passcode for authentication (e.g., an alternative form of authentication that is different from a type of biometric authentication) to perform the operation and cannot provide further biometric authentication attempts (e.g., 616 and/or 1016).

Accordingly, in some embodiments, when in rejected state 924 the security process enters biometric lockout. Thus, in some embodiments, when in rejected state 924, the security process is also in passcode state 925 and successful passcode authentication (e.g., an alternative form of authentication that is different from a type of biometric authentication) is required to provide further biometric authentications. When in not started state 920, the security process detects an indication (e.g., a flag, signal, and/or message) that the security process should perform biometric lockout at 933. The security process then moves into passcode state 925. In passcode state 925, the security process requests and/or receives a passcode to exit the biometric lockout and allow a user to attempt further biometric authentication attempts.

When a passcode is received in passcode state 925 that matches an enrolled passcode the security process performs passcode verification 934 to return to not started state 920, where further biometric authentication attempts can be performed to perform the requested operation.

FIGS. 10A-10Q illustrate example user interfaces for authentication using multiple types of authentication, in accordance with some embodiments. The user interfaces in these figures are used to illustrate the processes described below, including the processes in FIG. 11.

The computer systems described herein optionally prevent performance of requested operations and limit or prevent receipt of further biometric authentications when an attempted biometric authentication is not successful. The computer systems can further request an alternative authentication using, for example, a passcode to re-enable the ability to perform biometric authentications. Once the computer system successfully authenticates the user's identity based on a received biometric authentication, the computer system performs the operation as requested by the user.

At FIG. 10A, computer system 1000 is displaying webpage 1009 and has received a request (e.g., via a tap input on a credential field of the website) to fill in webpage credentials (e.g., username and/or password). In response to the request to fill in the webpage credentials, computer system 1000 displays sheet 1011, which includes autofill option 1012 and keyboard option 1014. At FIG. 10A, computer system 1000 detects an input (e.g., tap input 1010) directed to autofill option 1012 associated with an autofill operation to sign in with a user account. In response to detecting the input (e.g., tap input 1010) directed to autofill option 1012, computer system 1000 displays request 1016 for biometric authentication, as shown in FIG. 10B.

Exemplary biometric authentication includes authentication using face scans, fingerprint scans, and/or eye scans which can be received using various sensors of computer system 1000, such as a camera, a fingerprint scanner, and/or other sensors configured to capture biometric information for use in the biometric authentication. Accordingly, computer system 1000 optionally uses different types of biometric authentication when authenticating a user and optionally further uses, as discussed in more detail below, alternative types of authentication, such as authentication with a passcode and/or password.

At FIG. 10B, computer system 1000 detects (e.g., before, after, and/or during display of request 1016) a biometric information with, for example, a camera of computer system 1000. When the detected biometric information matches an enrolled biometric associated with a user, computer system 1000 performs the autofill operation to sign-in the user account and displays user interface 1002, as shown in FIG. 10C. When the detected biometric information does not match an enrolled biometric associated with a user, computer system 1000 allows another authentication attempt using the same type of biometric authentication that was previously attempted. Accordingly, computer system 1000 displays notification 1018 indicating that another biometric authentication can be attempted, as shown in 10D. In some embodiments, when the detected biometric information does not match an enrolled biometric, computer system 1000 automatically attempts another biometric authentication using the same type of biometric authentication, as shown in FIG. 10E.

In response to detecting selection of a notification (e.g., tap input 1020 on notification 1018) at FIG. 10D, computer system 1000 displays request 1016 for biometric authentication, as shown in FIG. 10E. In some embodiments, computer system 1000 allows a predetermined number of attempts with the same type of biometric authentication before locking a user out of biometric authentication and/or requiring an alternative type of authentication to provide further attempts of biometric authentication. Thus, the process of displaying a request for biometric authentication and receiving a biometric authentication may be repeated (e.g., 2, 3, 4, 5, and/or 10 times).

When the detected (e.g., at FIG. 10B and/or 10E) biometric information matches an enrolled biometric associated with a user, computer system 1000 performs the autofill operation to sign-in the user account and displays user interface 1002, as shown in FIG. 10C. However, when the biometric information detected at FIG. 10E does not match an enrolled biometric associated with a user, computer system 1000 presents different options to the user depending on the location of computer system 1000, as shown in FIG. 10F.

When computer system 1000 is in a familiar location such as the user's home, place of work, and/or other location where the user frequently visits, computer system 1000 allows an alternative type of authentication to be attempted to initiate performance of the requested operation. Accordingly, when in familiar location A, such as the user's home as shown in map 1004 of FIG. 10F, computer system 1000 displays notification 1022 indicating to the user that passcode authentication can be attempted to perform the requested operation. In response to receiving an input (e.g., tap input 1024) directed to notification 1022, computer system 1000 displays passcode user interface 1030, as shown in FIG. 10G, and subsequently receives set of inputs 1032 that includes the passcode. When the received passcode matches an enrolled passcode associated with the user, computer system 1000 performs the autofill operation to sign-in the user account and displays user interface 1002, as shown in FIG. 10C.

In some embodiments, the alternative authentication requested by computer system 1000 is an alternative type of biometric authentication (e.g., different from the biometric authentication that was not successful at FIG. 10E), such as authentication using face scans, fingerprint scans, and/or eye scans which can be received using various sensors of computer system 1000 such as a camera, a fingerprint scanner, and/or other sensors configured to capture the biometric authentication. Accordingly, if a biometric authentication attempt using a face scan does not succeed, computer system 1000 optionally requests a fingerprint scan and/or an eye scan rather than a passcode and/or password as discussed above.

When computer system 1000 is in an unfamiliar location (e.g., any location that is not a familiar location), as shown in map 1006 of FIG. 8F, computer system 1000 prevents further authentication attempts of the same type that were previously attempted and does not perform the requested operation. Additionally, computer system 1000 allows an alternative type of authentication, such as a passcode, to be attempted to re-enable the ability to provide biometric authentications of the same type that were previously attempted. Accordingly, computer system 1000 displays notification 1026 indicating that a passcode authentication can be attempted to attempt further biometric authentications. In response to receiving an input (e.g., tap input 1028) directed to notification 1026, computer system 1000 displays passcode user interface 1034, as shown in FIG. 10G, and subsequently receives set of inputs 1036 including the passcode.

At FIG. 10G, when the received passcode does not match an enrolled passcode associated with the user, the passcode authentication is not successful. Accordingly, computer system 1000 continues to prevent further biometric authentications of the type that were previously attempted and displays notification 1038 indicating that the user is unable to attempt further biometric authentications, as shown in FIG. 10H.

When the received passcode matches an enrolled passcode associated with the user, the passcode authentication is successful. Thus, when computer system 1000 is at an unfamiliar location and the passcode authentication is successful at FIG. 10G, computer system 1000 allows further biometric authentications of the type that were previously attempted and displays request 1016 for biometric authentication, as shown in FIG. 10I. Computer system 1000 then detects a biometric authentication in response to displaying request 1016. computer system 1000 computer system 1000 Thus, computer system 1000 exhibits different behavior based on whether computer system 1000 is at a familiar location or an unfamiliar location when the passcode authentication is successful at FIG. 10G.

At FIG. 10I, when the detected biometric authentication matches an enrolled biometric associated with a user, computer system 1000 performs the autofill operation to sign-in the user account and displays user interface 1002, as shown in FIG. 10J.

At FIG. 10I, when the detected biometric authentication does not match an enrolled biometric associated with a user, computer system 1000 does not perform the operation and instead displays notification 1040 indicating that a successful biometric authentication is required to perform the operation and that passcode authentication is not enough, as shown in FIG. 10K.

In some embodiments, preventing further authentication attempts of the same type that were previously attempted (e.g., when the mobile phone is at an unfamiliar location) includes ignoring received biometric information of the same type. Thus, computer system 1000 may receive biometric information and disregard the received biometric information without comparing received biometric information to an enrolled biometric associated with the user.

In some embodiments, computer system 1000 does not allow an alternative type of authentication and/or provide a request for the alternative type of authentication until an amount of time has passed after determining that detected biometric information does not match an enrolled biometric associated with a user. For example, computer system 1000 optionally requires that at least thirty minutes pass after the user has been locked out (e.g., prevented from attempting the same type of biometric authentication) before allowing and/or requesting the alternative type of authentication. In some embodiments, computer system 1000 only requires a time delay before allowing and/or requesting the alternative type of authentication when computer system 1000 is located at an unfamiliar location.

At FIG. 10L, computer system 1000 has been placed into a lost mode (e.g., via receiving a signal from a remote server) and displays lost mode user interface 1042. Lost mode user interface 1042 includes notification 1044 indicating that computer system 1000 is in a lost mode, as well as call option 1046 for initiating a call with the user associated with computer system 1000. Computer system 1000 detects an input (e.g., drag input 1048 from the bottom towards the top of the screen of computer system 1000). In response to detecting the input (e.g., drag input 1048), computer system 1000 initiates a process for unlocking computer system 1000 and removing computer system 1000 from the lost mode.

To remove computer system 1000 from the lost mode and unlock computer system 1000, multiple types of authentication must be successfully performed. In particular, computer system 1000 must successfully authenticate the user's identity with a first type of authentication, such as passcode authentication, and then a second type of authentication, such as biometric authentication (or, optionally, vice-versa). Accordingly, in response to detecting the input (e.g., drag input 1048) that initiates the process for unlocking computer system 1000, computer system 1000 displays passcode user interface 1050, as shown in FIG. 10M.

While displaying passcode user interface 1050, computer system 1000 detects series of inputs 1052 providing the passcode. When the received passcode matches an enrolled passcode associated with a user of computer system 1000, computer system 1000 determines that the passcode authentication is successful and displays request 1016 for biometric authentication, as shown in FIG. 10O. Computer system 1000 further optionally displays notification 1054 that biometric authentication is required and authentication option 1056 for triggering request 1016, as shown in FIG. 10N. When computer system 1000 detects an input (e.g., tap input 1058) directed to authentication option 1056, computer system 1000 displays request 1016, as shown in FIG. 10O.

While displaying request 1016 at FIG. 10O, computer system 1000 detects biometric information. When the received biometric information matches an enrolled biometric associated with the user, computer system 1000 is unlocked and optionally removed from the lost mode, as shown in FIG. 10P. In particular, computer system 1000 ceases to display the notifications related to the lost mode and instead displays widgets 1060 and 1062 which are associated with a calendar application and a fitness application respectively and include private information that is not displayed (and, optionally, inaccessible) when computer system 1000 is in the lost mode. Computer system 1000 then detects an input (e.g., drag input 1064 at the bottom of the display in an upward direction) and displays home screen user interface 1066, which includes further private information that is not displayed (and is, optionally, inaccessible) when computer system 1000 is in the lost mode.

FIGS. 11A-11B are a flow diagram illustrating a method for displaying user interfaces for authentication using multiple types of authentication using a computer system in accordance with some embodiments. Method 1100 is performed at a computer system (e.g., 100, 300, 500, 600, and/or 1000) (e.g., a smartphone, a desktop computer, a laptop, a tablet, and/or a wearable electronic device) that is in communication with a display generation component (e.g., a display controller and/or a touch-sensitive display system) and one or more input devices (e.g., a button, a motion detector (e.g., an accelerometer and/or gyroscope), a location sensor (e.g., GPS, Wi-Fi, and/or a radio that indicates a location of the computer system), a camera, a fingerprint scanner, and/or a touch-sensitive surface). Some operations in method 1100 are, optionally, combined, the orders of some operations are, optionally, changed, and some operations are, optionally, omitted.

As described below, method 1100 provides an intuitive way for managing user authentication. The method reduces the cognitive burden on a user when using authentications of different types, thereby creating a more efficient human-machine interface. For battery-operated computing devices, enabling a user to authenticate to perform an operation faster and more efficiently conserves power and increases the time between battery charges.

The computer system (e.g., 1000) detects (1102), via the one or more input devices, a first authentication attempt (e.g., 1016) using a first type of biometric authentication (e.g., a fingerprint scan, a face scan, and/or an eye scan.) (e.g., to confirm payment, confirm submission of an application (e.g., for a credit card and/or a new user account), change a setting associated with the computer system, and/or change a setting associated with a user account associated with the computer system (e.g., 1000)). In some embodiments, the first authentication attempt is detected while displaying, via the display generation component, a user interface for an application (e.g., a web application, a payment application, and/or a device pairing application). In some embodiments, the first authentication attempt is detected while displaying, via the display generation component, a user interface for settings associated with the computer system and/or a user account associated with the computer system. In some embodiments, the first authentication attempt is detected after (e.g., in response to) providing a prompt requesting to perform authentication. In some embodiments, the first authentication attempt is detected after (e.g., in response to) receiving a request to change a setting associated with the computer system and/or a user account associated with the computer system. In some embodiments, the first authentication attempt is detected after (e.g., in response to) receiving a request to perform an operation (e.g., providing payment and/or completing an order) In some embodiments, the first authentication attempt is triggered (e.g., by a person putting on a device, raising a device, waking a device, and/or attempting to perform an operation with the device such as unlocking the device, opening an application, filling a credential, authorizing a payment, and/or changing a setting associated with the computer system and/or a user account associated with the computer system).

In response to detecting the first authentication attempt (1104): in accordance with a determination that a first input of the first type of biometric authentication matches an enrolled biometric feature, the computer system (e.g., 1000) performs (1106) a respective operation (e.g., an operation associated with 1012) (e.g., starting a delay, unlocking a device, opening an application, filling a credential, authorizing a payment, and/or changing a setting associated with the computer system and/or a user account associated with the computer system) associated with the first authentication attempt.

In response to detecting the first authentication attempt (1104): in accordance with a determination that the first input of the first type of biometric authentication does not match an enrolled biometric feature (e.g., a fingerprint scan, face scan, and/or eye scan does not match a biometric signature associated with an account and/or a user.), the computer system (e.g., 1000) prevents (1108) further authentication attempts (e.g., 1016) using the first type of biometric authentication without performing the respective operation (e.g., an operation associated with 1012) associated with the first authentication attempt. In some embodiments, the first input does not match an enrolled biometric feature when the first input is different from an enrolled biometric associated with an account and/or a user. In some embodiments, the first input does not match an enrolled biometric feature when an amount of difference between the first input and an enrolled biometric feature associated with the account and/or the user is above a predetermined threshold. In some embodiments, the first input matches an enrolled biometric feature when an amount of difference between the first input and an enrolled biometric feature associated with the account and/or the user is below the predetermined threshold. In some embodiments, in accordance with the determination that the first input does not match an enrolled biometric feature, the computer system disables some (e.g., one or more) input devices (e.g., a camera and/or fingerprint scanner) in communication with the computer system. In some embodiments, further authentication attempts using the first type of biometric authentication are prevented for a predetermined time. In some embodiments, further authentication attempts using the first type of biometric authentication are prevented indefinitely. In some embodiments, in accordance with the determination that the first input does not match an enrolled biometric feature, the computer system displays, via the display generation component, an error message.

While preventing further authentication attempts (e.g., 1016) using the first type of biometric authentication and in accordance with a determination that a first set of criteria (e.g., the computer system being at a first type of location, a predetermined amount of time has passed since detecting the first input of the first type of biometric authentication, and/or the computer system being in a first mode) are met, the computer system (e.g., 1000) provides (1110) a prompt (e.g., 1022 and/or 1026) for an alternative type of authentication (e.g., a non-biometric authentication, a password, passcode, and/or a second type of biometric authentication that is different from the first type of biometric authentication such as a fingerprint scan, a face scan, and/or an eye scan) that is different from the first type of biometric authentication. In some embodiments, providing the prompt for the alternative type of authentication includes displaying, via the display generation component, a prompt for the alternative type of authentication. In some embodiments, providing the prompt for the alternative type of authentication includes providing an audio output requesting the alternative type of authentication. In some embodiments, providing the prompt for the alternative type of authentication includes displaying, via the display generation component, an overlay (e.g., a pop-up and/or a window) over a currently displayed user interface. In some embodiments, authentication attempts using the first type of biometric authentication are prevented in response to detecting a press of a hardware button. In some embodiments, authentication attempts using the first type of biometric authentication are prevented in response to detecting a press of a hardware button for a predetermined length of time (e.g., 1 second, 2 seconds, and/or 5 seconds). In some embodiments, authentication attempts using the first type of biometric authentication are prevented in response to detecting a recent restart of the computer system. In some embodiments, authentication attempts using the first type of biometric authentication are prevented in response to detecting the computer system powering off and powering on within a predetermined amount of time.

The computer system (e.g., 1000) receives (1112), via the one or more input devices, a second authentication attempt (e.g., 1032 and/or 1036) using the alternative type of authentication (e.g., a password, passcode, and/or a second type of biometric authentication such as a fingerprint scan, a face scan, and/or an eye scan).

In response to receiving the second authentication attempt (1114): in accordance with a determination that the second authentication attempt includes received authentication information that matches an enrolled authentication information for the alternative type of authentication (e.g., a non-biometric authentication, a password, passcode, and/or a second type of biometric authentication associated with an account and/or a user), the computer system (e.g., 1000) enables (1116) further authentication attempts (e.g., 1016) using the first type of biometric authentication (and, optionally, without performing the respective operation). In some embodiments, in accordance with the determination that the second authentication attempt includes received authentication information that matches enrolled authentication information for the alternative type of authentication, the computer system enables one or more input devices (e.g., a fingerprint scanner and/or camera) in communication with the computer system. In some embodiments, in accordance with the determination that the second authentication attempt includes received authentication information that matches enrolled authentication information for the alternative type of authentication, the computer system displays, via the display generation component, a prompt requesting a second authentication attempt of the first type of biometric authentication. (e.g., without performing the respective operation associated with the first authentication attempt).

In response to receiving the second authentication attempt (1114): in accordance with a determination that the second authentication attempt does not include received authentication information that matches enrolled authentication information for the alternative type of authentication, the computer system (e.g., 1000) continues (1118) to prevent further authentication attempts (e.g., 1016) using the first type of biometric authentication (and, optionally, without performing the respective operation). In some embodiments, preventing authentication attempts using the first type of biometric authentication is continued for a predetermined time. In some embodiments, preventing authentication attempts using the first type of biometric authentication is continued until a set of criteria are met. In some embodiments, the set of criteria includes a criterion that the computer system be in a type of location. In some embodiments, the set of criteria includes a criterion that a predetermined amount of time has passed since receiving an alternative type of authentication. In some embodiments, the set of criteria includes a criterion that a first type of operation be performed. In some embodiments the set of criteria includes a criterion that the computer system be in a first mode. Thus, in some embodiments, in response to detecting a biometric authentication failure the computer system prevents further biometric authentication attempts, and while the computer system prevents further biometric authentication attempts, the computer system requests alternative authentication and allows additional biometric authentication attempt when the alternative authentication is successful. Preventing further biometric authentication attempts in response to detecting a biometric authentication failure and requesting alternative authentication to allow additional biometric authentication attempts enables the computer system to require multiple different successful authentication attempts in order to perform certain operations and/or make certain changes to accounts, thereby providing additional control and security options.

In some embodiments, the computer system (e.g., 1000) detects, via the one or more input devices, a third authentication attempt (e.g., 1016) using the first type of biometric authentication (e.g., a fingerprint scan, a face scan, and/or an eye scan.) (e.g., to confirm payment, confirm submission of an application (e.g., for a credit card and/or a new user account), change a setting associated with the computer system, and/or change a setting associated with a user account associated with the computer system); and in response to detecting the third authentication attempt using the first type of biometric authentication: in accordance with a determination that authentication attempts (e.g., 1016) using the first type of biometric authentication are enabled: in accordance with a determination that a second input of the first type of biometric authentication received with the third authentication attempt (e.g., 1016) matches an enrolled biometric feature, the computer system performs the respective operation (e.g., an operation associated with 1012) associated with the first authentication attempt (e.g., confirming payment, confirming submission of an application (e.g., for a credit card and/or a new user account), changing a setting associated with the computer system and/or changing a setting associated with a user account associated with the computer system); and in accordance with a determination that the second input of the first type of biometric authentication received with the third authentication attempt does not match an enrolled biometric feature, the computer system forgoes performing the respective operation (e.g., an operation associated with 1012) associated with the first authentication attempt. Performing an operation associated with a previous authentication attempt when another authentication attempt of the same type is successful and enabled allows the computer system to perform previously requested operations when the user is able to successfully authenticate the user's identity, thereby performing an operation when a set of conditions has been met without requiring further user input.

In some embodiments, in response to detecting the third authentication attempt (e.g., 1016) using the first type of biometric authentication (e.g., a face scan, fingerprint scan, and/or eye scan): in accordance with a determination that authentication attempts using the first type of biometric authentication are prevented, the computer system (e.g., 1000) disregards the third authentication attempt (e.g., 1016) using the first type of biometric authentication without comparing the second input of the first type of biometric authentication received with the third authentication to an enrolled biometric feature (e.g., a face scan, fingerprint scan, and/or eye scan associated with a user profile). In some embodiments, if the first type of biometric authentication is not permitted, the computer system ignores biometric authentications of the first type without regard as to whether the biometric information received from the first type of biometric authentications matches or does not match and enrolled biometric information. Ignoring biometric authentication attempts of the first type when the first type of biometric authentication is not permitted without regard as to whether received biometric information matches an enrolled biometric information enables the computer system to reduce the number of comparisons between received biometric information and enrolled biometric information when biometric authentication attempts of a certain type are not allowed, thereby providing additional control and security options.

In some embodiments, the alternative type of authentication is a passcode, password and/or a swipe pattern (e.g., received at computer system 1000). Allowing the alternative type of authentication to be a passcode and/or a password enables the computer system to authenticate a user's identity when the user may not be able to provide biometric authentication information, thereby providing additional control and security options.

In some embodiments, prior to detecting the first authentication attempt (e.g., 1016 as shown in FIG. 10E) using the first type of biometric authentication: the computer system detects a fourth authentication attempt (e.g., 1016 as shown in FIG. 10B) using the first type of biometric authentication; and in response to detecting the fourth authentication attempt using the first type of biometric authentication: in accordance with a determination that a third input of the first type of biometric authentication received in the fourth authentication attempt does not match an enrolled biometric feature, the computer system (e.g., 1000) provides a prompt (e.g., 1018) (e.g., displaying via the display generation component and/or outputting via an audio output device) for the first authentication attempt using the first type of biometric authentication and forgoing performing a respective operation (e.g., an operation associated with 1012) associated with the fourth authentication attempt using the first type of biometric authentication. In some embodiments, in response to detecting the fourth authentication attempt using the first type of biometric authentication and in accordance with a determination that the third input of the first type of biometric authentication received in the fourth authentication attempt matches enrolled biometric feature, performing a respective operation (e.g., starting a delay, unlocking a device, opening an application, filling a credential, authorizing a payment, and/or changing a setting associated with the computer system and/or a user account associated with the computer system) associated with the first authentication attempt. In some embodiments, one or a plurality of authentication attempts using the first type of biometric authentication are detected before (e.g., immediately before) the first authentication attempt. In some embodiments, the computer system allows a user to attempt multiple biometric authentications before locking the user out (and, optionally, thus requiring a passcode). Allowing a user to attempt multiple biometric authentications before preventing the user from attempting additional biometric authentications enables the computer system to account for errors or user mistakes before preventing a user from accessing operations of the computer system, thereby providing additional control and security options.

In some embodiments, in response to receiving the second authentication attempt (e.g., 1032 and/or 1036) and in accordance with the determination that the second authentication attempt does not include received authentication information that matches enrolled authentication information for the alternative type of authentication, the computer system (e.g., 1000) forgoes performing the respective operation (e.g., an operation associated with 1012) (e.g., starting a delay, unlocking a device, opening an application, filling a credential, authorizing a payment, and/or changing a setting associated with the computer system and/or a user account associated with the computer system) associated with the first authentication attempt. In some embodiments, the computer system prevents access to operations of the device without a successful biometric authentication. Preventing access to operations of the device without a successful biometric authentication enables the computer system to provide greater security to a user when a biometric authentication cannot be performed, thereby providing additional control and security options.

In some embodiments, subsequent to receiving the second authentication attempt that does not include received authentication information that matches enrolled authentication information for the alternative type of authentication and in accordance with a determination that a predetermined amount of time has passed since receiving the second authentication attempt, the computer system (e.g., 1000) provides a prompt (e.g., 1022 and/or 1026) for the alternative type of authentication (e.g., a non-biometric authentication, a password, passcode, and/or a second type of biometric authentication that is different from the first type of biometric authentication such as a fingerprint scan, a face scan, and/or an eye scan) that is different from the first type of biometric authentication; subsequent to providing the prompt (e.g., 1022 and/or 1026) for the alternative type of authentication, the computer system (e.g., 1000) receives via the one or more input devices, a fifth authentication attempt (e.g., 1032 and/or 1036) using the alternative type of authentication (e.g., a password, passcode, and/or a second type of biometric authentication such as a fingerprint scan, a face scan, and/or an eye scan); and in response to receiving the fifth authentication attempt and in accordance with a determination that the fifth authentication attempt includes received authentication information that matches an enrolled authentication information for the alternative type of authentication (e.g., a non-biometric authentication, a password, passcode, and/or a second type of biometric authentication associated with an account and/or a user), the computer system performs the respective operation (e.g., an operation associated with 1012). In some embodiments, in response to receiving the fifth authentication attempt and in accordance with a determination that the fifth authentication attempt does not include received authentication information that matches enrolled authentication information for the alternative type of authentication, forgoing performing the respective operation. In some embodiments, the prompt for the alternative type of authentication is provided in response to enabling the alternative type of authentication. In some embodiments, the computer system allows an alternative type of authentication after a time period delay. Allowing an alternative type of authentication after a time period delay enables the computer system to provide greater security to a user while still allowing the user to provide different types of authentication attempts, thereby providing additional control and security options.

In some embodiments, the respective operation is a critical account change and in response to receiving the second authentication attempt (e.g., 1032 and/or 1036): in accordance with a determination that the second authentication attempt does not include received authentication information that matches enrolled authentication information for the alternative type of authentication, the computer system (e.g., 1000) forgoes performing the respective operation. In some embodiments, the computer system (e.g., 1000) prevents access to critical account changes without a successful biometric authentication. Preventing access to critical account changes without a successful biometric authentication enables the computer system to provide greater security to a user when a biometric authentication cannot be performed, thereby providing additional control and security options.

In some embodiments, the first set of criteria includes a first criterion that is met when the computer system (e.g., 1000) is in a second type of location (e.g., location E as shown in 10F and/or 10G) (e.g., not a familiar location, such as a location that is: not a trusted location, not a location at which the computer system has previously been charged at overnight, and/or not a location that a user of the computer system has previously designated as a home of the user), and while preventing further authentication attempts (e.g., 1016) using the first type of biometric authentication and in accordance with a determination that a second set of criteria (e.g., the computer system (e.g., 1000) being at a first type of location, a predetermined amount of time has passed since detecting the first input of the first type of biometric authentication, and/or the computer system being in a second mode) are met, wherein the second set of criteria includes a second criterion that is met when the computer system (e.g., 1000) is in a first type of location (e.g., location A as shown in 10F and/or 10G) (e.g., a familiar location, such as: a trusted location, a location at which the computer system has previously been charged at overnight, and/or a location that a user of the computer system has previously designated as a home of the user) that is different from the second type of location: the computer system provides the prompt (e.g., 1022, 1026) for an alternative type of authentication (e.g., a non-biometric authentication, a password, passcode, and/or a second type of biometric authentication that is different from the first type of biometric authentication such as a fingerprint scan, a face scan, and/or an eye scan) that is different from the first type of biometric authentication; and the computer system receives via the one or more input devices, the second authentication attempt (e.g., 1032, 1036) using the alternative type of authentication (e.g., a password, passcode, and/or a second type of biometric authentication such as a fingerprint scan, a face scan, and/or an eye scan); in response to receiving the second authentication attempt and in accordance with the determination that the second authentication attempt includes received authentication information that matches enrolled authentication information for the alternative type of authentication (e.g., a non-biometric authentication, a password, passcode, and/or a second type of biometric authentication associated with an account and/or a user), the computer system performs the respective operation (e.g., an operation associated with 1012). In some embodiments, in response to receiving the second authentication attempt and in accordance with the determination that the second authentication attempt does not include received authentication information that matches enrolled authentication information for the alternative type of authentication, forgoing performing the respective operation. In some embodiments, the computer system allows the alternative type of authentication (e.g., passcode fallback) when in a familiar location and does not allow the alternative type of authentication when in a non-familiar location. Allowing the alternative type of authentication when in a familiar location and not allowing the alternative type of authentication when in a non-familiar location enables the computer system to provide greater security to a user in locations where a user is more likely to have security risks while enabling easier access at locations like the user's home, thereby providing additional control and security options.

In some embodiments, providing the prompt (e.g., similar to 1022 and/or 1026) for the alternative type of authentication includes displaying, via the display generation component, a prompt for the alternative type of authentication. In some embodiments, providing the prompt for the alternative type of authentication includes providing an audio output requesting the alternative type of authentication. In some embodiments, providing the prompt for the alternative type of authentication includes displaying, via the display generation component, an overlay (e.g., a pop-up and/or a window) over a currently displayed user interface. In some embodiments, authentication attempts using the first type of biometric authentication are prevented in response to detecting a press of a hardware button. In some embodiments, authentication attempts using the first type of biometric authentication are prevented in response to detecting a press of a hardware button for a predetermined length of time (e.g., 1 second, 2 seconds, and/or 5 seconds). In some embodiments, authentication attempts using the first type of biometric authentication are prevented in response to detecting a recent restart of the computer system. In some embodiments, authentication attempts using the first type of biometric authentication are prevented in response to detecting the computer system powering off and powering on within a predetermined amount of time.

In some embodiments, the first set of criteria includes a first criterion that is met when the computer system (e.g., 1000) is in a second type of location (e.g., location E as shown in 10F and/or 10G) (e.g., not a familiar location, such as a location that is: not a trusted location, not a location at which the computer system has previously been charged at overnight, and/or not a location that a user of the computer system has previously designated as a home of the user), and while preventing further authentication attempts (e.g., 1016) using the first type of biometric authentication and in accordance with the determination that the first set of criteria are met, wherein the first set of criteria includes a third criterion that is met after a first period of time (e.g., 24 hours, 7 days, or 28 days) has passed since the determination that the first input of the first type of biometric authentication does not match an enrolled biometric feature: the computer system provides the prompt (e.g., 1022 and/or 1026) for the alternative type of authentication (e.g., a non-biometric authentication, a password, passcode, and/or a second type of biometric authentication that is different from the first type of biometric authentication such as a fingerprint scan, a face scan, and/or an eye scan) that is different from the first type of biometric authentication; and the computer system receives via the one or more input devices, the second authentication attempt (e.g., 1032 and/or 1036) using the alternative type of authentication (e.g., a password, passcode, and/or a second type of biometric authentication such as a fingerprint scan, a face scan, and/or an eye scan); in response to receiving the second authentication attempt and in accordance with the determination that the second authentication attempt includes received authentication information that matches enrolled authentication information for the alternative type of authentication (e.g., a non-biometric authentication, a password, passcode, and/or a second type of biometric authentication associated with an account and/or a user), the computer system performs the respective operation (e.g., an operation associated with 1012); In some embodiment, in response to receiving the second authentication attempt and in accordance with the determination that the second authentication attempt does not include received authentication information that matches enrolled authentication information for the alternative type of authentication, forgoing performing the respective operation, and while preventing further authentication attempts (e.g., 1016) using the first type of biometric authentication and in accordance with a determination that a second set of criteria (e.g., the computer system being at a first type of location, a predetermined amount of time has passed since detecting the first input of the first type of biometric authentication, and/or the computer system being in a first mode) are met, wherein the second set of criteria includes a second criterion that is met when the computer system (e.g., 1000) is in a first type of location (e.g., location A as shown in 10F and/or 10G) (e.g., a familiar location, a trusted location, a location at which the computer system has previously been charged at overnight, and/or a location that a user of the computer system has previously designated as a home of the user) that is different from the second type of location and a fourth criterion that is met when a second period of time (e.g., 0 seconds, 0.5 seconds, 1 second, or 3 seconds) that is different from the first period of time has passed since the determination that the first input of the first type of biometric authentication does not match an enrolled biometric feature: the computer system provides the prompt (e.g., 1022 and/or 1026) for an alternative type of authentication (e.g., a non-biometric authentication, a password, passcode, and/or a second type of biometric authentication that is different from the first type of biometric authentication such as a fingerprint scan, a face scan, and/or an eye scan) that is different from the first type of biometric authentication; the computer system receives via the one or more input devices, the second authentication attempt (e.g., 1032 and/or 1036) using the alternative type of authentication (e.g., a password, passcode, and/or a second type of biometric authentication such as a fingerprint scan, a face scan, and/or an eye scan); and in response to receiving the second authentication attempt and in accordance with the determination that the second authentication attempt includes received authentication information that matches enrolled authentication information for the alternative type of authentication (e.g., a non-biometric authentication, a password, passcode, and/or a second type of biometric authentication associated with an account and/or a user), the computer system performs the respective operation (e.g., an operation associated with 1012). In some embodiments, in response to receiving the second authentication attempt and in accordance with the determination that the second authentication attempt does not include received authentication information that matches enrolled authentication information for the alternative type of authentication, forgoing performing the respective operation. In some embodiments, the computer system allows the alternative type of authentication (e.g., passcode fallback) a first amount of time after the biometric failure (e.g., immediately) when in a familiar location and allows the alternative type of authentication (e.g., passcode fallback) a second amount of time after the biometric failure (e.g., 24 hours) when in a non-familiar location. Allowing the alternative type of authentication after a first amount of time after the biometric failure in a familiar location and allowing the alternative type of authentication after a second amount of time after the biometric failure when in a non-familiar location enables the computer system to provide greater security in different types of locations while providing easier access when in locations the user typically frequents, thereby providing additional control and security options.

In some embodiments, providing the prompt (e.g., similar to 1022 and/or 1026) for the alternative type of authentication includes displaying, via the display generation component, a prompt for the alternative type of authentication. In some embodiments, providing the prompt for the alternative type of authentication includes providing an audio output requesting the alternative type of authentication. In some embodiments, providing the prompt for the alternative type of authentication includes displaying, via the display generation component, an overlay (e.g., a pop-up and/or a window) over a currently displayed user interface. In some embodiments, authentication attempts using the first type of biometric authentication are prevented in response to detecting a press of a hardware button. In some embodiments, authentication attempts using the first type of biometric authentication are prevented in response to detecting a press of a hardware button for a predetermined length of time (e.g., 1 second, 2 seconds, and/or 5 seconds). In some embodiments, authentication attempts using the first type of biometric authentication are prevented in response to detecting a recent restart of the computer system. In some embodiments, authentication attempts using the first type of biometric authentication are prevented in response to detecting the computer system powering off and powering on within a predetermined amount of time.

In some embodiments, while the computer system (e.g., 1000) is in a first mode (e.g., a lost mode and/or a disabled mode), the computer system provides a prompt (e.g., 1050) for an authentication attempt using a first type of authentication (e.g., a passcode input or a biometric input); the computer system receives via the one or more input devices, a seventh authentication attempt (e.g., 1052) using the first type of authentication (e.g., a passcode input or a biometric input); in response to receiving the seventh authentication attempt and in accordance with a determination that the seventh authentication attempt is successful and that the computer system (e.g., 1000) is in the first mode (e.g., a lost mode and/or a disabled mode), the computer system provides a prompt (e.g., 1054) for an authentication attempt (e.g., 1016) using a second type of authentication (e.g., a passcode input or a biometric input) that is different from the first type of authentication input; the computer system receives via the one or more input devices, an eighth authentication attempt using the second type of authentication; and in response to receiving the eighth authentication attempt: in accordance with a determination that the eighth authentication attempt is successful, the computer system enables access to the computer system (e.g., 1000) (e.g., unlocking the computer system, allowing modifications to the computer system, and/or transitioning the computer system from the first mode to a second mode (e.g., a not lost mode and/or an enabled mode) that is different from the first mode); and in accordance with a determination that the eighth authentication attempt is unsuccessful, the computer system forgoes enabling access to the computer system (e.g., 1000) (e.g., maintaining the computer system as locked, now allowing modifications to the computer system, and/or maintaining the computer system in the first mode). In some embodiments, when recovering a computer system that has been marked as lost, the computer system requires both a passcode and a biometric authentication to unlock the computer system (and, optionally, subsequently remove the computer system from being marked as lost). Requiring both a passcode and a biometric authentication to unlock the computer system when recovering the computer system that has been marked lost enables the computer system to provide greater security when the computer system has been marked lost as compared to when the computer system has not been marked lost, thereby providing additional control and security options.

In some embodiments, the first type of authentication input is password, passcode (e.g., an alphanumeric password or a numeric passcode), or gesture pattern authentication and the second type of authentication is a biometric authentication. In some embodiments, the computer system requires a passcode first and then a biometric authentication. Requiring a passcode first and then a biometric authentication when recovering the computer system that has been marked lost enables the computer system to display the authentication requirements in a staggered manner, thereby providing improved feedback.

In some embodiments, providing the prompt (e.g., 1050) for the authentication attempt using the first type of authentication comprises: displaying, via the display generation component, a prompt (e.g., 1050) requesting the first type of authentication to attempt the second type of authentication. In some embodiments, the computer system displays a prompt for the user to enter a passcode that, if authenticated, enables the computer system to receive a subsequent biometric authentication for further authentication. Displaying a prompt to use a passcode to enable biometric authentication enables the computer system to provide a notification of the order in which the authentication attempts are required, thereby providing improved feedback.

In some embodiments, the computer system (e.g., 1000) displays, via the display generation component and concurrently with the prompt requesting the first type of authentication to enable the second type of authentication, a password, passcode (e.g., alphanumeric passcode and/or numeric passcode), or gesture pattern entry user interface (e.g., a virtual keyboard, gesture entry area, and/or a handwriting entry area). Displaying the prompt along with the passcode entry user interface enables the computer system to provide the information about the order of authentications while receiving one of the authentications, thereby reducing the number of inputs needed to perform an operation.

In some embodiments, the computer system (e.g., 1000) displays, via the display generation component, a user interface (e.g., 1042) indicating that the computer system (e.g., 1000) is in the first mode (e.g., a user interface including instructions for contacting a user associated with the computer system, an option to contact the user associated with the computer system, and/or a user interface including instructions for enabling the computer system). In some embodiments, the computer system displays, via the display generation component, a lost phone user interface (e.g., with instructions for contacting the owner and/or an option to call the owner). Displaying a lost phone user interface (e.g., with instructions for contacting the owner and/or an option to call the owner) enables the computer system to provide anyone interacting with the computer system the information necessary to return the computer system to the user, thereby providing improved feedback.

Note that details of the processes described above with respect to method 1100 (e.g., FIG. 11) are also applicable in an analogous manner to the methods described above and below. For example, method 1100 optionally includes one or more of the characteristics of the various methods described above with reference to method 700 and/or below with method 1200. For example, method 1100 may incorporate the location-based user authentication described in method 700 in addition to utilizing authentications of multiple types. As another examples, method 1100 may incorporate multiple authentications separated by a timer as described by method 1200 in addition to utilizing authentications of multiple types. For brevity, these details are not repeated above.

FIG. 12 is a flow diagram illustrating a method for performing authentication to perform an operation in accordance with some embodiments. Method 1200 is performed at a computer system (e.g., 100, 300, 500, 600, and/or 1000) (e.g., a smartphone, a desktop computer, a laptop, a tablet, and/or a wearable electronic device) that is in communication with one or more output devices (e.g., a display controller, a touch-sensitive display system, a speaker, a haptic device, and/or a device capable of providing audio output) and one or more input devices (e.g., a button, a motion detector (e.g., an accelerometer and/or gyroscope), a location sensor (e.g., GPS, Wi-Fi, and/or a radio that indicates a location of the computer system), a camera, a fingerprint scanner, a biometric sensor, and/or a touch-sensitive surface). Some operations in method 1200 are, optionally, combined, the orders of some operations are, optionally, changed, and some operations are, optionally, omitted.

As described below, method 1200 provides an intuitive way for increasing security through the use of multiple authentication checks to perform an operation. The method increases the security of the computer system when performing operations, thereby reducing the likelihood of unauthorized access to the computer system. For battery-operated computing devices, reducing the likelihood of unauthorized access to the computer system allows a user more control over the computer system, increasing battery life in addition to security.

The computer system (e.g., 600 and/or 1000) receives (1202), via the one or more input devices, first authentication information corresponding to a request (e.g., 610, 614, 638, 650, and/or 1016) to perform an operation (e.g., operations that are the same as or similar to operations described with reference to 702 and/or 1102). In some embodiments, the operation is an operation (e.g., an operation associated with 640 and/or 652) that is determined to be critical that requires an additional degree of security (e.g., based on the type of operation (e.g., an operation associated with 640 and/or 652), based on the location (e.g., locations A, B, and/or C as shown in 6A and/or locations E, F, and/or G as shown in 6J, 6S, and 6AB) of the computer system, and/or based on other contextual criteria) (e.g., the location based authentication as described above with reference to FIGS. 7, 8, and/or 9A-9B and/or the multiple types of authentication described as above with reference to FIGS. 11A and/or 11B).

In response to receiving, via the one or more input devices, the first authentication information (e.g., password, passcode, pattern, biometric, or other authentication information) (e.g., biometric authentication received in response to 616 and/or authentication attempt 1016), in accordance with a determination that the first authentication information is valid (e.g., that the first authentication information matches authorized password, passcode, pattern, biometric, and/or other authentication information that was previously registered or enrolled for an authorized user), the computer system (e.g., 600 and/or 1000) delays (1204) allowing the operation (e.g., an operation associated with 640 and/or 652) to be performed for a threshold amount of time (e.g., as described above with reference to FIG. 7) (e.g., the operation is prevented from being performed, but optionally a delay timer is started that will, after one or more other security criteria are met, enable the operation to be performed) (e.g., starting the delay timer as described above with reference to FIGS. 6A-6AK).

After the expiration of the threshold amount of time (e.g., the timer shown in 648), the computer system (e.g., 600 and/or 1000) receives (1206), via the one or more input devices, second authentication information corresponding to the request to perform the operation (e.g., biometric authentication in response to 616 and/or authentication attempt 1016) (e.g., the multiple authentications separated by a delay timer as described above with reference to FIGS. 7, 8, 9A, and/or 9B).

In response to receiving the second authentication information, in accordance with a determination that the second authentication information is valid (e.g., that the second authentication information matches authorized password, passcode, pattern, biometric, and/or other authentication information that was previously registered or enrolled for an authorized user), the computer system (e.g., 600 and/or 1000) allows (1208) the operation (e.g., an operation associated with 640 and/or 652) to be performed, wherein the second authentication information is required to be provided in conjunction with (e.g., along with, concurrently with, simultaneously with, and/or within a threshold time of) a contextual cue that cannot be conveyed verbally or in writing (e.g., the second authentication information is required to be biometric authentication information and/or is required to be accompanied by a context that cannot be replicated based on information provided by a person without access to another physical object or device, such as the presence of a wireless or wired connection to a known device such as a vehicle stereo, unlocked computer, unlocked phone, unlocked watch, and/or unlocked wearable device) (e.g., the multiple authentications separated by a delay timer as described above with reference to FIGS. 7, 8, 9A, and/or 9B).

While the operation is allowed to be performed, the computer system (e.g., 600 and/or 1000) detects (1210), via the one or more input devices, input corresponding to a request to perform the operation (e.g., an operation associated with 640 and/or 652).

In response to detecting the input corresponding to the request to perform the operation, the computer system (e.g., 600 and/or 1000) performs (1212) the operation (e.g., an operation associated with 640 and/or 652), wherein performing the operation includes generating, via the one or more output devices, an indication that the operation has been performed (e.g., updating the appearance of a status indicator, changing a user interface that is displayed via a display generation component of the device, and/or providing a non-visual output such as a haptic output and/or audio output that indicates that the operation has been performed).

Requiring two valid authentications separated by a delay to perform the operation including an authentication information that is required to be provided in conjunction with a contextual cue that cannot be conveyed verbally or in writing increases the security of the computer system and allows for the prevention of unauthorized use of the computer system by a party other than the owner of the computer system if the computer system is removed from the presence of the owner, because the owner of the computer system cannot be forced to provide the contextual cue in verbally or in writing. Thus, even when the party other than the owner of the computer system has retrieved some security information of the user, such as a passcode, the party cannot perform critical operations because the physical presence of the owner and/or unlocked device associated with the owner is required (e.g., forgoing initiating a process to perform the operation as described with reference to 708, preventing further authentication attempts as described with reference to 1108, and/or the authentication process as described above with reference to FIGS. 8, 9A, and/or 9B such as biometric lockout 933).

In some embodiments, prior to receiving the first authentication information (e.g., a biometric authentication received in response to displaying 616 and/or 1016, a biometric authentication received at local authentication 820, and/or a biometric received at 900A and/or 900B): the computer system detects a request (e.g., 610, 614, 638, 650, and/or a request to perform an operation associated with 1012) to perform an operation and in response to request to perform the operation, the computer system (e.g., 600 and/or 100) requests user authentication (e.g., providing authentication prompt 616, 626, 636, 1016, 1018, and/or 1030) (e.g., outputting a prompt to the user to provide authentication information or presenting a user interface such as displaying a lock screen user interface, that indicates that authentication information is required to proceed) (e.g., as described above with reference to FIGS. 7, 8, 9A, 9B, 11A, and/or 11B). Requesting user authentication in response to a request to perform an operation increases the security of the computer system when an operation is requested, ensuring that the owner of the computer system is requesting the operation.

In some embodiments, the first authentication information includes biometric authentication information (e.g., a biometric authentication received in response to displaying 616 and/or 1016, a biometric authentication received at local authentication 820, and/or a biometric received at 900A and/or 900B) (e.g., face, eye, iris, fingerprint, hand print, voice, and/or other biometric authentication). Requiring biometric authentication information allows the computer system to detect the physical presence of the user and prevent access from others who have gained access to other security information of the user such as passcodes, increasing the security of the computer system.

In some embodiments, the first authentication information is required to be provided in conjunction with (e.g., along with, concurrently with, simultaneously with, or within a threshold time of) a contextual cue that cannot be conveyed verbally or in writing (e.g., a biometric authentication received in response to displaying 616 and/or 1016, a biometric authentication received at local authentication 820, and/or a biometric received at 900A and/or 900B) (e.g., the first authentication information is required to be biometric authentication information and/or is required to be accompanied by a context that that cannot be replicated based on information provided by a person without access to another physical object or device such as the presence of a wireless or wired connection to a known device such as a vehicle stereo, unlocked computer, unlocked phone, unlocked watch, or unlocked wearable device) (e.g., the multiple authentications separated by a delay timer as described above with reference to FIGS. 7, 8, 9A, and/or 9B). Requiring the first authentication information to be provided in conjunction with a contextual cue that cannot be conveyed verbally or in writing allows the computer system to check for the physical presence of the user, increasing the security of the computer system.

In some embodiments, in response to receiving the first authentication information (e.g., password, passcode, pattern, biometric, or other authentication information), in accordance with a determination that the first authentication information is not valid (e.g., that the first authentication information does not match authorized password, passcode, pattern, biometric, or other authentication information), the computer system prevents the operation from being performed (e.g., forgoing initiating a process to perform the operation as described with reference to 708, preventing further authentication attempts as described with reference to 1108, and/or the authentication process as described above with reference to FIGS. 8, 9A, and/or 9B such as biometric lockout 933) (e.g., and forgoing starting a timer that would allow the operation to be performed at a future point in time after receiving valid authentication information at the end of the threshold amount of time). Preventing the operation from being performed when the authentication information is not valid prevents access to the device when the user is not present or cannot provide authentication information, increasing security of the computer system.

In some embodiments, in response to receiving the second authentication information, in accordance with a determination that the second authentication information is not valid (e.g., that the second authentication information matches authorized password, passcode, pattern, biometric, or other authentication information that was previously registered and/or enrolled for an authorized user), the computer system prevents the operation from being performed (e.g., forgoing initiating a process to perform the operation as described with reference to 708, preventing further authentication attempts as described with reference to 1108, and/or the authentication process as described above with reference to FIGS. 8, 9A, and/or 9B such as biometric lockout 933) (e.g., until security criteria for performing the operation have been met, such as multiple valid authentications that are spaced apart by a threshold amount of time). Preventing the operation from being performed when the authentication information is not valid prevents access to the device when the user is not present or cannot provide authentication information, increasing security of the computer system.

In some embodiments, after allowing the operation to performed, the computer system provides, via the one or more output devices, a user interface (e.g., the user interface shown in 6H, 6Y, 10C, and/or 10J) that includes one or more selectable options for proceeding with the operation (e.g., as described above with reference to FIGS. 7, 11A, and/or 11B). In some embodiments, proceeding with the operation includes a single input such as a control turning a function on or off, which can be performed by manipulation of a single UI element or hardware control. In some embodiments, proceeding with the operation includes multiple inputs with various different input devices (e.g., inputs with a keyboard, mouse, trackpad, touch-sensitive surface, one or more cameras, one or more buttons, and/or one or more biometric sensors). In some embodiments, proceeding with the operation includes interactions with remote servers or other devices (e.g., such as creating or changing a setting of an account, registering a new device, changing a setting on a remote server). Providing a user interface that includes one or more selectable options for proceeding with the operation after allowing the operation to be performed allows for efficient completion of the operation, reducing the number of inputs and increasing the battery life of the computer system.

In some embodiments, in response to receiving the first authentication information, in accordance with a determination that the first authentication information is valid, displaying, via the one or more output devices, an indication that a delay is required before the operation can be performed (e.g., user interface 644 as shown in FIG. 6Q, user interface 648 as shown in FIG. 6R and/or 6U, and/or as described above with reference to FIG. 7))(e.g., in conjunction with delaying allowing the operation to be performed for the threshold amount of time). Displaying the indication that the delay is required before the operation can be performed provides information to the user about when another authentication attempt is required, increasing the efficiency of the interaction between the user and the computer system and in turn increasing battery life of the computer system.

Note that details of the processes described above with respect to method 1200 (e.g., FIG. 12) are also applicable in an analogous manner to the methods described above. For example, method 1200 optionally includes one or more of the characteristics of the various methods described above with reference to method 700 and/or method 1100. For example, method 1200 can include the location-based user authentication described in method 700 in addition to requiring multiple authentications separated by a delay. As another example, method 1200 can include authentications of multiple types as described in method 1100 in addition to requiring multiple authentications separated by a delay. For brevity, these details are not repeated above.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to user authentication. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide location-based user authentication services for different types of operations. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of user authentication services, the present technology can be configured to allow users to select to “opt in” or “opt out” of participation in the collection of personal information data during registration for services or anytime thereafter. In another example, users can select not to utilize certain user authentication services. In yet another example, users can select to limit the length of time location and other personal data stored for user with user authentication services is stored. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, user authentication settings can be based on non-personal information data or a bare minimum amount of personal information, such as non-personal information available to the user authentication service or publicly available information.

What is claimed is:

1. A computer system configured to communicate with a display generation component and one or more input devices, comprising:
one or more processors; and
memory storing one or more programs configured to be executed by the one or more processors, the one or more programs including instructions for:
receiving, via the one or more input devices, a sequence of one or more inputs that includes a request to perform an operation of a respective type; and
in response to receiving the sequence of one or more inputs:
in accordance with a determination that the operation is a first type of operation that was requested while the computer system was in a first type of location, initiating a process to perform the operation; and
in accordance with a determination that the operation is the first type of operation that was requested while the computer system was in a second type of location that is different from the first type of location, forgoing initiating the process to perform the operation.

2. The computer system of claim 1, the one or more programs further including instructions for:
in response to receiving the sequence of one or more inputs:
in accordance with a determination that the operation is a second type of operation that is different from the first type of operation, performing the operation without regard to whether the operation was requested while the computer system was in the first type of location or the second type of location.

3. The computer system of claim 1, wherein locations of the first type of location are determined based on a location history of the computer system.

4. The computer system of claim 3, the one or more programs further including instructions for:
while a first location is categorized as a first type of location, determining that a first set of one or more categorization conditions has been met for the first location;
in response to determining that the first set of one or more categorization conditions has been met for the first location, changing the categorization of the first location from the first type of location to the second type of location; and
while a second location is categorized as the second type of location, determining that a second set of one or more categorization conditions has been met for the second location; and
in response to determining that the second set of one or more categorization conditions has been met for the second location, changing the categorization of the second location from the second type of location to the first type of location.

5. The computer system of claim 1, the one or more programs further including instructions for:
in response to receiving the sequence of one or more inputs and in accordance with the determination that the operation is the first type of operation that was requested while the computer system was in the first type of location:
providing a prompt for an alternative type of authentication other than biometric authentication;
receiving, via the one or more input devices, an authentication attempt using the alternative type of authentication; and
in response to receiving the authentication attempt and in accordance with a determination that the authentication attempt includes received authentication information that matches enrolled authentication information for the alternative type of authentication, perform the operation; and
in response to receiving the sequence of one or more inputs and in accordance with the determination that the operation is the first type of operation that was requested while the computer system was in the second type of location that is different from the first type of location, initiating a second process to perform the operation, wherein the second process to perform the operation is different from the first process to perform the operation and wherein the second process includes a first prompt for biometric authentication.

6. The computer system of claim 1, the one or more programs further including instructions for:
in response to receiving the sequence of one or more inputs and in accordance with a determination that the operation is a second type of operation that was requested while the computer system was in a second type of location that is different from the first type of location, initiating a third process to perform the operation, wherein the third process to perform the operation includes:
providing a first prompt for a biometric authentication; and
receiving, via the one or more input devices, a first authentication attempt using the biometric authentication;
in response to receiving the first authentication attempt:
in accordance with a determination that the first authentication attempt includes received biometric authentication information that matches an enrolled biometric feature, starting a delay timer; and
in accordance with a determination that the first authentication attempt does not include received biometric authentication information that matches an enrolled biometric feature, forgoing starting the delay timer and forgoing performing the operation;
in accordance with a determination that the delay timer has reached a threshold time and another request to perform the operation has been received:
providing a second prompt for the biometric authentication; and
receiving, via the one or more input devices, a second authentication attempt using the biometric authentication; and
in response to receiving the second authentication attempt:
in accordance with a determination that the second authentication attempt includes received biometric information that matches an enrolled biometric feature, performing the operation; and
in accordance with a determination that the second authentication attempt does not include received biometric information that matches an enrolled biometric feature, forgoing performing of the operation.

7. The computer system of claim 6, wherein the second type of operation includes changing and/or removing a password associated with the computer system.

8. The computer system of claim 6, wherein the second type of operation includes adding, changing, and/or removing an enrolled biometric.

9. The computer system of claim 6, wherein the second type of operation includes approving a sign in attempted on a second computer system that is different from the computer system.

10. The computer system of claim 6, wherein the second type of operation includes changing a password associated with a user account.

11. The computer system of claim 6, wherein the second type of operation includes changing settings associated with the delay timer.

12. The computer system of claim 6, wherein starting the delay timer includes:
in accordance with a determination that the second authentication attempt includes received biometric authentication information that matches an enrolled biometric feature and the computer system is in a first mode, starting a delay timer of a first length; and
in accordance with a determination that the second authentication attempt includes received biometric authentication information that matches an enrolled biometric feature and the computer system is in a second mode that is different from the first mode, starting a delay timer of a second length that is different from the first length.

13. The computer system of claim 6, the one or more programs further including instructions for:
after starting the delay timer, detecting a location of the computer system;
in accordance with a determination that the location of the computer system is the first type of location:
allowing the second authentication attempt using the biometric authentication without regard to whether an end of the delay timer has been reached; and
in accordance with a determination that the location of the computer system is the second type of location, preventing the second authentication attempt using the biometric authentication until an end of the delay timer has been reached.

14. The computer system of claim 6, wherein the delay timer measures a delay until the second authentication attempt using the biometric authentication can be attempted and wherein the delay timer starts based on the first authentication attempt using the biometric authentication being successful.

15. The computer system of claim 14, wherein the sequence of one or more inputs that includes the request is a first sequence of one or more inputs that includes the request, the one or more programs further including instructions for:
while the delay timer is active:
receiving, via the one or more input devices, a second sequence of one or more inputs that includes a request to perform a second operation of the second type; and
in response to receiving the second sequence of one or more inputs and in accordance with a determination that the second operation is the second type of operation that was requested while the computer system was in the second type of location, displaying, via the display generation component, a current time of the delay timer.

16. The computer system of claim 14, the one or more programs further including instructions for:
while the delay timer is active:
receiving, via the one or more input devices, the second sequence of one or more inputs that includes the request to perform the second operation; and
in response to receiving the second sequence of one or more inputs:
in accordance with the determination that the second operation is the second type of operation that was requested while the computer system was in the second type of location that is different from the first type of location, continuing the delay timer without starting a new delay timer.

17. The computer system of claim 14, the one or more programs further including instructions for:
detecting that the delay timer has reached the threshold time; and
in response to detecting that the delay timer has reached the threshold time, providing a notification including the second prompt for the biometric authentication.

18. The computer system of claim 17, the one or more programs further including instructions for:
detecting, via the one or more input devices, an input directed at the notification including the second prompt for biometric authentication; and
in response to detecting the input directed at the notification including the second prompt for biometric authentication, displaying, via the display generation component, a user interface associated with the operation of the respective type.

19. The computer system of claim 6, wherein the request is a first request and wherein the operation is a first operation, the one or more programs further including instructions for:
subsequent to receiving the second authentication attempt that includes received biometric information that matches an enrolled biometric feature:
receiving via the one or more input devices, a third sequence of one or more inputs that includes a second request to perform a third operation; and
in response to receiving the third sequence of one or more inputs and in accordance with a determination that the third operation is the second type of operation that was requested while the computer system was in the second type of location, initiating a process to perform the third operation of the respective type without starting a delay timer.

20. The computer system of claim 6, wherein the request is a first request and wherein the operation is a first operation, the one or more programs further including instructions for:
subsequent to the second authentication attempt including received biometric information that matches an enrolled biometric feature:
receiving, via the one or more input devices, a fourth sequence of one or more inputs that includes a request to perform a fourth operation of the respective type; and
in response to receiving the fourth sequence of one or more inputs and in accordance with a determination that the fourth operation is the second type of operation that was requested while the computer system was in the second type of location and that the fourth sequence of one or more inputs is received within a time period from when the second authentication attempt occurred, initiating a process to perform the fourth operation of the respective type.

21. The computer system of claim 1, wherein the first type of operation includes removing a trusted device.

22. The computer system of claim 6, the one or more programs further including instructions for:
while the delay timer is active, ceasing to provide a location of the computer system to one or more other computer systems.

23. The computer system of claim 6, the one or more programs further including instructions for:
while the delay timer is active:
in accordance with a determination that another computer system is a first type of computer system, providing a location of the computer system; and
in accordance with a determination that another computer system is a second type of computer system, forgoing providing the location of the computer system.

24. The computer system of claim 23, the one or more programs further including instructions for:
while the delay timer is active:
in accordance with a determination that the location of the computer system is available to other computer systems, providing a notification that the computer system can be located remotely.

25. The computer system of claim 6, the one or more programs further including instructions for:
receiving, via the one or more input devices, a request to require multiple requests for biometric authentication with a delay timer for the second type of request regardless of a location of the computer system; and
in response to receiving the request to require multiple requests for biometric authentication with a delay timer for the second type of request regardless of a location of the computer system, enabling an option to require multiple requests for biometric authentication with a delay timer for the second type of request regardless of a location of the computer system.

26. The computer system of claim 6, the one or more programs further including instructions for:
receiving, via the one or more input devices, a request to disable requiring multiple requests for biometric authentication with a delay timer for the second type of request regardless of a location of the computer system; and
in response to receiving the request to disable requiring multiple requests for biometric authentication with a delay timer for the second type of request regardless of a location of the computer system, disabling requiring multiple requests for biometric authentication with a delay timer for the second type of request regardless of a location of the computer system.

27. The computer system of claim 1, the one or more programs further including instructions for:
in response to the sequence of one or more inputs that includes the request to perform the operation of the respective type and in accordance with a determination that a successful biometric authentication has not occurred within a time period, initiating the process to perform the operation, including, in accordance with a determination that a successful biometric authentication has not occurred within the time period, providing a prompt for an alternative type of authentication other than biometric authentication that is associated with the operation of the respective type.

28. The computer system of claim 27, wherein:
in accordance with a determination that the operation is the first type of operation, the time period is more than 10 hours.

29. The computer system of claim 27, wherein:
in accordance with a determination that the operation is a second type of operation that is different from the first type of operation and in accordance with a determination that the computer system is not marked as lost on a remote device registration service, the time period is more than 2 days.

30. The computer system of claim 27, wherein:
in accordance with a determination that the operation is a second type of operation and the computer system has been marked as lost on a remote device registration service, the time period is more than 5 days.

31. A non-transitory computer-readable storage medium storing one or more programs configured to be executed by one or more processors of a computer system that is in communication with a display generation component and one or more input devices, the one or more programs including instructions for:
receiving, via the one or more input devices, a sequence of one or more inputs that includes a request to perform an operation of a respective type; and
in response to receiving the sequence of one or more inputs:
in accordance with a determination that the operation is a first type of operation that was requested while the computer system was in a first type of location, initiating a process to perform the operation; and
in accordance with a determination that the operation is the first type of operation that was requested while the computer system was in a second type of location that is different from the first type of location, forgoing initiating the process to perform the operation.

32. A method, comprising:
at a computer system that is in communication with a display generation component and one or more input devices:
receiving, via the one or more input devices, a sequence of one or more inputs that includes a request to perform an operation of a respective type; and
in response to receiving the sequence of one or more inputs:
in accordance with a determination that the operation is a first type of operation that was requested while the computer system was in a first type of location, initiating a process to perform the operation; and
in accordance with a determination that the operation is the first type of operation that was requested while the computer system was in a second type of location that is different from the first type of location, forgoing initiating the process to perform the operation.
